(19) United States
(12) Patent Application Publication
(10) Pub. No.: US 2003/0134198 A1
(43) Pub. Date: Jul. 17, 2003

(54) Negative electrode material, negative electrode, nonaqueous electrolyte battery and method of manufacturing a negative electrode material

(75) Inventors: Takao Sawa, Yokohama-shi (JP); Toshiya Sakamoto, Yokohama-shi (JP); Tatsuoki Kono, Tokyo (JP); Norio Takami, Yokohama-shi (JP); Shinsuke Matsuno, Kashiwa-shi (JP)

Correspondence Address: FOLEY AND LARDNER, SUITE 500, 3000 K STREET NW, WASHINGTON, DC, 20007, US

(73) Assignee: KABUSHIKI KAISHA TOSHIBA

(21) Appl. No.: 10/256,046

(22) Filed: Sep. 27, 2002

(30) Foreign Application Priority Data
Sep. 28, 2001 (JP) 2001-304740
Nov. 30, 2001 (JP) 2001-366931
Apr. 18, 2002 (JP) 2002-116497

(51) Int. Cl. H01M 4/58; C01B 33/00; C01B 33/08

(52) U.S. Cl. 429/221; 429/218.1; 429/223; 429/220; 429/224; 429/231.5; 429/231.95; 423/324

(57) ABSTRACT

According to the present invention, a negative electrode material is provided. The negative electrode material is capable of storing and releasing lithium, and exhibits at least one peak of heat generation in the range of 200° C. to 450° C. in the differential scanning calorimetry (DSC) at a temperature rise speed of 10° C./min. and a peak derived from a crystalline phase in the X-ray diffraction.

### CROSS-REFERENCE TO RELATED APPLICATIONS

This application is based upon and claims the benefit of priority from the prior Japanese Patent Applications No. 2001-304740, filed Sep. 28, 2001; No. 2001-366931, filed Nov. 30, 2001; and No. 2002-116497, filed Apr. 18, 2002, the entire contents of all of which are incorporated herein by reference.

### BACKGROUND OF THE INVENTION

1. Field of the Invention

The present invention relates to a negative electrode material for use in nonaqueous electrolyte batteries, a negative electrode containing the negative electrode material, a nonaqueous electrolyte battery comprising the negative electrode, and a method of manufacturing a negative electrode material. The nonaqueous electrolyte battery according to the present invention includes both a nonaqueous electrolyte primary battery and a nonaqueous electrolyte secondary battery.

2. Description of the Related Art

In recent years, a nonaqueous electrolyte battery that uses lithium metal as a negative electrode active material has been gaining public attention as a high energy density battery. A primary battery that uses manganese dioxide (MnO₂), fluoro-carbons [(CF₂)n], thionyl chloride (SOCl₂) or the like for a positive electrode active material has been already used as a power source of a calculator, a watch and a back-up battery of a memory. Furthermore, recently, as various kinds of electronic appliance such as VTR or communication appliance become smaller in size and lighter in weight, as power source for these, there is a strong demand for a higher energy density secondary battery, and there are active studies on a lithium secondary battery that uses lithium as the negative electrode active material.

As a lithium secondary battery, one is under research. This lithium secondary battery comprises a negative electrode that contains lithium metal; a positive electrode that contains a compound (for instance, TiS₂, MoS₂, V₂O₅, V₆O₁₃, MnO₂ and so on) that can cause a topochemical reaction with a lithium ion; and an electrolyte consisting essentially of a liquid nonaqueous electrolyte or a lithium ion conductive solid electrolyte. The electrolyte contains a nonaqueous solvent such as propylene carbonate (PC), 1,2-dimethoxy ethane (DME), γ-butyrolactone (γ-BL), tetrahydrofuran (THF) or the like; and a lithium salt such as LiClO₄, LiBF₄, LiAsF₆ or the like dissolved in the nonaqueous solvent.

However, the aforementioned lithium secondary battery has not yet been put into practical use. Main reasons for this are in that lithium metal for use in the negative electrode is pulverized and reactive lithium dendrite is precipitated during charge and discharge cycle, resulting in a likelihood of not only causing short circuit but also causing thermal runaway of the battery. In addition to the above, there are further problems in that a charge/discharge efficiency deteriorates and a cycle life becomes shorter.

In view of these situations, there is a proposal in which in place of the lithium metal a carbonaceous material that can store and release lithium, such as cokes, baked resin, carbon fiber, and vapor-grown-carbon material, is used. The lithium ion secondary battery that has been recently commercialized is provided with a negative electrode that contains the carbonaceous material, a positive electrode that contains LiCoO₂ and a nonaqueous electrolyte. In such a lithium ion secondary battery, a lithium ion released from the negative electrode during discharge is taken in the nonaqueous electrolyte, and during charge there occurs a reaction in which the lithium ion in the nonaqueous electrolyte is stored in the negative electrode.

In accordance with a demand for furthermore smaller size and longer operation time on recent electronics, it is strongly demanded to further increase a capacity of a battery. However, it is difficult to further increase a capacity of a negative electrode containing a carbonaceous material. Furthermore, when low-temperature baked carbon that is considered to have a higher capacity is used, because of a smaller density thereof, it is difficult to realize a larger charge/discharge capacity a unit volume. Accordingly, in realizing a higher capacity battery, a new negative electrode material has to be developed.

Jpn. Apt. Appln. KOKAI Publication No. 2000-311681 discloses a negative electrode material for use in lithium secondary batteries that contains particles consisting essentially of an amorphous Sn·A·X alloy having a non-stoichiometric composition. In the above formula, A denotes at least one kind of transition metal and X denotes at least one kind element selected from the group consisting of O, F, N, Mg, Ba, Sr, Ca, La, Ce, Si, Ge, C, P, B, Bi, Sb, Al, In, S, Se, Te and Zn. In the above, the X may not be contained. In addition, between the numbers of atoms of each of elements in the above formula, a relationship of Sn/(Sn+A+X)=20 to 80 atomic percent holds.

Furthermore, in an alloy system in which Sn is an element fundamental for lithium storage capacity such as in Jpn. Pat. Appln. KOKAI Publication No. 2000-311681, when a content of Sn becomes less than 20 atomic percent, a high capacity cannot be obtained. In fact, in Table 1, it is shown that when an amorphous alloy whose composition is represented by Sn₁₈Co₈₂ is used, a first time charge/discharge efficiency, a discharge capacity and a cycle life are inferior to an amorphous alloy whose content of Sn is in the range of from 20 to 80 atomic percent. On the other hand, when the content of Sn exceeds 80 atomic percent, the capacity can be made higher but a longer cycle life cannot be obtained. Still furthermore, even in a composition where a content of Sn is in the range of from 20 to 80 atomic percent, discharge capacity and cycle life are not sufficient.

On the other hand, in paragraphs [0010] through [0012] of Jpn. Pat. Appln. KOKAI Publication No. 10-223221, with an intention of improving a discharge capacity and a charge/discharge cycle life of a secondary battery, it is disclosed to use a binary or ternary intermetallic compound that contains a transition metal element such as Ni, Co or Fe and Al, or a binary intermetallic compound between Al and Mg.

However, a nonaqueous electrolyte battery in which the intermetallic compound disclosed in Jpn. Pat. Appln. KOKAI Publication No. 10-223221 is used is not sufficient in not only the discharge capacity and cycle life but also in discharge rate characteristics.

Furthermore, Jpn. Pat. Appln. KOKAI Publication No. 10-302770 discloses, with an intention to improve the discharge capacity, a coulomb efficiency and the rate characteristics, a negative electrode material for use in lithium ion secondary batteries that consists essentially of a compound expressed by a chemical formula AB_{X} (0.5≦X≦3). Here, A denotes at least one kind element selected from the group consisting of Fe, Ni, Mn, Co, Mo, Cr, Nb, V, Cu and W, and B is Si and at least one kind element selected from the group consisting of C, Ge, Sn, Pb, Al and P.

In paragraph [0025] of the above publication, it is disclosed that a ratio of Si to M (C, Ge, Sn, Pb, Al, P) in a B site is preferably set in the range of from 1:0.2 (0.83:0.17) to 1:0.

However, even when a presence ratio of Si in the B site in AB_{X} is made 0.83 or more, the discharge capacity, cycle life and discharge rate characteristics are not sufficient.

### SUMMARY OF THE INVENTION

An object of the present invention is to provide a negative electrode material capable of improving a discharge capacity, charge/discharge cycle life and rate characteristics in nonaqueous electrolyte batteries, a method of manufacturing a negative electrode material, a negative electrode and a nonaqueous electrolyte battery.

In addition, another object of the present invention is to provide a negative electrode material that is capable of realizing a high discharge capacity and excellent rate characteristics in nonaqueous electrolyte batteries, a method of manufacturing a negative electrode material, a negative electrode and a nonaqueous electrolyte battery.

According to a first aspect of the present invention, there is provided a negative electrode material that has a composition expressed by a general formula (1) below and comprises an amorphous phase:

(Al₁₋ₓSiₓ)ₐM_{b}M′_{c}T_{d} (1)

provided that, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x<0.75.

According to a second aspect of the present invention, there is provided a negative electrode material that has a composition expressed by a general formula (2) below and comprises an amorphous phase:

(Al_{1-X}A_{X})ₐM_{b}M′_{c}T_{d} (2)

provided that, the A is Mg, or Si and Mg, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x≦0.9.

According to a third aspect of the present invention, there is provided a negative electrode material that has a composition expressed by the following general formula (3) and includes a microcrystalline phase having an average crystal grain size of 500 nm or less:

(Al_{1-X}Si_{X})ₐM_{b}M′_{c}T_{d} (3)

provided that, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x<0.75.

According to a fourth aspect of the present invention, there is provided a negative electrode material that has a composition expressed by the following general formula (4) and contains a microcrystalline phase whose average crystal grain size is 500 nm or less:

(Al_{1-X}A_{X})ₐM_{b}M′_{c}T_{d} (4)

provided that, the A is Mg, or Si and Mg, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x≦0.9.

According to a fifth aspect of the present invention, there is provided a negative electrode material that has a composition expressed by the following general formula (5) and comprises an amorphous phase:

[(Al_{1-X}Si_{X})ₐM_{b}M′_{c}T_{d}]_{y}Li_{z} (5)

provided that, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x<0.75, y+z=100 atomic percent, and 0<z≦50 atomic percent.

According to a sixth aspect of the present invention, there is provided a negative electrode material that has a composition expressed by the following general formula (6) and comprises an amorphous phase:

[(Al_{1-X}A_{X})ₐM_{b}M′_{c}T_{d}]_{y}Li_{z} (6)

provided that, the A is Mg, or Si and Mg, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x≦0.9, y+z=100 atomic percent, and 0<z≦50 atomic percent.

According to a seventh aspect of the present invention, there is provided a negative electrode material that contains a microcrystalline phase whose average crystal grain size is 500 nm or less and has a composition expressed by the following general formula (7):

[(Al_{1-X}Si_{X})ₐM_{b}M′_{c}T_{d}]_{y}Li_{z} (7)

provided that, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x<0.75, y+z=100 atomic percent, and 0<z≦50 atomic percent.

According to an eighth aspect of the present invention, there is provided a negative electrode material that contains a microcrystalline phase whose average crystal grain size is 500 nm or less and has a composition expressed by the following general formula (8):

[(Al_{1-X}A_{X})ₐM_{b}M′_{c}T_{d}]_{y}Li_{z} (8)

provided that, the A is Mg, or Si and Mg, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x≦0.9, y+z=100 atomic percent, and 0<z≦50 atomic percent.

According to a ninth aspect of the present invention, there is provided a negative electrode material that is capable of storing and releasing lithium, wherein the negative electrode material exhibits at least one peak of heat generation in the range of 200° C. to 450° C. in differential scanning calorimetry (DSC) at a temperature rise speed of 10° C./min., and exhibits a peak derived from a crystalline phase in X-ray diffraction.

According to a tenth aspect of the present invention, there is provided a negative electrode material, comprising:

a first phase including isolated intermetallic compound crystal grains that include at least two kinds of elements capable of forming an alloy with lithium, an average size of crystal grains of the first phase is in the range of 5 nm to 500 nm, and the number of crystal grains of the first phase is within the range of 10 pieces to 2000 pieces per an area of 1 μm²; and

a second phase that contains a simple substance of an element capable of forming an alloy with lithium and is arranged between the isolated crystal grains.

According to an eleventh aspect of the present invention, there is provided a negative electrode material, comprising:

a first phase including isolated intermetallic compound crystal grains that include at least two kinds of elements capable of forming an alloy with lithium, an average size of crystal grains of the first phase is in the range of 5 nm to 500 nm, and an average distance between the isolated crystal grains is 500 nm or less; and

a second phase that contains a simple substance of an element capable of forming an alloy with lithium and is arranged between the isolated crystal grains.

According to a twelfth aspect of the present invention, there is provided a negative electrode material, comprising:

a first phase including isolated crystal grains of an intermetallic compound that includes at least two kinds of elements capable of forming an alloy with lithium, and an average size of crystal grains of the first phase is in the range of 5 nm to 500 nm; and

a second phase that contains a simple substance of an element capable of forming an alloy with lithium and is arranged between the isolated crystal grains,

wherein the intermetallic compound have a cubic fluorite structure whose lattice constant is in the range of from 5.42 Å to 6.3 Å or an inverse fluorite structure whose lattice constant is in the range of from 5.42 Å to 6.3 Å.

According to a thirteenth aspect of the present invention, there is provided a negative electrode material, comprising:

an intermetallic compound phase that includes at least two kinds of elements capable of forming an alloy with lithium; and

a second phase containing a simple substance of an element capable of forming an alloy with lithium,

wherein, in the powder X-ray diffraction, peaks derived from the intermetallic compound phase appear at least in the range of from 3.13 Å to 3.64 Å and from 1.92 Å to 2.23 Å by d value, and a peak derived from the second phase appears at least in the range of from 2.31 Å to 2.4 Å by d value.

According to a fourteenth aspect of the present invention, there is provided a negative electrode material, including:

a phase containing an element that is capable of forming an alloy with lithium; and

a plurality of intermetallic compound phases,

wherein each of at least two kinds of the plurality of intermetallic compound phases includes a first element that is capable of forming an intermetallic compound with lithium and a second element that does not form an intermetallic compound with lithium, a combination of the first element and the second element being different from each other.

According to a fifteenth aspect of the present invention, there is provided a negative electrode material, including:

a phase containing an element capable of forming an alloy with lithium;

an intermetallic compound phase; and

a nonequilibrium phase.

According to a sixteenth aspect of the present invention, there is provided a negative electrode containing an alloy that has a composition expressed by a general formula (1) below and comprises an amorphous phase:

(Al₁₋ₓSiₓ)ₐM_{b}M′_{c}T_{d} (1)

provided that, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x<0.75.

According to a seventeenth aspect of the present invention, there is provided a negative electrode containing an alloy that has a composition expressed by a general formula (2) below and comprises an amorphous phase:

(Al_{1-X}A_{X})ₐM_{b}M′_{c}T_{d} (2)

provided that, the A is Mg, or Si and Mg, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x≦0.9.

According to an eighteenth aspect of the present invention, there is provided a negative electrode containing an alloy that contains a microcrystalline phase whose average crystal grain size is 500 nm or less and has a composition expressed by a general formula (3) below:

(Al_{1-X}Si_{X})ₐM_{b}M′_{c}T_{d} (3)

provided that, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x<0.75.

According to a nineteenth aspect of the present invention, there is provided a negative electrode containing an alloy that contains a microcrystalline phase whose average crystal grain size is 500 nm or less and has a composition expressed by a general formula (4) below:

(Al_{1-X}A_{X})ₐM_{b}M′_{c}T_{d} (4)

provided that, the A is Mg, or Si and Mg, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x≦0.9.

According to a twentieth aspect of the present invention, there is provided a negative electrode containing an alloy that has a composition expressed by a general formula (5) below and comprises an amorphous phase:

[(Al_{1-X}Si_{X})ₐM_{b}M′_{c}T_{d}]_{y}Li_{z} (5)

provided that, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x<0.75, y+z=100 atomic percent, and 0<z≦50 atomic percent.

According to a twenty-first aspect of the present invention, there is provided a negative electrode containing an alloy that has a composition expressed by a general formula (6) below and comprises an amorphous phase:

[(Al_{1-X}A_{X})ₐM_{b}M′_{c}T_{d}]_{y}Li_{z} (6)

provided that, the A is Mg, or Si and Mg, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x≦0.9, y+z=100 atomic percent, and 0<z≦50 atomic percent.

According to a twenty-second aspect of the present invention, there is provided a negative electrode containing an alloy that includes a microcrystalline phase whose average crystal grain size is 500 nm or less and has a composition expressed by a general formula (7) below:

[(Al_{1-X}Si_{X})ₐM_{b}M′_{c}T_{d}]_{y}Li_{z} (7)

provided that, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x<0.75, y+z=100 atomic percent, and 0<z≦50 atomic percent.

According to a twenty-third aspect of the present invention, there is provided a negative electrode containing an alloy that includes a microcrystalline phase whose average crystal grain size is 500 nm or less and has a composition expressed by a general formula (8) below:

[(Al_{1-X}A_{X})ₐM_{b}M′_{c}T_{d}]_{y}Li_{z} (8)

provided that, the A is Mg, or Si and Mg, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x≦0.9, y+z=100 atomic percent, and 0<z≦50 atomic percent.

According to a twenty-fourth aspect of the present invention, there is provided a negative electrode including a negative electrode material that is capable of storing and releasing lithium, wherein the negative electrode material exhibits at least one peak of heat generation in the range of 200° C. to 450° C. in differential scanning calorimetry (DSC) at a temperature raise speed of 10° C./min., and exhibits a peak derived from a crystalline phase in X-ray diffraction.

According to a twenty-fifth aspect of the present invention, there is provided a negative electrode including a negative electrode material,

wherein the negative electrode material comprises:

a first phase including isolated intermetallic compound crystal grains that include at least two kinds of elements capable of forming an alloy with lithium, an average size of crystal grains of the first phase is in the range of 5 nm to 500 nm, and the number of crystal grains of the first phase is within the range of 10 pieces to 2000 pieces per an area of 1 μm²; and

a second phase that contains a simple substance of an element capable of forming an alloy with lithium and is arranged between the isolated crystal grains.

According to a twenty-sixth aspect of the present invention, there is provided a negative electrode including a negative electrode material,

wherein the negative electrode material comprises:

a first phase including isolated intermetallic compound crystal grains that include at least two kinds of elements capable of forming an alloy with lithium, an average size of crystal grains of the first phase is in the range of 5 nm to 500 nm, and an average distance between the isolated crystal grains is 500 nm or less; and

a second phase that contains a simple substance of an element capable of forming an alloy with lithium and is arranged between the isolated crystal grains.

According to a twenty-seventh aspect of the present invention, there is provided a negative electrode including a negative electrode material,

wherein the negative electrode material comprises:

a first phase including isolated crystal grains of an intermetallic compound that includes at least two kinds of elements capable of forming an alloy with lithium, and an average size of crystal grains of the first phase is in the range of 5 nm to 500 nm; and

a second phase that contains a simple substance of an element capable of forming an alloy with lithium and is arranged between the isolated crystal grains, and the intermetallic compound have a cubic fluorite structure whose lattice constant is in the range of from 5.42 Å to 6.3 Å or an inverse fluorite structure whose lattice constant is in the range of from 5.42 Å to 6.3 Å.

According to a twenty-eighth aspect of the present invention, there is provided a negative electrode including a negative electrode material,

wherein the negative electrode material comprises:

an intermetallic compound phase including at least two kinds of elements capable of forming an alloy with lithium; and

a second phase containing a simple substance of an element capable of forming an alloy with lithium, and

the negative electrode material, in powder X-ray diffraction, exhibits peaks derived from the intermetallic compound at least in the range of from 3.13 Å to 3.64 Å and from 1.92 Å to 2.23 Å by d value and a peak derived from the second phase at least in the range of from 2.31 Å to 2.4 Å by d value.

According to a twenty-ninth aspect of the present invention, there is provided a negative electrode containing a negative electrode material including:

a plurality of intermetallic compound phases; and

a phase containing an element that is capable of forming an alloy with lithium,

wherein each of at least two kinds of the plurality of intermetallic compound phases contains a first element that is capable of forming an alloy with lithium and a second element that does not form an alloy with lithium, a combination of the first element and the second element being different from each other.

According to a thirtieth aspect of the present invention, there is provided a negative electrode containing a negative electrode material including:

an intermetallic compound phase;

a nonequilibrium phase; and

a phase that contains an element capable of forming an alloy with lithium.

According to a thirty-first aspect of the present invention, there is provided a nonaqueous electrolyte battery comprising:

a negative electrode containing an alloy that has a composition expressed by the following general formula (1) and comprises an amorphous phase;

a positive electrode; and

a nonaqueous electrolyte:

(Al₁₋ₓSiₓ)ₐM_{b}M′_{c}T_{d} (1)

provided that, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x<0.75.

According to a thirty-second aspect of the present invention, there is provided a nonaqueous electrolyte battery comprising:

a negative electrode containing an alloy that has a composition expressed by the following general formula (2) and comprises an amorphous phase;

a positive electrode; and

a nonaqueous electrolyte:

(Al_{1-X}A_{X})ₐM_{b}M′_{c}T_{d} (2)

provided that, the A is Mg, or Si and Mg, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x≦0.9.

According to a thirty-third aspect of the present invention, there is provided a nonaqueous electrolyte battery comprising:

a negative electrode containing an alloy that includes a microcrystalline phase whose average crystal grain size is 500 nm or less and has a composition expressed by the following general formula (3);

a positive electrode; and

a nonaqueous electrolyte:

(Al_{1-X}Si_{X})ₐM_{b}M′_{c}T_{d} (3)

provided that, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x<0.75.

According to a thirty-fourth aspect of the present invention, there is provided a nonaqueous electrolyte battery comprising:

a negative electrode containing an alloy that includes a microcrystalline phase whose average crystal grain size is 500 nm or less and has a composition expressed by the following general formula (4);

a positive electrode; and

a nonaqueous electrolyte:

(Al_{1-X}A_{X})ₐM_{b}M′_{c}T_{d} (4)

provided that, the A is Mg, or Si and Mg, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x≦0.9.

According to a thirty-fifth aspect of the present invention, there is provided a nonaqueous electrolyte battery comprising:

a negative electrode containing an alloy that has a composition expressed by the following general formula (5) and comprises an amorphous phase;

a positive electrode; and

a nonaqueous electrolyte:

[(Al_{1-X}Si_{X})ₐM_{b}M′_{c}T_{d}]_{y}Li_{z} (5)

provided that, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x<0.75, y+z=100 atomic percent, and 0<z≦50 atomic percent.

According to a thirty-sixth aspect of the present invention, there is provided a nonaqueous electrolyte battery comprising:

a negative electrode containing an alloy that has a composition expressed by the following general formula (6) and comprises an amorphous phase;

a positive electrode; and

a nonaqueous electrolyte:

[(Al_{1-X}A_{X})ₐM_{b}M′_{c}T_{d}]_{y}Li_{z} (6)

provided that, the A is Mg, or Si and Mg, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x≦0.9, y+z=100 atomic percent, and 0<z≦50 atomic percent.

According to a thirty-seventh aspect of the present invention, there is provided a nonaqueous electrolyte battery comprising:

a negative electrode containing an alloy that includes a microcrystalline phase whose average crystal grain size is 500 nm or less and has a composition expressed by the following general formula (7);

a positive electrode; and

a nonaqueous electrolyte:

[(Al_{1-X}Si_{X})ₐM_{b}M′_{c}T_{d}]_{y}Li_{z} (7)

provided that, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x<0.75, y+z=100 atomic percent, and 0<z≦50 atomic percent.

According to a thirty-eighth aspect of the present invention, there is provided a nonaqueous electrolyte battery comprising:

a negative electrode containing an alloy that includes a microcrystalline phase whose average crystal grain size is 500 nm or less and has a composition expressed by the following general formula (8);

a positive electrode; and

a nonaqueous electrolyte:

[(Al_{1-X}A_{X})ₐM_{b}M′_{c}T_{d}]_{y}Li_{z} (8)

provided that, the A is Mg, or Si and Mg, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x≦0.9, y+z=100 atomic percent, and 0<z≦50 atomic percent.

According to a thirty-ninth aspect of the present invention, there is provided a nonaqueous electrolyte battery comprising a positive electrode, a nonaqueous electrolyte and a negative electrode that includes a negative electrode material capable of storing and releasing lithium,

wherein the negative electrode material exhibits at least one peak of heat generation in the range of 200° C. to 450° C. in differential scanning calorimetry (DSC) at a temperature raise speed of 10° C./min., and exhibits a peak derived from a crystalline phase in X-ray diffraction.

According to a fortieth aspect of the present invention, there is provided a nonaqueous electrolyte battery comprising a positive electrode, a nonaqueous electrolyte and a negative electrode that includes a negative electrode material,

wherein the negative electrode material comprises:

a first phase including isolated intermetallic compound crystal grains that include at least two kinds of elements capable of forming an alloy with lithium, an average size of crystal grains of the first phase is in the range of 5 nm to 500 nm, and the number of crystal grains of the first phase is within the range of 10 pieces to 2000 pieces per an area of 1 μm²; and

a second phase that contains a simple substance of an element capable of forming an alloy with lithium and is arranged between the isolated crystal grains.

According to a forty-first aspect of the present invention, there is provided a nonaqueous electrolyte battery comprising a positive electrode, a nonaqueous electrolyte and a negative electrode including a negative electrode material,

wherein the negative electrode material comprises:

a first phase including isolated intermetallic compound crystal grains that include at least two kinds of elements capable of forming an alloy with lithium, an average size of crystal grains of the first phase is in the range of 5 nm to 500 nm, and an average distance between the isolated crystal grains is 500 nm or less; and

a second phase that contains a simple substance of an element capable of forming an alloy with lithium and is arranged between the isolated crystal grains.

According to a forty-second aspect of the present invention, there is provided a nonaqueous electrolyte battery comprising a positive electrode, a nonaqueous electrolyte and a negative electrode including a negative electrode material,

wherein the negative electrode material comprises:

a first phase including isolated crystal grains of an intermetallic compound that includes at least two kinds of elements capable of forming an alloy with lithium, and an average size of crystal grains of the first phase is in the range of 5 nm to 500 nm; and

a second phase that contains a simple substance of an element capable of forming an alloy with lithium and is arranged between the isolated crystal grains, and

the intermetallic compound have a cubic fluorite structure whose lattice constant is in the range of from 5.42 Å to 6.3 Å or an inverse fluorite structure whose lattice constant is in the range of from 5.42 Å to 6.3 Å.

According to a forty-third aspect of the present invention, there is provided a nonaqueous electrolyte battery comprising a positive electrode, a nonaqueous electrolyte and a negative electrode that includes a negative electrode material,

wherein the negative electrode material comprises:

an intermetallic compound phase including at least two kinds of elements capable of forming an alloy with lithium; and

a second phase containing a simple substance of an element capable of forming an alloy with lithium,

and the negative electrode material exhibits, in powder X-ray diffraction, peaks derived from the intermetallic compound phase at least in the range of from 3.13 Å to 3.64 Å and from 1.92 Å to 2.23 Å by d value and a peak derived from the second phase at least in the range of from 2.31 Å to 2.4 Å by d value.

According to a forty-fourth aspect of the present invention, there is provided a nonaqueous electrolyte battery comprising:

a negative electrode containing a negative electrode material including a plurality of intermetallic compound phases and a phase containing an element that is capable of forming an alloy with lithium;

a positive electrode; and

a nonaqueous electrolyte:

wherein each of at least two kinds of the plurality of intermetallic compound phases contains a first element that is capable of forming an alloy with lithium and a second element that does not form an alloy with lithium, a combination of the first element and the second element being different from each other.

According to a forty-fifth aspect of the present invention, there is provided a nonaqueous electrolyte battery comprising:

a negative electrode containing a negative electrode material including an intermetallic compound phase, a nonequilibrium phase and a phase containing an element that is capable of forming an alloy with lithium;

a positive electrode; and

a nonaqueous electrolyte.

According to a forty-sixth aspect of the present invention, there is provided a method of manufacturing a negative electrode material, comprising:

ejecting a melt containing first to third elements onto a single roll such that an alloy thickness is 10 μm to 500 μm; and

quenching the melt to obtain an alloy that contains a high melting point intermetallic compound phase including the first to third elements and a second phase containing the first element and lower in the melting point than the intermetallic compound phase,

wherein the first element is at least one kind of element selected from the group consisting of Al, In, Pb, Ga, Sb, Bi, Sn and Zn,

the second element is at least one kind of element selected from elements, other than Al, In, Pb, Ga, Sb, Bi, Sn and Zn, capable of forming an intermetallic compound with lithium, and

the third element is an element capable of forming an intermetallic compound with the first element and second element.

According to a forty-seventh aspect of the present invention, there is provided a method of manufacturing a negative electrode material, comprising:

ejecting a melt containing Al and element N1 and element N2 and element N3 onto a single roll such that an alloy thickness is 10 μm to 500 μm; and

quenching the melt to obtain an alloy that contains a high melting point intermetallic compound phase including Al and the element N1 and the element N2 and a second phase containing Al and lower in the melting point than the intermetallic compound phase,

wherein the element N1 is Si, or Si and Mg,

the element N2 is at least one element of Ni and Co,

the element N3 is at least one kind of element selected from the group consisting of In, Bi, Pb, Sn, Ga, Sb, Zn, Fe, Cu, Mn, Cr, Ti, Zr, Nb, Ta and rare earth elements, and

an Al content in the melt is h atomic percent, a content of the element N1 in the melt is i atomic percent, a content of the element N2 in the melt is j atomic percent and a content of the element N3 in the melt is k atomic percent, the h, i, j and k, respectively, satisfy 12.5≦h<95, 0<i≦71, 5≦j≦40, and 0≦k<20.

According to a fort-eighth aspect of the present invention, there is provided a method of manufacturing a negative electrode material, comprising:

quenching a melt according to a single roll method to obtain an alloy consisting essentially of an amorphous phase, and the melt having a composition expressed by a general formula (9) below; and

applying heat-treatment to the alloy at a temperature equal to or more than a crystallization temperature of the alloy:

XₓT1_{y}J_{z} (9)

provided that, the X is at least two kinds of elements selected from the group consisting of Al, Si, Mg, Sn, Ge, In, Pb, P and C, the T1 is at least one kind of element selected from the group consisting of Fe, Co, Ni, Cr and Mn, the J is at least one kind of element selected from the group consisting of Cu, Ti, Zr, Hf, V, Nb, Ta, Mo, W and rare earth elements, and x, y and z satisfy the following corresponding equations, x+y+z=100 atomic percent, 50≦x≦90, 10≦y≦33, and 0≦z≦10.

According to a forty-ninth aspect of the present invention, there is provided a method of manufacturing a negative electrode material, comprising:

quenching a melt according to a single roll method to obtain an alloy consisting essentially of an amorphous phase, the melt having a composition expressed by a general formula (10) below; and

applying heat-treatment to the alloy at a temperature equal to or more than a crystallization temperature of the alloy:

A1ₐT1_{b}J_{c}Z_{d} (10)

provided that, the A1 is at least one kind of element selected from the group consisting of Si, Mg and Al, the T1 is at least one kind of element selected from the group consisting of Fe, Co, Ni, Cr and Mn, the J is at least one kind of element selected from the group consisting of Cu, Ti, Zr, Hf, V, Nb, Ta, Mo, W and rare earth elements, the Z is at least one kind of element selected from the group consisting of C, Ge, Pb, P and Sn, and the a, b, c and d satisfy the following corresponding equations, a+b+c+d=100 atomic percent, 50≦a≦95, 5≦b≦40, 0≦c≦10, and 0≦d<20.

According to a fiftieth aspect of the present invention, there is provided a method of manufacturing a negative electrode material, comprising:

quenching a melt according to a single roll method to obtain an alloy consisting essentially of an amorphous phase, and the melt having a composition expressed by a general formula (11) below; and

applying heat-treatment to the alloy at a temperature equal to or more than a crystallization temperature of the alloy:

T1_{100-a-b-c}(A2₁₋ₓJ′ₓ)ₐB_{b}J_{c} (11)

provided that, the T1 is at least one kind of element selected from the group consisting of Fe, Co, Ni, Cu, Cr and Mn, the element A2 is at least one element selected from the group consisting of Al and Si, the J is at least one kind of element selected from the group consisting of Ti, Zr, Hf, V, Nb, Ta, Mo, W and rare earth elements, the J′ is at least one kind of element selected from the group consisting of C, Ge, Pb, P, Sn and Mg, and a, b, c, and x satisfy the following corresponding equations, 10 atomic percent≦a≦85 atomic percent, 0<b≦35 atomic percent, 0≦c≦10 atomic percent, and 0≦x≦0.3, and a content of Sn is less than 20 atomic percent (including 0 atomic percent).

According to a fifty-first aspect of the present invention, there is provided a method of manufacturing a negative electrode material, comprising:

quenching a melt according to a single roll method to obtain an alloy consisting essentially of an amorphous phase, the melt having a composition expressed by a general formula (12) below; and

applying heat-treatment to the alloy at a temperature equal to or more than a crystallization temperature of the alloy:

(Mg₁₋ₓA3ₓ)_{100-a-b-c-d}(RE)ₐT1_{b}M1_{c}A4_{d} (12)

provided that, the element A3 is at least one kind of element selected from the group consisting of Al, Si and Ge, the RE is at least one kind of element selected from the group consisting of Y and rare earth elements, the T1 is at least one kind of element selected from the group consisting of Fe, Co, Ni, Cu, Cr and Mn, the M1 is at least one kind of element selected from the group consisting of Ti, Zr, Hf, V, Nb, Ta, Mo, and W, the A4 is at least one kind of element selected from the group consisting of Sn, Pb, Zn, P and C, and a, b, c, d and x satisfy the following corresponding equations, 0<a≦40 atomic percent, 0<b≦40 atomic percent, 0≦c≦10 atomic percent, 0≦d<20 atomic percent, and 0≦x≦0.5.

According to a fifty-second aspect of the present invention, there is provided a method of manufacturing a negative electrode material, comprising:

quenching a melt according to a single roll method to obtain an alloy consisting essentially of an amorphous phase, and the melt having a composition expressed by a general formula (13) below; and

applying heat-treatment to the alloy at a temperature equal to or more than a crystallization temperature of the alloy:

(A1₁₋ₓA5ₓ)ₐT1_{b}J_{c}Z_{d} (13)

provided that, the element A5 is at least one kind of element selected from the group consisting of Si and Mg, the T1 is at least one kind of element selected from the group consisting of Fe, Co, Ni, Cr and Mn, the J is at least one kind of element selected from the group consisting of Cu, Ti, Zr, Hf, V, Nb, Ta, Mo, W and rare earth elements, the Z is at least one kind of element selected from the group consisting of C, Ge, Pb, P and Sn, and a, b, c, d and x satisfy the following corresponding equations, a+b+c+d=100 atomic percent, 50≦a≦95, 5≦b≦40, 0≦c≦10, 0≦d<20, and 0<x≦0.9.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiment of the invention, and together with the general description given above and the detailed description of the embodiment given below, serve to explain the principles of the invention.

FIG. 1 is a sectional view showing a thin nonaqueous electrolyte secondary battery that is an example of a nonaqueous electrolyte battery according to the present invention;

FIG. 2 is an enlarged sectional view showing A portion of FIG. 1;

FIG. 3 is a characteristic diagram showing an X-ray diffraction pattern of a negative electrode material according to Example 1;

FIG. 4 is a characteristic diagram showing an X-ray diffraction pattern of a negative electrode material according to Example 15;

FIG. 5 is a schematic diagram showing one example of a metal texture of a negative electrode material for use in nonaqueous electrolyte batteries according to the present invention;

FIG. 6 is a characteristic diagram showing an X-ray diffraction pattern of a negative electrode material according to Example 52;

FIG. 7 is a transmission electron microgram (magnification of 10⁵ times) of the negative electrode material according to Example 52;

FIG. 8 is a characteristic diagram showing a DSC curve due to differential scanning calorimetry of the negative electrode material according to Example 52;

FIG. 9 is a characteristic diagram showing an X-ray diffraction pattern of a negative electrode material according to Example 73; and

FIG. 10 is a characteristic diagram showing an X-ray diffraction pattern of a negative electrode material according to Example 89.

### DETAILED DESCRIPTION OF THE INVENTION

First, a first through twelfth negative electrode materials for nonaqueous electrolyte batteries according to the present invention will be explained.

<First Negative Electrode Material for Use in Nonaqueous Electrolyte Batteries>

A first negative electrode material for use in nonaqueous electrolyte batteries contains an alloy that has a composition expressed by the following general formula (1) and consists essentially of an amorphous phase.

(Al_{1-X}Si_{X})ₐM_{b}M′_{c}T_{d} (1)

Here, the M denotes at least one kind of element selected from the group consisting of Fe, Co, Ni, Cu and Mn, the M′ denotes at least one kind of element selected from the group consisting of Ti, Zr, Hf, V, Nb, Ta, Cr, Mo, W, and rare earth elements, the T denotes at least one kind of element selected from the group consisting of C, Ge, Pb, P and Sn, and the a, b, c, d and X satisfy corresponding relationships of a+b+c+d=100 atomic percent, 50 atomic percent≦a≦95 atomic percent, 5 atomic percent≦b≦40 atomic percent, 0≦c≦10 atomic percent, 0≦d<20 atomic percent, and 0<x<0.75.

As a metal texture consisting essentially of an amorphous phase, for instance, one that does not show any peak derived from a crystalline phase in X-ray diffraction can be cited.

(Aluminum and Si)

Al and Si are principal elements for the storage of lithium. When an atomic ratio x of Si becomes equal to or more than 0.75, a metal texture consisting essentially of an amorphous phase cannot be obtained, and the cycle life of a secondary battery decreases. A further preferable range of atomic ratio x is 0.3 or more and less than 0.75.

A total atomic ratio of Al and Si is in the range of 50 to 95 atomic percent. When the total atomic ratio is less than 50 atomic percent, since the lithium storage capacity of the negative electrode material becomes lower, the discharge capacity, the cycle life and the rate characteristics of the secondary battery become difficult to improve. On the other hand, when the total atomic ratio exceeds 95 atomic percent, there hardly occurs a lithium release reaction in the negative electrode material. A preferable range of the total atomic ratio is more than 67 atomic percent and 90 atomic percent or less, more preferable range being 70 atomic percent or more and 88 atomic percent or less.

(Element M)

Three kinds of elements of Al, Si and element M can promote the formation of an amorphous phase. Furthermore, the element M can suppress the negative electrode material from pulverizing when it stores or releases lithium. When the atomic ratio b of the element M is made less than 5 atomic percent, it is difficult to form an amorphous phase. On the other hand, when the atomic ratio b of the element M exceeds 40 atomic percent, the discharge capacity of a secondary battery is remarkably deteriorated. A more preferable range of the atomic ratio b of the element M is 7 to 35 atomic percent.

(Element M′)

As the rare earth element, for instance, La, Ce, Pr, Nd, Pm, Sm, Eu, Gd, Tb, Dy, Ho, Er, Tm, Yb, and Lu can be cited. Among these, La, Ce, Pr, Nd and Sm are desirable.

When the element M′ is contained 10 atomic percent or less, the formation of an amorphous phase can be promoted. Furthermore, it is also effective in suppressing the stored lithium ion from remaining in the alloy and in suppressing a capacity from lowering at the charge/discharge cycles. A preferable range of the atomic ratio c is 8 atomic percent or less. However, when the atomic ratio c is made smaller than 0.01 atomic percent, there is a likelihood of incapability of obtaining an effect promoting the formation of the amorphous phase and an effect of suppressing the lowering of the capacity at the charge/discharge cycles. Accordingly, the lower limit of the atomic ratio c is preferable to be 0.01 atomic percent.

(Element T) The element T can help the formation of the amorphous phase. When the atomic ratio d of the element T is in the range of less than 20 atomic percent, the capacity or the life can be improved. However, when the atomic ratio d is made 20 atomic percent or more, the cycle life deteriorates. A more preferable range of the atomic ratio d is 15 atomic percent or less.

In a nonaqueous electrolyte secondary battery comprising the first negative electrode material according to the present invention, there is no change in the composition of the alloy contained in the negative electrode material before the charge/discharge is applied. However, once the charge/discharge is applied, the composition of the alloy can change because of lithium remaining as an irreversible capacity. The composition of the alloy after the change can be expressed with a general formula (5) that will be described later.

<Second Negative Electrode Material for Use in Nonaqueous Electrolyte Secondary Batteries>

A second negative electrode material for use in nonaqueous electrolyte batteries according to the present invention contains an alloy that has a composition expressed by the following general formula (2) and consists essentially of an amorphous phase.

(Al_{1-X}A_{X})ₐM_{b}M′_{c}T_{d} (2)

Here, the A denotes Mg, or Si and Mg, the M denotes at least one kind of element selected from the group consisting of Fe, Co, Ni, Cu and Mn, the M′ denotes at least one kind of element selected from the group consisting of Ti, Zr, Hf, V, Nb, Ta, Cr, Mo, W, and rare earth elements, the T denotes at least one kind of element selected from the group consisting of C, Ge, Pb, P and Sn, and the a, b, c, d and x satisfy corresponding relationships of a+b+c+d=100 atomic percent, 50 atomic percent≦a≦95 atomic percent, 5 atomic percent≦b≦40 atomic percent, 0≦c≦10 atomic percent, 0≦d<20 atomic percent, and 0<x≦0.9.

As a metal texture consisting essentially of an amorphous phase, for instance, one that does not show any peak derived from a crystalline phase in X-ray diffraction can be cited.

(Aluminum and Element A)

Al and the element A (Mg, or Mg and Si) are principal elements in the storage of lithium. When an atomic ratio x of the element A exceeds 0.9, a metal texture consisting essentially of an amorphous phase cannot be obtained, and the cycle life and the rate characteristics of a secondary battery deteriorates. A further preferable range of the atomic ratio x is 0.3≦x≦0.8.

A total atomic ratio of Al and the element A is in the range of 50 to 95 atomic percent. When the total atomic percent is made less than 50 atomic percent, since the lithium storage capacity of the negative electrode material becomes lower, the discharge capacity, the cycle life and the rate characteristics of the secondary battery become difficult to improve. On the other hand, when the total atomic ratio exceeds 95 atomic percent, there hardly occurs a lithium release reaction in the negative electrode material. A preferable range of the total atomic ratio is in the range of 70 to 90 atomic percent.

(Element M)

Three kinds of elements of Al, element A and element M can promote the formation of an amorphous phase. Furthermore, the element M can suppress the negative electrode material from being pulverized when it stores or releases lithium. When the atomic ratio b of the element M is made less than 5 atomic percent, the formation of the amorphous phase becomes difficult. On the other hand, when the atomic ratio b of the element M exceeds 40 atomic percent, the discharge capacity of the secondary battery remarkably deteriorates. A more preferable range of the atomic ratio b of the element M is 7 to 35 atomic percent.

(Element M′)

As the rare earth elements, ones the same as those cited in the first negative electrode material can be cited. Among these, La, Ce, Pr, Nd and Sm are desirable.

When the element M′ is contained 10 atomic percent or less, the amorphous phase can be promoted in the formation thereof. Furthermore, it is also effective in suppressing the stored lithium ion from remaining in the alloy and in suppressing the capacity from lowering at the charge/discharge cycles. A more preferable range of the atomic ratio c is 8 atomic percent or less. However, when the atomic ratio c is made smaller than 0.01 atomic percent, there is a likelihood of being incapable of obtaining an effect of promoting the formation of the amorphous phase and an effect of suppressing the capacity from lowering at the charge/discharge cycles. Accordingly, the lower limit of the atomic ratio c is preferable to be 0.01 atomic percent.

(Element T)

The element T can help the formation of an amorphous phase. When the atomic ratio d of the element T is in the range of less than 20 atomic percent, the capacity or the life can be improved. However, when the atomic ratio d is made 20 atomic percent or more, the cycle life deteriorates. A furthermore preferable range of the atomic ratio d is 15 atomic percent or less.

In a nonaqueous electrolyte secondary battery comprising the second negative electrode material according to the present invention, there is no change in the composition of the alloy contained in the negative electrode material before the charge/discharge is applied. However, once the charge/discharge is applied, the composition of the alloy can change because of lithium remaining as an irreversible capacity. The composition of the alloy after the change can be expressed with a general formula (6) that will be described later.

The first and second negative electrode materials can be prepared according to, for instance, a melt quenching method, a mechanical alloying method, or a mechanical grinding method.

(Melt Quenching Method)

A melt quenching method is one in which a melt of an alloy whose composition is adjusted to a predetermined composition is ejected from a small nozzle onto a cooling body (for instance, a roll) that is rotating at a high speed, thereby the melt is cooled. As a shape of a sample obtained according to the melt quenching method, there can be cited, for instance, a long ribbon, a flake or the like. Since a melting point changes as the composition of a sample changes, the shape of the sample tends to change according to the composition. Furthermore, when a metal texture consists essentially of an amorphous phase, the long ribbon-like ones can be obtained with ease. On the other hand, a cooling speed is mainly dependent on a thickness of the sample obtained by the quenching, and the thickness of the sample is desirably controlled by a roll material, a roll peripheral speed and a nozzle opening.

The optimum roll material is determined in accordance with the wettability with the alloy melt, and a copper system alloy (for instance, Cu, TiCu, ZrCu, and BeCu) is preferable.

When the roll peripheral speed, though depending on the material composition, is set in the range of 20 to 60 m/s, the formation of the amorphous phase can be easily attained. When the roll peripheral speed is less than 20 m/s, a phase in which a microcrystalline phase and an amorphous phase are mixed tends to occur. On the other hand, when the roll peripheral speed exceeds 60 m/s, the alloy melt is difficult to sit on the cooling roll that is rotating at a high-speed. Accordingly, contrary to expectation, the cooling speed becomes lower and the microcrystalline phase tends to precipitate. Though depending on the composition, roughly speaking, at the roll peripheral speed of 10 m/s or more, an intended microcrystal can be obtained.

The nozzle opening is preferably set in the range of 0.3 to 2 mm. When the nozzle opening is less than 0.3 mm, the melt is ejected from the nozzle with difficulty. On the other hand, when the nozzle opening exceeds 2 mm, since a thicker sample tends to be formed, a sufficient cooling speed cannot be obtained.

Furthermore, a gap between the roll and the nozzle is preferably set in the range of 0.2 to 10 mm. However, even when the gap exceeds 10 mm, when the melt can be flowed in a laminar flow, the cooling speed can be uniformly increased. However, when the gap is widened, since a thicker sample tends to be obtained, as the gap is widened, the cooling speed becomes slower.

Since when the mass-production is performed, a large amount of heat is necessary to be deprived of the alloy melt, a heat capacity of the roll is preferably made larger. From the above situations, a roll diameter is preferable to be 300 mmφ or more, and a more preferable range is 500 mmφ or more. Furthermore, a width of the roll is preferable to be 50 mm or more, a furthermore preferable range being 100 mm or more.

(Mechanical Alloying/Mechanical Grinding Method)

Mechanical alloying and mechanical grinding are a method in which powder prepared so as to have a predetermined composition is put into a pot in an inert atmosphere, by the rotation of the pot, the powder is sandwiched with balls in the pot and transformed into an alloy owing to energy at that time.

The alloy that consists essentially of an amorphous phase and is prepared according to the melt quenching method, the mechanical alloying method or the mechanical grinding method may be heat-treated to make brittle. A temperature for the heat treatment, from a viewpoint of avoiding the formation of the microcrystalline phase, is preferably set at a temperature equal to a crystallization temperature or less.

Other than the aforementioned the melt quenching method, the mechanical alloying method and the mechanical grinding method, a gas atomization method, a rotating disc method, and a rotating electrode method can be applied to obtain powdery samples. Since these methods, when applied under the selected conditions, can generate spherical samples, the negative electrode material can be most closely packed in the negative electrode and is preferable in realizing a higher capacity battery.

<Third Negative Electrode Material for Use in Nonaqueous Electrolyte Batteries>

A third negative electrode material for use in nonaqueous electrolyte batteries contains an alloy that has a composition expressed by the following general formula (3) and contains a microcrystalline phase having an average crystal grain size of 500 nm or less.

(Al_{1-X}Si_{X})ₐM_{b}M′_{c}T_{d} (3)

Here, the M denotes at least one kind of element selected from the group consisting of Fe, Co, Ni and Mn, the M′ denotes at least one kind of element selected from the group consisting of Cu, Ti, Zr, Hf, V, Nb, Ta, Cr, Mo, W and rare earth elements, the T denotes at least one kind of element selected from the group consisting of C, Ge, Pb, P and Sn, and the a, b, c, d and x satisfy corresponding relationships of a+b+c+d=100 atomic percent, 50 atomic percent≦a≦95 atomic percent, 5 atomic percent≦b≦40 atomic percent, 0≦c≦10 atomic percent, 0≦d<20 atomic percent, and 0<x<0.75.

The third negative electrode material can consist essentially of either a microcrystalline phase or a composite phase between a microcrystalline phase and an amorphous phase.

The microcrystalline phase can be an intermetallic compound phase, a phase of a compound having a nonstoichiometric composition or a phase of an alloy having a nonstoichiometric composition, and in particular preferably a plurality of compounds or alloy phases in view of the cycle life and capacity.

When an average crystal grain size of the microcrystalline phase exceeds 500 nm, since the pulverization of the negative electrode material can be rapidly advanced, an electrical contact between the negative electrode material themselves or between the conductive agent and the negative electrode material decreases, as the results, the discharge capacity becomes lower and the charge/discharge cycle life deteriorates. A more preferable range of the average crystal grain size is 5 nm or more and 500 nm or less, a furthermore preferable range being 5 nm or more and 300 nm or less.

The average crystal grain size can be obtained from Scherrer's equation with a half-value width of an X-ray diffraction peak. Furthermore, it can be obtained also by taking a transmission electron (TEM) microgram, selecting arbitrarily 20 crystal grains, measuring the maximum diameter of each thereof, and averaging these. Most preferably, 50 crystal grains adjacent to each other in the transmission electron (TEM) microgram (for instance, 10⁵ magnification) are selected, a length of the longest portion of each of the crystal grains is measured as a crystal grain size, the obtained values thereof are averaged, and the averaged value is taken as an average crystal grain size. The magnification of the TEM microgram can be changed according to the crystal grain size being measured.

A ratio of a microcrystalline phase in a composite phase of the microcrystalline phase and the amorphous phase can be measured either by (a) differential scanning calorimetry (DSC) or by (b) an X-ray diffractometry.

(a) Differential Scanning Calorimetry (DSC)

When an alloy consisting essentially of an amorphous phase is measured by differential scanning calorimetry (DSC), it generates heat at a crystallization temperature, this amount of heat generation is taken as a standard calorific value. With an alloy whose ratio of a microcrystalline phase is unknown, the differential scanning calorimetry (DSC) is performed, and by comparing this calorific value with the standard calorific value, a ratio of the microcrystalline phase can be evaluated.

(b) X-ray Diffractometry

With a diffraction intensity of the strongest peak in the X-ray diffraction pattern of an alloy whose ratio of the microcrystalline phase is known as a reference, an intensity of the same diffraction peak of an alloy whose ratio of the microcrystalline phase is unknown is compared. Thereby, a ratio of the microcrystalline phase can be evaluated.

(Aluminum and Si)

Al and Si are principal elements for the storage of lithium. When an atomic ratio x of Si becomes equal to or more than 0.75, the cycle life of the secondary battery deteriorates. A further preferable range of atomic ratio x is 0.3 or more and less than 0.75.

A total atomic ratio of Al and Si is in the range of 50 to 95 atomic percent. When the total atomic ratio is less than 50 atomic percent, lithium storage capacity of the negative electrode material becomes lower, and the discharge capacity, the cycle life and the rate characteristics of the secondary battery become difficult to improve. On the other hand, when the total atomic ratio exceeds 95 atomic percent, there hardly occurs a lithium release reaction in the negative electrode material. A more preferable range of the total atomic ratio is more than 67 atomic percent and 90 atomic percent or less, a still more preferable range being 70 atomic percent or more and 88 atomic percent or less.

(Element M)

Three kinds of elements of Al, Si and the element M can promote the formation of a microcrystalline phase. Furthermore, the element M can suppress the negative electrode material from being pulverized when it stores or releases lithium. When the atomic ratio b of the element M is made less than 5 atomic percent, it is difficult to microcrstallize. On the other hand, when the atomic ratio b of the element M exceeds 40 atomic percent, the discharge capacity of the secondary battery is remarkably deteriorated. A more preferable range of the atomic ratio b of the element M is 7 to 35 atomic percent.

(Element M′)

As the rare earth element, ones the same as those explained in the first negative electrode material can be cited. Among these, La, Ce, Pr, Nd and Sm are desirable.

When the element M′ is contained 10 atomic percent or less, the microcrstallization can be advanced. Furthermore, it is also effective in suppressing stored lithium from remaining in the alloy and in suppressing capacity from lowering at the charge/discharge cycles. A more preferable range of the atomic ratio c is 8 atomic percent or less. However, when a magnitude of the atomic ratio c is made smaller than 0.01 atomic percent, there is a likelihood of being incapable of sufficiently obtaining a promotion effect of the microcrystallization and a suppression effect of the lowering of the capacity at the charge/discharge cycles. Accordingly, the lower limit of the atomic ratio c is preferable to be 0.01 atomic percent.

(Element T)

The element T can help the formation of the microcrystalline phase. When the element T is contained in the range of less than 20 atomic percent by atomic ratio d, the capacity or the life can be improved. However, when the atomic ratio d is made 20 atomic percent or more, the cycle life deteriorates. A more preferable range of the atomic ratio d is 15 atomic percent or less.

In a nonaqueous electrolyte secondary battery comprising the third negative electrode material according to the present invention, there is no change in the composition of the alloy contained in the negative electrode material before the charge/discharge is applied. However, once the charge/discharge is applied, the composition of the alloy can change because of lithium remaining as an irreversible capacity. The composition of the alloy after the change can be expressed with a general formula (7) that will be described later.

The third negative electrode material can be prepared according to methods, for instance, explained in the following (1) through (3).

(1) The alloy that is prepared according to the aforementioned melt quenching method, the mechanical alloying method or the mechanical grinding method and consists essentially of an amorphous phase is heat treated at a temperature equal to or more than a crystallization temperature thereof to precipitate a microcrystalline phase, and thereby the third negative electrode material is obtained. The crystallization temperature denotes a temperature that is obtained from the first peak of heat generation when a heat analysis is performed of the material. Specifically, when a measurement is performed, with a differential scanning calorimeter, at a temperature rise speed of 10° C./min, a temperature at an intersection point between an extension of a curve that shows a slightly change and a gradient having the most precipitous rise of the peak of heat generation is taken as the crystallization temperature. In particular, when the element M′ is slightly contained in the negative electrode material, an average crystal grain size can be easily controlled to 500 nm or less. Among the elements M′, only a slight addition of 4d, 4f and 5d transition metals such as Zr, Hf, Nb, Ta, Mo and W, or rare earth elements shows a high promotion effect in the microcrstallization. Among the elements M′, Ti, V and Cr can obtain a higher effect of the microcrstallization when an amount of addition is increased.

(2) Micro-crystallites can be directly precipitated by means of the melt quenching method. In this case, when the cooling speed of the melt is controlled, crystal grains having an appropriate crystal grain size can be precipitated with the optimum ratio. The cooling speed depends on a thickness of the material being cooled and the control of the thickness thereof is preferably performed by the peripheral speed of the cooling roll, the roll material and a feed amount of the melt (nozzle opening). The alloy prepared according to the melt quenching method can undergo the heat treatment to control the embrittlement. And the alloy prepared according to the melt quenching method can undergo the heat treatment to control the metal texture, thereby controlling the crystal grain size or a precipitation ratio of the microcrystalline phase.

(3) The third negative electrode material can be obtained according to the mechanical alloying or the mechanical grinding.

<Fourth Negative Electrode Material for Use in Nonaqueous Electrolyte Batteries>

A fourth negative electrode material for use in nonaqueous electrolyte batteries contains an alloy that has a composition expressed by a general formula (4) and contains a microcrystalline phase whose average crystal grain size is 500 nm or less.

(Al_{1-X}A_{X})ₐM_{b}M′_{c}T_{d} (4)

Here, the A denotes Mg, or Si and Mg, the M denotes at least one kind of element selected from the group consisting of Fe, Co, Ni and Mn, the M′ denotes at least one kind of element selected from the group consisting of Cu, Ti, Zr, Hf, V, Nb, Ta, Cr, Mo, W, and rare earth elements, the T denotes at least one kind of element selected from the group consisting of C, Ge, Pb, P and Sn, and the a, b, c, d and x satisfy corresponding relationships of a+b+c+d=100 atomic percent, 50 atomic percent≦a≦95 atomic percent, 5 atomic percent≦b≦40 atomic percent, 0≦c≦10 atomic percent, 0≦d<20 atomic percent, and 0<x≦0.9.

The fourth negative electrode material can consist essentially of either of a microcrystalline phase or a composite phase between the microcrystalline phase and an amorphous phase.

The microcrystalline phase can be an intermetallic compound, a compound having a nonstoichiometric composition or an alloy having a nonstoichiometric composition, and particularly preferably a plurality of compounds or alloy phases in view of the cycle life and capacity.

The reason for the average crystal grain size of the microcrystalline phase being made 500 nm or less is due to the reason similar to that explained in the third negative electrode material. A more preferable range of the average crystal grain size is 5 nm or more and 500 nm or less, a furthermore preferable range being 5 nm or more and 300 nm or less.

The average crystal grain size can be obtained from a half-value width of the X-ray diffraction peak with help of Scherrer's equation. Furthermore, it can be obtained also by taking a transmission electron microgram (TEM), selecting arbitrarily 20 crystal grains therefrom, measuring the maximum diameter of each thereof, and averaging these. Most preferably, in the transmission electron microgram (TEM) (for instance, 10⁵ magnification), 50 crystal grains adjacent to each other are selected, the longest length of each of the crystal grains is measured, the obtained values are averaged, and the averaged value is taken as an average crystal grain size. The magnification of the TEM microgram can be changed according to the crystal grain sizes being measured.

A ratio of the microcrystalline phase in a composite phase of the microcrystalline phase and the amorphous phase can be measured either by (a) differential scanning calorimetry (DSC) or by (b) an X-ray diffractometry. The measurements by the differential scanning calorimetry and the X-ray diffractometry are performed in the ways similar to those explained in the above third negative electrode material.

(Aluminum and Element A)

Al and the element A (Mg, or Mg and Si) are principal elements for the storage of lithium. When an atomic ratio x of the element A exceeds 0.9, the formation of the microcrystalline phase is difficult, and the cycle life and the rate characteristics of the secondary battery deteriorate. A more preferable range of the atomic ratio x is 0.3≦x≦0.8.

A total atomic ratio of Al and the element A is in the range of 50 to 95 atomic percent. When the total atomic ratio is made less than 50 atomic percent, the lithium storage capacity of the negative electrode material becomes lower, and the discharge capacity, the cycle life and the rate characteristics of the secondary battery become difficult to improve. On the other hand, when the total atomic ratio exceeds 95 atomic percent, there hardly occurs a lithium release reaction in the negative electrode material. A preferable range of the total atomic ratio is from 70 to 90 atomic percent.

(Element M)

Three kinds of elements of Al, the element A and the element M can promote the microcrystallization. Furthermore, the element M can suppress the negative electrode material from pulverizing when it stores or releases lithium. When the atomic ratio b of the element M is made less than 5 atomic percent, it is difficult to microcrystallize. On the other hand, when the atomic ratio b of the element M exceeds 40 atomic percent, the discharge capacity of the secondary battery remarkably deteriorates. A more preferable range of the atomic ratio b of the element M is from 7 to 35 atomic percent.

(Element M′)

As the rare earth element, ones the same as those explained in the first negative electrode material can be cited. Among these, La, Ce, Pr, Nd and Sm are desirable.

From the same reason as that explained in the third negative electrode material, the element M′ is preferably contained 10 atomic percent or less. A more preferable atomic ratio c is in the range of 8 atomic percent or less. Furthermore, from the same reason as that explained in the above third negative electrode material, the lower limit of the atomic ratio c is preferably set at 0.01 atomic percent.

(Element T)

The reason for the atomic ratio d of the element T being made less than 20 atomic percent is due to the same reason as that explained in the above third negative electrode material. A more preferable range of the atomic ratio d is 15 atomic percent or less.

In a nonaqueous electrolyte secondary battery comprising the fourth negative electrode material according to the present invention, there is no change in the composition of the alloy contained in the negative electrode material before the charge/discharge is applied. However, once the charge/discharge is applied, the composition of the alloy can change because of lithium remaining as an irreversible capacity. The composition of the alloy after the change can be expressed with a general formula (8) that will be described later.

The fourth negative electrode material can be prepared according to any one of the methods, for instance, (1) through (3) explained in the above third negative electrode material.

According to the above-explained first or the second negative electrode material for use in nonaqueous electrolyte batteries according to the present invention, a nonaqueous electrolyte battery can be realized in which the discharge capacity and charge/discharge cycle life are improved, even when the discharge rate is set at a higher value a higher discharge capacity can be obtained, and at a smaller number of repetition of charge/discharge, the maximum discharge capacity can be attained. Furthermore, a reason for the charge/discharge cycle life being improved according to the first or second negative electrode material is considered that since the metal texture is consisting essentially of the amorphous phase, an expansion of a crystal lattice at the lithium storage is suppressed, resulting in the suppression of the pulverization.

According to the third or the fourth negative electrode material for use in nonaqueous electrolyte batteries according to the present invention, a nonaqueous electrolyte battery can be realized in which the discharge capacity and the charge/discharge cycle life are improved, even when the discharge rate is set at a higher value a higher discharge capacity is obtained, and at a smaller number of repetition of charge/discharge, the maximum discharge capacity can be attained. The reason for the charge/discharge cycle life being improved according to the third or fourth negative electrode material is considered that since the negative electrode material has a metal texture that contains a microcrystalline phase whose average crystal grain size is 500 nm or less, at the storage of lithium, distortion accompanying the crystal lattice expansion is suppressed, resulting in suppressing the pulverization.

Furthermore, in the first through fourth negative electrode materials for use in nonaqueous electrolyte batteries, since lithium is not contained in constituent elements of the alloys, at the time of synthesizing the negative electrode materials, handling thereof is simple, and when the negative electrode material is prepared by use of the melt quenching method, since there is no risk of such as catching fire, the mass-production can be easily performed. Furthermore, in an alloy system that does not contain lithium, since an activation energy from the amorphous phase, metastable phase to a stable phase is high, or crystal grain growth of the microcrystalline phase is slow, the crystal structure itself is stable. Accordingly, the negative electrode materials are advantageous to the cycle life of the electrode characteristics. Furthermore, these materials are less influenced by the fluctuation of the heat treatment conditions, resulting in an improvement of the product yield of the negative electrode materials.

Subsequently, fifth through eighth negative electrode materials for nonaqueous electrolyte batteries according to the present invention will be explained.

<Fifth Negative Electrode Material for Use in Nonaqueous Electrolyte Batteries>

A fifth negative electrode material for use in nonaqueous electrolyte batteries according to the present invention contains an alloy that has a composition expressed by the following general formula (5) and consists essentially of an amorphous phase.

[(Al_{1-X}Si_{X})ₐM_{b}M′_{c}T_{d}]_{y}Li_{z} (5)

Here, the M denotes at least one kind of element selected from the group consisting of Fe, Co, Ni, Cu and Mn, the M′ denotes at least one kind of element selected from the group consisting of Ti, Zr, Hf, V, Nb, Ta, Cr, Mo, W, and rare earth elements, the T denotes at least one kind of element selected from the group consisting of C, Ge, Pb, P and Sn, and the a, b, c, d, x, y and z satisfy corresponding relationships of a+b+c+d=1, 0.5≦a≦0.95, 0.05≦b≦0.4, 0≦c≦0.1, 0≦d<0.2, 0<x<0.75, y+z=100 atomic percent, and 0<z≦50 atomic percent.

As a metal texture consisting essentially of an amorphous phase, for instance, one that does not show any peak derived from the crystal phase in X-ray diffraction can be cited.

(Aluminum and Si)

Al and Si are principal elements for the storage of lithium. The reason for Si being contained at an atomic ratio x of less than 0.75 is due to the reason similar to that explained in the first negative electrode material. A further preferable range of atomic ratio x is 0.3 or more and less than 0.75.

The reason for a total atomic ratio of Al and Si being set in the range of 0.5 to 0.95 is due to the reason similar to that explained in the first negative electrode material. A preferable range of the total atomic ratio is more than 0.67 and 0.9 or less, a more preferable range being 0.7 or more and 0.88 or less.

(Element M)

The reason for the atomic ratio b of the element M being set in the range of 0.05 to 0.4 is due to the reason similar to that explained in the first negative electrode material. A more preferable range of the atomic ratio b of the element M is from 0.07 to 0.35.

(Element M′)

As the rare earth element, ones similar to those as explained in the first negative electrode material can be cited. Among these, La, Ce, Pr, Nd and Sm are desirable.

From the reason similar to that explained in the first negative electrode material, the element M′ is preferably contained 0.1 or less by atomic ratio c. A more preferable range of the atomic ratio c is 0.08 or less. Furthermore, from the reason similar to that explained in the above first negative electrode material, the lower limit of the atomic ratio c is preferably set at 0.0001.

(Element T)

The reason for the atomic ratio d of the element T being set at less than 0.2 is due to the reason similar to that explained in the above first negative electrode material. A more preferable range of the atomic ratio d is 0.15 or less.

(Li)

Lithium is an element that shoulders a charge transfer in a nonaqueous electrolyte battery. Accordingly, when lithium is contained as an alloy constituent element, an amount of lithium storage and release at the negative electrode can be improved and the discharge capacity and the charge/discharge cycle life can be improved. Furthermore, since the fifth negative electrode material can be easily activated in comparison with the first negative electrode material, the maximum discharge capacity can be attained at relatively earlier stage of the charge/discharge cycle.

When the lithium is not contained in the constituent elements as in the first negative electrode material, in a positive electrode active material, a lithium-containing compound such as a lithium composite oxide is necessary to be used. According to the fifth negative electrode material, since a compound that does not contain lithium in the constituent elements can be used as a positive electrode active material, kinds of usable positive electrode active materials can be widened. However, when the content z of lithium exceeds 50 atomic percent, the formation of the amorphous phase becomes difficult. A more preferable range of the lithium content z is 25 atomic percent or less.

The fifth negative electrode material can be prepared by means of, for instance, a melt quenching method, a mechanical alloying method, a mechanical grinding method, a gas atomizing method, a rotating disc method or a rotating electrode method. Each of the above methods is preferably performed under the conditions similar to those explained in the above first negative electrode material.

<Sixth Negative Electrode Material for Use in Nonaqueous Electrolyte Batteries>

A sixth negative electrode material for use in nonaqueous electrolyte batteries according to the present invention contains an alloy that has a composition expressed by the following general formula (6) and consists essentially of an amorphous phase.

[(Al_{1-X}A_{X})ₐM_{b}M′_{c}T_{d}]_{y}Li_{z} (6)

Here, the A denotes Mg, or Si and Mg, the M denotes at least one kind of element selected from the group consisting of Fe, Co, Ni, Cu and Mn, the M′ denotes at least one kind of element selected from the group consisting of Ti, Zr, Hf, V, Nb, Ta, Cr, Mo, W, and rare earth elements, the T denotes at least one kind of element selected from the group consisting of C, Ge, Pb, P and Sn, and the a, b, c, d, x, y and z satisfy corresponding relationships of a+b+c+d=1, 0.5≦a≦0.95, 0.05≦b≦0.4, 0≦c≦0.1, 0≦d<0.2, 0<x≦0.9, y+z=100 atomic percent, and 0<z≦50 atomic percent.

As a metal texture consisting essentially of an amorphous phase, for instance, one that does not show any peak derived from the crystal phase in X-ray diffraction can be cited.

(Aluminum and Element A)

Al and element A are principal elements for the lithium storage. The reason for the element A being contained at an atomic ratio x of 0.9 or less is due to the reason similar to that explained in the second negative electrode material. A further preferable range of atomic ratio x is 0.3≦x≦0.8.

The reason for a total atomic ratio of Al and the element A being set in the range of 0.5 to 0.95 is due to the reason similar to that explained in the second negative electrode material. A preferable range of the total atomic ratio is 0.7 to 0.9.

(Element M)

The reason for the atomic ratio b of the element M being set in the range of 0.05 to 0.4 is due to the reason similar to that explained in the second negative electrode material. A more preferable range of the atomic ratio b of the element M is from 0.07 to 0.35.

(Element M′)

As the rare earth element, ones similar to those explained in the first negative electrode material can be cited. Among these, La, Ce, Pr, Nd and Sm are desirable.

From the reasons similar to those explained in the second negative electrode material, the element M′ is preferably contained 0.1 or less by atomic ratio c. A more preferable range of the atomic ratio c is 0.08 or less. Furthermore, from the reasons similar to those explained in the above second negative electrode material, the lower limit of the atomic ratio c is preferably set at 0.0001.

(Element T)

The reason for the atomic ratio d of the element T being set less than 0.2 is due to the reasons similar to those explained in the above second negative electrode material. A more preferable range of the atomic ratio d is 0.15 or less.

(Li)

When lithium is contained as an alloy constituent element, an amount of lithium storage and release at the negative electrode can be improved, and the discharge capacity and the charge/discharge cycle life can be improved. Furthermore, since the sixth negative electrode material can be easily activated in comparison with the second negative electrode material, the maximum discharge capacity can be attained at relatively earlier stage of the charge/discharge cycle.

Furthermore, according to the sixth negative electrode material, since a compound that does not contain lithium in the constituent elements can be used as a positive electrode active material, kind of usable positive electrode active materials can be expanded. However, when the content z of lithium exceeds 50 atomic percent, the formation of an amorphous phase becomes difficult. A more preferable range of the lithium content z is 25 atomic percent or less.

The sixth negative electrode material can be prepared by means of, for instance, a melt quenching method, a mechanical alloying method, a mechanical grinding method, a gas atomizing method, a rotating disc method or a rotating electrode method. Each of the above methods is preferably performed under the conditions similar to those explained in the above first negative electrode material.

<Seventh Negative Electrode Material for Use in Nonaqueous Electrolyte Batteries>

A seventh negative electrode material for use in nonaqueous electrolyte batteries according to the present invention contains an alloy that has a composition expressed by the following general formula (7) and contains a microcrystalline phase whose average crystal grain size is 500 nm or less.

[(Al_{1-X}Si_{X})ₐM_{b}M′_{c}T_{d}]_{y}Li_{z} (7)

Here, the M denotes at least one kind of element selected from the group consisting of Fe, Co, Ni and Mn, the M′ denotes at least one kind of element selected from the group consisting of Cu, Ti, Zr, Hf, V, Nb, Ta, Cr, Mo, W, and rare earth elements, the T denotes at least one kind of element selected from the group consisting of C, Ge, Pb, P and Sn, and the a, b, c, d, x, y and z satisfy corresponding relationships of a+b+c+d=1, 0.5≦a≦0.95, 0.05≦b≦0.4, 0≦c≦0.1, 0≦d<0.2, 0<x<0.75, y+z=100 atomic percent, and 0<z≦50 atomic percent.

The seventh negative electrode material can consist essentially of either of a microcrystalline phase or a composite phase of the microcrystalline phase and an amorphous phase.

The microcrystalline phase can be an intermetallic compound phase, a phase of a compound having a nonstoichiometric composition or a phase of an alloy having a nonstoichiometric composition, and in particular preferably a plurality of compounds or alloy phases in view of the cycle life and capacity thereof.

The reason for an average crystal grain size of the microcrystalline phase being set at 500 nm or less is due to the reason similar to that explained in the third negative electrode material. A more preferable range of the average crystal grain size is 5 nm or more and 500 nm or less, a furthermore preferable range being 5 nm or more and 300 nm or less.

The average crystal grain size can be obtained from a half-value width of the X-ray diffraction peak with help of Scherrer's equation. Furthermore, it can be obtained also by taking a transmission electron microgram (TEM), selecting arbitrarily 20 crystal grains therefrom, measuring the maximum diameter of each thereof, and averaging these. Most preferably, in the transmission electron microgram (TEM) (for instance, 10⁵ magnification), 50 crystal grains adjacent to each other are selected, the longest length of each of the crystal grains is measured, the obtained values are averaged, and the averaged value is taken as an average crystal grain size. The magnification of the TEM microgram can be changed according to the crystal grain sizes being measured.

A ratio of the microcrystalline phase in the composite phase of the microcrystalline phase and the amorphous phase can be measured either by (a) differential scanning calorimetry (DSC) or by (b) an X-ray diffractometry. The measurements due to the differential scanning calorimetry and the X-ray diffractometry are performed in the ways similar to those explained in the above third negative electrode material.

(Aluminum and Si)

Al and Si are principal elements for the storage of lithium. The reason for the element A being contained less than 0.75 by the atomic ratio x is due to the reason similar to that explained in the third negative electrode material. A further preferable range of atomic ratio x is 0.3 or more and less than 0.75.

The reason for a total atomic ratio of Al and Si being set in the range of 0.5 to 0.95 is due to the reason similar to that explained in the third negative electrode material. A more preferable range of the total atomic ratio is more than 0.67 and 0.9 or less, a further preferable range being 0.7 or more and 0.88 or less.

(Element M)

The reason for the atomic ratio b of the element M being set in the range of 0.05 to 0.4 is due to the reason similar to that explained in the third negative electrode material. A more preferable range of the atomic ratio b of the element M is from 0.07 to 0.35.

(Element M′)

As the rare earth element, ones similar to those explained in the first negative electrode material can be cited. Among these, La, Ce, Pr, Nd and Sm are desirable.

From the reason similar to that explained in the third negative electrode material, the element M′ is preferably contained 0.1 or less by atomic ratio. A more preferable atomic ratio c is in the range of 0.08 or less. Furthermore, from the reason similar to that explained in the above third negative electrode material, the lower limit of the atomic ratio c is preferably set at 0.0001.

(Element T)

The reason for the atomic ratio d of the element T being set less than 0.2 is due to the reason similar to that explained in the above third negative electrode material. A more preferable range of the atomic ratio d is 0.15 or less.

(Li)

When lithium is contained as an alloy constituent element, an amount of lithium storage and release at the negative electrode can be improved, and the discharge capacity and the charge/discharge cycle life can be improved. Furthermore, since the seventh negative electrode material can be more easily activated in comparison with the third negative electrode material, the maximum discharge capacity can be attained at a relatively earlier stage of the charge/discharge cycle.

Furthermore, according to the seventh negative electrode material, since a compound that does not contain lithium in the constituent elements can be used as a positive electrode active material, kinds of usable positive electrode active materials can be expanded. However, when the content z of lithium exceeds 50 atomic percent, the formation of the microcrystalline phase becomes difficult. A more preferable range of the lithium content z is 25 atomic percent or less.

The seventh negative electrode material can be prepared by means of, for instance, any one of (1) through (3) explained in the third negative electrode material.

<Eighth Negative Electrode Material for Use in Nonaqueous Electrolyte Batteries>

An eighth negative electrode material for use in nonaqueous electrolyte batteries according to the present invention contains an alloy that has a composition expressed by the following general formula (8) and contains a microcrystalline phase whose average crystal grain size is 500 nm or less.

[(Al_{1-X}A_{X})ₐM_{b}M′_{c}T_{d}]_{y}Li_{z} (8)

Here, the A is made of Mg, or Si and Mg, the M denotes at least one kind of element selected from the group consisting of Fe, Co, Ni and Mn, the M′ denotes at least one kind of element selected from the group consisting of Cu, Ti, Zr, Hf, V, Nb, Ta, Cr, Mo, W, and rare earth elements, the T denotes at least one kind of element selected from the group consisting of C, Ge, Pb, P and Sn, and the a, b, c, d, x, y and z satisfy corresponding relationships of a+b+c+d=1, 0.5≦a≦0.95, 0.05≦b≦0.4, 0≦c≦0.1, 0≦d<0.2, 0<x≦0.9, y+z=100 atomic percent, and 0<z≦50 atomic percent.

The eighth negative electrode material can consist essentially of either of a microcrystalline phase or a composite phase of the microcrystalline phase and an amorphous phase.

The microcrystalline phase can be an intermetallic compound phase, a phase of a compound having a nonstoichiometric composition or a phase of an alloy having a nonstoichiometric composition, and in particular preferably a plurality of compounds or alloy phases in view of the life and capacity thereof.

The reason for the average crystal grain size of the microcrystalline phase being set at 500 nm or less is due to the reason similar to that explained in the third negative electrode material. A more preferable range of the average crystal grain size is 5 nm or more and 500 nm or less, furthermore preferable range being 5 nm or more and 300 nm or less.

The average crystal grain size can be obtained from a half-value width of the X-ray diffraction peak with help of Scherrer's equation. Furthermore, it can be obtained also by taking a transmission electron microgram (TEM), selecting arbitrarily 20 crystal grains therefrom, measuring the maximum diameter of each thereof, and averaging these. Most preferably, in the transmission electron microgram (TEM) (for instance, 10⁵ magnification), 50 crystal grains adjacent to each other are selected, the maximum length of each of the crystal grains is measured, the obtained values are averaged, and the averaged value is taken as an average crystal grain size. The magnification of the TEM microgram can be changed according to the crystal grain sizes being measured.

A ratio of a microcrystalline phase in a composite phase of the microcrystalline phase and an amorphous phase can be measured either by (a) differential scanning calorimetry (DSC) or by (b) an X-ray diffractometry. The measurements by the differential scanning calorimetry and the X-ray diffractometry are performed in the ways similar to those explained in the above third negative electrode material.

(Aluminum and Element A)

Al and element A (Mg, or Mg and Si) are principal elements for the storage of lithium. The reason for the element A being contained 0.9 or less by the atomic ratio x is due to the reason similar to that explained in the fourth negative electrode material. A further preferable range of the atomic ratio x is 0.3≦x≦0.8.

The reason for a total atomic ratio of Al and the element A being set in the range of 0.5 to 0.95 is due to the reason similar to that explained in the fourth negative electrode material. A more preferable range of the total atomic ratio is from 0.7 to 0.9.

(Element M)

The reason for the atomic ratio b of the element M being in the range of 0.05 to 0.4 is due to the reason similar to that explained in the fourth negative electrode material. A more preferable range of the atomic ratio b of the element M is from 0.07 to 0.35.

(Element M′)

As the rare earth element, ones similar to those explained in the first negative electrode material can be cited. Among these, La, Ce, Pr, Nd and Sm are desirable.

From the reason similar to that explained in the third negative electrode material, the element M′ is preferably contained 0.1 or less by atomic ratio c. A more preferable atomic ratio c is in the range of 0.08 or less. Furthermore, from the reason similar to that explained in the above third negative electrode material, the lower limit of the atomic ratio c is preferably set at 0.0001.

(Element T)

The reason for the atomic ratio d of the element T being set less than 0.2 is due to the reason similar to that explained in the above third negative electrode material. A more preferable range of the atomic ratio d is 0.15 or less.

(Li)

When lithium is contained as an alloy constituent element, an amount of lithium storage and release at a negative electrode can be improved, and the discharge capacity and the charge/discharge cycle life can be improved. Furthermore, since the eighth negative electrode material can be easily activated in comparison with the fourth negative electrode material, the maximum discharge capacity can be attained at a relatively earlier stage of the charge/discharge cycle.

Furthermore, according to the eighth negative electrode material, since a compound that does not contain lithium in the constituent elements can be used as a positive electrode active material, kinds of usable positive electrode active materials can be expanded. However, when the content z of lithium exceeds 50 atomic percent, the formation of the microcrystalline phase becomes difficult. A more preferable range of the lithium content z is 25 atomic percent or less.

The eighth negative electrode material can be prepared by means of, for instance, any one of (1) through (3) explained in the third negative electrode material.

According to the above-explained fifth or sixth negative electrode material for use in nonaqueous electrolyte batteries according to the present invention, a nonaqueous electrolyte battery can be realized in which the discharge capacity and the charge/discharge cycle life are improved, even when the discharge rate is set at a higher rate a higher discharge capacity is obtained, and at a smaller repetition number of charge/discharge the maximum discharge capacity is attained. It is considered that the reason for the charge/discharge cycle life being improved when the fifth or sixth negative electrode material is used is in that since a metal texture consists essentially of the amorphous phase, an expansion of a crystal lattice at the storage of lithium is alleviated, resulting in suppressing the pulverization from occurring.

According to the seventh or eighth negative electrode material for use in nonaqueous electrolyte batteries according to the present invention, a nonaqueous electrolyte battery can be realized in which the discharge capacity and the charge/discharge cycle life are improved, even when the discharge rate is set at a higher rate a higher discharge capacity is obtained, and at a smaller number of repetitions of charge/discharge the maximum discharge capacity is attained. It is considered that the reason for the charge/discharge cycle life being improved when the seventh or eighth negative electrode material is used is in that owing to the metal texture that contains the microcrystalline phase whose average crystal grain size is 500 nm or less, distortion accompanying a crystal lattice expansion at the storage of lithium is alleviated, resulting in suppressing the pulverization from occurring.

<Ninth Negative Electrode Material for Use in Nonaqueous Electrolyte Batteries>

A ninth negative electrode material for use in nonaqueous electrolyte batteries according to the present invention is a negative electrode material that can store and release lithium. In the present negative electrode material, when a differential scanning calorimetry (DSC) is performed at a temperature rise speed of 10° C./min., at least one peak of heat generation is exhibited in the range of 200 to 450° C., and in the X-ray diffraction prior to the differential scanning calorimetry a peak derived from a crystalline phase appears.

By use of a differential scanning calorimeter (DSC), a thermal process that transits from a nonequilibrium state to an equilibrium state can be studied. The peak of heat generation that appears at the differential scanning calorimetry (DSC) corresponds to a thermal process generated when a nonequilibrium state transits to a state more stable than that. A negative electrode material in which in the X-ray diffraction, a peak derived from a crystalline phase appears, and when, after the X-ray diffraction measurement, the differential scanning calorimetry (DSC) is performed at the temperature rise speed of 10° C./min. at least one peak of heat generation appears in the range of 200 to 450° C. contains a nonequilibrium phase that is not an amorphous phase, and can improve the charge/discharge cycle life of a secondary battery. It is supposed that to an improvement of the charge/discharge cycle life, an improvement of a diffusion speed of lithium ion owing to the nonequilibrium phase contributes. In order to further improve the charge/discharge cycle life, it is more preferable for the temperature range in which the peak of heat generation appears to be in the range of 220 to 400° C.

The number of the peaks of heat generation, being different according to the composition, is not particularly restricted. That is, since a process from a nonequilibrium state to an equilibrium state is different depending on the composition, the number of steps thereof cannot be restricted to a particular one, however, there usually appear one to four peaks of heat generation.

The nonequilibrium phase contained in the ninth negative electrode material according to the present invention is desirable to have either a cubic fluorite structure (CaF₂) or a cubic inverse fluorite structure. A lattice constant of such a crystal phase is preferable to be 5.42 Å or more and 6.3 Å or less. This is due to the following reasons. When the lattice constant is made less than 5.42 Å, there is a likelihood of incapability of obtaining a higher capacity. On the other hand, when the lattice constant is larger than 6.3 Å, there is a likelihood of difficulty in sufficiently improving the charge/discharge cycle life. A more preferable range of the lattice constant is 5.45 to 6 Å, a further preferable range being 5.5 to 5.9 Å.

A nonequilibrium phase that has a cubic fluorite structure having a lattice constant of 5.42 Å or more and 6.3 Å or less or an inverse fluorite structure having the lattice constant in the same range can be easily obtained when the nonequilibrium phase has a composition that contains Al, Si and Ni or a composition that contains Al, Si and Co. Even when Ni or Co in such a composition is partially replaced by other element (for instance, Fe, Nb and La), the aforementioned crystal structure can be obtained. In particular, the preferable ones of the nonequilibrium phases having such a crystal structure are a solid solution phase in which an Al-dissolved Si₂Ni phase, a solid solution phase in which an Al-dissolved Si₂Co phase, ones obtained by partially replacing Ni or Si in the Si₂Ni phase by other element (for instance, Co, Fe, Cu, Mn, Ti, Zr, Hf, Nb, Ta, Cr, La, Ce, Pr and Nd), and ones obtained by partially replacing Co or Si in the Si₂Co phase by other element (for instance, Fe, Ni, Nb, and La). The kind of the nonequilibrium phases contained in the alloy may be one kind or two or more kinds.

The nonequilibrium phase that is contained in the ninth negative electrode material according to the present invention and is not an amorphous phase is preferable to have an average crystal grain size in the range of 5 nm to 500 nm. This is due to the reasons explained in the following. When the average crystal grain size is less than 5 nm, since the crystal grains are too small, it becomes almost difficult to store lithium, resulting in the likelihood of being incapable of obtaining a higher capacity. On the other hand, when the average crystal grain size exceeds 500 nm, there is the likelihood of the pulverization of the negative electrode material being advanced and the charge/discharge cycle life being deteriorated. A more preferable range of the average crystal grain size is 10 to 400 nm.

An average crystal grain size of the nonequilibrium phase can be obtained by selecting mutually adjacent 50 crystal grains in a transmission electron (TEM) microgram (for instance, 10⁵ magnification), measuring the longest length of each of the crystal grains as a crystal grain size, and calculating an average value thereof. The magnification of the TEM microgram can be changed according to the crystal grain sizes being measured.

<Tenth Negative Electrode Material for Use in Nonaqueous Electrolyte Batteries>

The tenth negative electrode material for use in nonaqueous electrolyte batteries according to the present invention is a negative electrode material for use in nonaqueous electrolyte batteries that comprises an intermetallic compound phase (a first phase) containing at least two kinds of elements capable of forming an alloy with lithium and a second phase containing an element capable of forming an alloy with lithium. The present negative electrode material exhibits, in powder X-ray diffraction, peaks due to the intermetallic compound phase (the first phase) at least from 3.13 to 3.64 Å and from 1.92 to 2.23 Å by d-value, and a peak derived from the second phase at least from 2.31 to 2.4 Å by the d-value.

The first phase is preferable to exhibit, in the powder X-ray diffraction, diffraction peaks at least from 3.13 to 3.64 Å and from 1.92 to 2.23 Å by the d-value. At the same time, the second phase is preferable to exhibit, in the powder X-ray diffraction, a peak at least from 2.31 to 2.4 Å by the d-value. When any one of the diffraction peaks of from 3.13 to 3.64 Å, from 1.92 to 2.23 Å, and from 2.31 to 2.4 Å does not appear, the discharge capacity, charge/discharge cycle life or the discharge rate characteristics deteriorate.

In view of a further improvement in the discharge rate characteristics of the battery, the first phase is preferable to exhibit, in the powder X-ray diffraction, further peaks in the respective ranges of 1.64 to 1.9 Å, 1.36 to 1.58 Å, and 1.25 to 1.45 Å by the d-value. Furthermore, the second phase is preferable to exhibit, in the powder X-ray diffraction, further diffraction peaks in the respective ranges of 2 to 2.08 Å, 1.41 to 1.47 Å, and 1.21 to 1.25 Å by the d-value.

The d-values in the powder X-ray diffractions of the first and second phases can be changed according to the composition, or a state of melt quenching, or a process such as a subsequent heat treatment.

<Eleventh Negative Electrode Material for Use in Nonaqueous Electrolyte Batteries>

An eleventh negative electrode material for use in nonaqueous electrolyte batteries according to the present invention includes;

a first phase in which crystal grains of an intermetallic compound whose average crystal grain size is 5 nm to 500 nm and that contain two or more kinds of elements capable of forming an alloy with lithium, at least part of the crystal grains are precipitated isolated from each other; and

a second phase that is precipitated so as to fill in the isolated crystal grains and contains an element capable of forming an alloy with lithium.

A metal texture of the eleventh negative electrode material according to the present invention will be explained with reference to FIG. 5.

The eleventh negative electrode material according to the present invention has a metal texture that includes a first phase in which crystal grains 21 of an intermetallic compound are precipitated isolated from each other, and a second phase 22 that is precipitated so as to fill in between the crystal grains 21 of the intermetallic compound. Furthermore, the metal texture has an island structure in which the isolated crystal grains 21 correspond to islands, and the second phase 22 corresponds to a sea. In FIG. 5, although only islands that are formed by precipitating the crystal grains 21 of the intermetallic compound singly and isolated from each other are shown, in the metal texture there may be ones that are formed by precipitating two or more crystal grains 21 of the intermetallic compound that are mutually in contact. When the second phase 22 has a continuous network structure, a force that the first phase holds the second phase can be heightened. Accordingly, an effect of reducing the distortion accompanying the storage and release of lithium of the second phase can be increased. However, there are tendencies in that a plurality of crystal grains of the intermetallic compound are mutually in contact, or the second phase coagulates owing to heat treatment. As a result, the network structure is broken and the second phase 22 is partially isolated. Even such a case is also included in the present invention. When the second phase 22 is isolated, the number of the islands a unit area decreases, or a distance L between islands tends to increase.

(First Phase)

The reasons for providing an average crystal grain size of crystal grains of the intermetallic compound in the above range are due to the followings. When the average crystal grain size is less than 5 nm, since the crystal grains are too small to store lithium, a higher capacity cannot be obtained. On the other hand, when the average crystal grain size exceeds 500 nm, since it becomes difficult for the intermetallic compound phase to absorb the distortion accompanying the lithium storage and release of the second phase, the negative electrode material is advanced in the pulverization, resulting in lowering the charge/discharge cycle life. A more preferable range of the average crystal grain size is 10 to 300 nm.

The average size of the crystal grains of the intermetallic compound can be obtained in a way that, in the transmission electron microgram (TEM) (for instance, 10⁵ magnification), 50 crystal grains adjacent to each other are selected, the maximum length of each of the crystal grains is measured, and the obtained values are averaged to obtain an average crystal grain size. The magnification of the TEM microgram can be changed according to the crystal grain sizes being measured. Furthermore, when two or more crystal grains of the intermetallic compound are in contact, the maximum length of each of crystal grains of the intermetallic compound that can be divided by a grain boundary is measured as a crystal grain size.

The reason for the number of crystal grains of the intermetallic compound being provided in the range of 10 pieces to 2000 pieces per an area of 1 μm² is due to the followings. That is, when the number of the crystal grains per an area of 1 μm² is less than 10 pieces, since a force that the first phase holds the second phase is weak and the distortion due to the lithium storage and release of the second phase becomes larger, the negative electrode material may be promoted in the pulverization and the charge/discharge cycle life may be lowered. On the other hand, when the number of the crystal grains of the intermetallic compound per an area of 1 μm² exceeds 2000 pieces, the lithium storage characteristics of the negative electrode material become lower and a higher capacity may not be obtained. When the number of the crystal grains of the intermetallic compound per an area of 1 μm² is made in the range of 10 pieces to 2000 pieces, expansion and contraction due to the lithium storage and release of the second phase can be sufficiently suppressed and the negative electrode material is suppressed from advancing in the pulverization, resulting in an improvement of the charge/discharge cycle characteristics. A more preferable range is 20 to 1800 pieces.

An average of the distances L between the crystal grains of the intermetallic compound is preferably set in the range of 500 nm or less. This is due to the following reasons. When the average of the distances L between the crystal grains is made larger than 500 nm, since it becomes difficult for the first phase to hold the second phase, the pulverization of the negative electrode material is advanced owing to the distortion due to the storage and release of lithium of the second phase, the charge/discharge cycle life may be deteriorated. When the average of the distances L between the crystal grains of the intermetallic compound is made in the range of 500 nm or less, since the crystal grains of the intermetallic compound surround the second phase and can hold the same, expansion and contraction due to the lithium storage and release of the second phase can be sufficiently suppressed and the negative electrode material can be suppressed from pulverizing, resulting in an improvement of the charge/discharge cycle life. A preferable range of the average of the distances between the crystal grains is 400 nm or less, a more preferable range being 300 nm or less.

The crystal grains of the intermetallic compound are desirable to have either a cubic fluorite structure (CaF₂) or a cubic inverse fluorite structure. The lattice constant of such crystal grains is preferable to be 5.42 Å or more and 6.3 Å or less. This is due to the following reasons. When the lattice constant is less than 5.42 Å, there is a likelihood of incapability of obtaining a high capacity. On the other hand, when the lattice constant is larger than 6.3 Å, there is a likelihood of difficulty in sufficiently improving the charge/discharge cycle life. When the lattice constant is in the range of 5.42 Å or more and 6.3 Å or less, since the expansion and contraction due to the lithium storage and release of the second phase can be sufficiently suppressed, the negative electrode material can be hindered from pulverizing, resulting in an improvement of the charge/discharge cycle life of the secondary battery. A more preferable range of the lattice constant is 5.45 to 6 Å, a further preferable range being 5.5 to 5.9 Å.

Furthermore preferable ones of crystal structures of the crystal grains of the intermetallic compound are a crystal structure A in which Al is dissolved in the form of solid solution in a fluorite (CaF₂) type Si₂Ni lattice, and a crystal structure B in which Al is dissolved in the form of solid solution in a fluorite type Si₂Co lattice. In the crystal structure A, Ni or Si in the Si₂Ni lattice may be partially replaced by other element (for instance, Co, Fe, Cu, Mn, Ti, Zr, Hf, Nb, Ta, Cr, La, Ce, Pr and Nd). On the other hand, in the crystal structure B, Co or Si in the Si₂Co lattice may be partially replaced by other element (for instance, Fe, Ni, Nb, La). In the eleventh negative electrode material according to the present invention, crystal grains of the intermetallic compound having the crystal structure A and those having the crystal structure B may coexist.

The first phase is preferable to be a nonequilibrium phase that exhibits, when the differential scanning calorimetry (DSC) is performed at a temperature rise speed of 10° C./min., at least one peak of heat generation in the range of 200 to 450° C. By configuring like this, the charge/discharge cycle life of a secondary battery can be further improved. The temperature range where the peak of heat generation appears is desirably set in the range of 220 to 400° C.

(Second Phase)

An occupation rate of the second phase in the negative electrode material is desirably set in the range of 1 to 50%. When the occupation rate of the second phase is less than 1%, lithium is hardly stored, resulting in a likelihood of incapability of obtaining a higher capacity. On the other hand, when the occupation rate of the second phase exceeds 50%, since it becomes difficult to suppress the negative electrode material from pulverizing, there is a likelihood of incapability of obtaining a longer cycle life. The preferable range of the occupation rate is 5 to 40%.

The occupation rate of the second phase in the negative electrode material can be measured by a method explained in the following. That is, in one visual field of a TEM microgram (though the magnification is changed in accordance with the crystal grain size, for instance, 10⁵ times), an entire area that includes at least 50 crystal grains of the intermetallic compound is assigned to 100%. An area ratio (%) of the first phase of the entire area is obtained by means of image processing. The area ratio (%) of the first phase is subtracted from the entire area (100%), an area ratio of the second phase, that is, an occupation rate of the second phase in the negative electrode material can be obtained. When two or more crystal grains of the intermetallic compound are in contact each other, these are not counted as one but as the number of crystal grains of the intermetallic compound that can be separated by the grain boundary.

The first phase is preferable to exhibit, in the powder X-ray diffraction, diffraction peaks at least in the ranges of from 3.13 to 3.64 Å and from 1.92 to 2.23 Å by d-value. At the same time, the second phase is preferable to exhibit, in the powder X-ray diffraction, a diffraction peak at least in the range of from 2.31 to 2.4 Å by the d-value. By thus configuring, the discharge rate characteristics of the battery can be further improved. The first phase is desirable to exhibit, in the X-ray diffraction, further diffraction peaks in the range of from 1.64 to 1.9 Å, from 1.36 to 1.58 Å, and from 1.25 to 1.45 Å by the d-value. Furthermore, the second phase is desirable to exhibit, in the X-ray diffraction, further diffraction peaks in the range of from 2 to 2.08 Å, from 1.41 to 1.47 Å, and from 1.21 to 1.25 Å by the d-value.

In the first and second phases of each of the tenth and eleventh negative electrode materials for use in nonaqueous electrolyte batteries according to the present invention, it is desirable to have a composition explained in the following.

(Composition of the First Phase)

As an element that is contained in the first phase and capable of forming an alloy with lithium, Al, In, Pb, Ga, Mg, Sb, Bi, Sn and Zn are preferable. For an element that is capable of forming an intermetallic compound with the element that is capable of forming an alloy with lithium, Ni or Co or both of Ni and Co is preferably used. Ni can be partially replaced with other element. As the other element, transition metal elements such as, for instance, Co, Fe and Nb, and rare earth elements such as La can be used. On the other hand, as the other element that can partially replace Co, transition metal elements such as, for instance, Fe and Nb, and rare earth elements such as La can be cited. The kind of the other element can be one kind or two kinds or more.

(Composition of the Second Phase)

The second phase contains an element capable of forming an alloy with lithium, and elements other than this are allowed to dissolve for forming a solid solution by an amount of 10 atomic percent or less (including 0). As an element capable of forming an alloy with lithium, for instance, Al, In, Pb, Ga, Mg, Sb, Bi, Sn and Zn can be cited. Among these, Al is preferable. Furthermore, when the element that is dissolved in the form of the solid solution in the second phase is one that is capable of forming an alloy with lithium, an amount of the lithium storage and release of the second phase can be more improved. Still furthermore, the dissolution of the M element such as Ni or Co and the M′ element into the second phase for forming the solid solution is preferable because it is considered that owing to an improvement in mechanical strength the pulverization suppression effect is generated.

Furthermore, each of the ninth through eleventh negative electrode materials for use in nonaqueous electrolyte batteries according to the present invention is preferable to be an alloy that has a composition that contains Al, an element N1 that consists essentially of Si or Si and Mg, an element N2 that consists essentially of at least one of Ni and Co, and an element N3 that consists essentially of at least one kind selected from the group consisting of In, Bi, Pb, Sn, Ga, Sb, Zn, Fe, Cu, Mn, Cr, Ti, Zr, Nb, Ta and rare earth elements. When a content of Al in the alloy is taken as h atomic percent, that of N1 in the alloy as i atomic percent, that of N2 in the alloy as j atomic percent, and that of N3 in the alloy as k atomic percent, the h, i, j and k, respectively, satisfy 12.5≦h<95, 0<i≦71, 5≦j≦40, and 0≦k<20.

The reasons for the contents of Al, the element N1, element N2 and element N3 being restricted to the above ranges is due to the reasons explained in the following.

(Al)

When the Al content h in the alloy is made less than 12.5 atomic percent, there may be a difficulty in precipitating the second phase (sea), resulting in a likelihood of deteriorating the charge/discharge cycle life. On the other hand, when the Al content h in the alloy is 95 atomic percent or more, since the first phase (island) is only slightly formed, the capacity and the charge/discharge cycle life may be deteriorated. A preferable range of the Al content h is 20 to 85 atomic percent.

(Element N1)

When Si is not contained in the alloy, a remarkable capacity lowering may be caused and a higher capacity may not be obtained, and the first phase (island) favorable for a longer cycle life may not precipitate and the longer cycle life may not be obtained. On the other hand, when the content i of the element N1 in the alloy exceeds 71 atomic percent, though the capacity increases, there is a likelihood of causing a difficulty in the formation of the second phase (sea). When the second phase (sea) is not formed, the charge/discharge cycle life largely deteriorates, and the number of charge/discharge cycles necessary for attaining the maximum capacity increases, or the rate characteristics deteriorate. A more preferable range of the content i of the element N1 is 10 to 60 atomic percent.

(Element N2)

When the content j of the element N2 in the alloy is made less than 5 atomic percent, the first phase may be formed with difficulty and the charge/discharge cycle life may deteriorate. On the other hand, when the content j of the element N2 in the alloy exceeds 40 atomic percent, the second phase may be hardly formed and the first phase may occupy the most. In such a case, the number of charge/discharge cycles necessary for attaining the maximum capacity may increase, or the rate characteristics may deteriorate. A more preferable range of the content j of the element N2 is from 12 to 35 atomic percent.

(Element N3)

When the content k of the element N3 in the alloy is made 20 atomic percent or more, in the case of the element N3 being In, Bi, Pb, Sn, Ga, Mg, Sb or Zn, the charge/discharge cycle life deteriorates, on the other hand, in the case of the element N3 being Fe, Cu, Mn, Cr, Ti, Zr, Nb, Ta, Cr or rare earth elements, the capacity deteriorate. A more preferable content k of the element N3 is 15 atomic percent or less.

Among the alloy compositions, more favorable compositions are ones expressed by the following formula (9), the compositions expressed by the aforementioned formulas (3) and (7), or the compositions expressed by the aforementioned formulas (4) and (8) in which the element A consists essentially of Si and Mg.

(Al₁₋ₘ₋ₙSiₘM1ₙ)ₚM2_{q}M3ᵣM4ₛ (9)

Here, the M1 is at least one kind of element selected from the group consisting of In, Bi, Pb, Sn, Ga, Mg, Sb and Zn, the M2 is at least one kind of element selected from the group consisting of Ni and Co, the M3 is at least one kind of element selected from the group consisting of Fe, Cu, Mn and Cr, the M4 is at least one kind of element selected from the group consisting of Ti, Zr, Nb, Ta and rare earth elements, and the atomic ratios m, n, p, q, r and s satisfy the following corresponding equations, that is, p+q+r+s=100 atomic percent, 60 atomic percent≦p≦90 atomic percent, 10 atomic percent≦q≦40 atomic percent, 0≦r≦10 atomic percent, 0≦s≦10 atomic percent, 0<m<0.75 and 0≦n<0.2.

<Twelfth Negative Electrode Material for Use in Nonaqueous Electrolyte Batteries>

A twelfth negative electrode material for use in nonaqueous electrolyte batteries according to the present invention includes an alloy that contains a microcrystalline phase whose average crystal grain size is 500 nm or less and has a composition expressed by any one of the aforementioned general formulas (3), (4), (7) and (8). However, in the compositions expressed by the general formulas (4) and (8), the case where the element A is Mg is excluded.

As the twelfth negative electrode material, for instance, a negative electrode material that consists essentially of a microcrystalline phase, a negative electrode material that consists essentially of a composite phase between the microcrystalline phase and an amorphous phase, and a negative electrode material that contains the microcrystalline phase as a principal phase can be cited.

The microcrystalline phase may be one made of an intermetallic compound, one made of a compound having a nonstoichiometric composition, or one that consists essentially of an alloy having a nonstoichiometric composition.

When an average crystal grain size of the microcrystalline phase exceeds 500 nm, since the negative electrode material is promoted in the pulverization thereof, the charge/discharge cycle life deteriorates. Although one having a smaller average crystal grain size can more suppress the pulverization, when the average crystal grain size is made smaller than 5 nm, lithium is hardly stored and the discharge capacity of the secondary battery may deteriorate. Accordingly, the average crystal grain size is more preferable to be in the range of 5 nm or more and 500 nm or less. A furthermore preferable range is 5 nm or more and 300 nm or less.

The average crystal grain size of the microcrystalline phase can be obtained in a way that in a TEM microgram (for instance, 10⁵ magnification) mutually adjacent 50 crystal grains are selected, the maximum length is measured of each of the crystal grains, and an average value thereof is calculated. The magnification of the TEM microgram can be altered in accordance with a magnitude of the crystal grain size being measured.

The microcrystalline phase is desirable to have either a cubic fluorite structure (CaF₂) or a cubic inverse fluorite structure. The lattice constant of such a crystal phase is preferable to be 5.42 Å or more and 6.3 Å or less. The microcrystalline phase having the cubic fluorite structure whose lattice constant is 5.42 Å to 6.3 Å or inverse fluorite structure whose lattice constant is 5.42 Å or more and 6.3 Å or less is a nonequilibrium phase that is not an amorphous phase, and can improve the charge/discharge cycle life and the discharge capacity of the secondary battery. When the lattice constant is made less than 5.42 Å, there is a likelihood of being incapable of obtaining a higher capacity. On the other hand, when the lattice constant is made larger than 6.3 Å, there is a likelihood of difficulty in sufficiently improving the charge/discharge cycle life. A more preferable range of the lattice constant is 5.45 to 6 Å, a furthermore preferable range being 5.5 to 5.9 Å.

Among the microcrystalline phases having the cubic fluorite (CaF₂) structure, a solid solution phase in which an Al-dissolved Si₂Ni phase, a solid solution phase in which an Al-dissolved Si₂Co phase, ones in which Ni or Si in the Si₂Ni phase is partially replaced by other element (for instance, Co, Fe, Cu, Mn, Ti, Zr, Hf, Nb, Ta, Cr, La, Ce, Pr and Nd), and ones in which Co or Si in the Si₂Co phase is partially replaced by other element (for instance, Fe, Ni, Nb, and La) are desirable. These microcrystalline phases are nonequilibrium phases that are not the amorphous phase. Furthermore, since these microcrystalline phases can improve a diffusion rate of lithium ion in the negative electrode material, the charge/discharge cycle life of the secondary battery can be improved.

The twelfth negative electrode material according to the present invention is preferable to exhibit, when the differential scanning calorimetry (DSC) is performed under a temperature rise speed of 10° C./min., at least one peak of heat generation in the range of 200 to 450° C. Such a negative electrode material can improve the charge/discharge cycle life of a secondary battery. The temperature range where the peak of heat generation is detected is desirably set in the range of 220 to 400° C.

The twelfth negative electrode material according to the present invention is desirable to exhibit, in the powder X-ray diffraction, a diffraction peak derived from Al in the range of from 2.31 to 2.4 Å by the d-value and diffraction peaks due to an intermetallic compound that contains Al and Si at least in the ranges of from 3.13 to 3.64 Å and from 1.92 to 2.23 Å by d-value. By configuring like this, a nonaqueous electrolyte secondary battery that is excellent in the discharge capacity, the cycle life and the discharge rate, and small in the number of repetition of charge/discharge cycle at which the maximum discharge capacity is attained can be realized.

From a viewpoint of further improving the discharge rate characteristics of the nonaqueous electrolyte battery, in the X-ray diffraction, diffraction peaks due to Al are preferable to appear further in the ranges of from 2 to 2.08 Å, from 1.41 to 1.47 Å, and from 1.21 to 1.25 Å by the d-value, and diffraction peaks due to an intermetallic compound that contains Al and Si are preferable to appear further in the ranges of from 1.64 to 1.9 Å, from 1.36 to 1.58 Å, and from 1.25 to 1.45 Å by the d-value.

The d-value at which a diffraction peak appears in the X-ray diffraction can be altered with the composition, a melt quenching state or by a process such as a subsequent heat treatment.

A metal texture of the twelfth negative electrode material according to the present invention is desirable to include a first phase in which at least part of crystal grains of an intermetallic compound that contains Al and Si and the element M is precipitated isolated from each other and a second phase that contains Al as a principal element and is precipitated so as to fill in between the isolated crystal grains. While the second phase containing Al can store and release lithium much in comparison with the first phase, an amount of distortion at the storage and release increases. By configuring in the aforementioned metal texture, since the second phase can be held by the first phase, the distortion accompanying the lithium storage and release of the second phase can be alleviated and the negative electrode material can be hindered from pulverizing, resulting in a further improvement in the charge/discharge cycle life. In the second phase containing Al, elements other than Al may be dissolved in the form of the solid solution in the range of 10 atomic percent or less. In addition, it is considered that dissolution of the M element such as Ni and Co, and the M′ element into the second phase to form the solid solution is preferable because the solid solution increases mechanical strength and results in exhibiting the suppression effect of the pulverization.

The ninth through twelfth negative electrode materials according to the present invention can be prepared according to, for instance, the methods explained in the following.

A melt containing a first element, a second element and a third element is ejected on a single roll so that a ribbon thickness can be 10 to 500 μm and quenched. Thereby, the melt is solidified into an alloy having a metal texture comprising a high melting point intermetallic compound phase that contains the first through third elements, and a second phase that contains the first element as a principal element and is lower in its melting point than that of the intermetallic compound phase. Thus, the ninth through twelfth negative electrode materials can be obtained.

Here, the first element is at least one kind of element selected from the group consisting of Al, In, Pb, Ga, Mg, Sb, Bi, Sn and Zn. The second element is at least one kind of element selected from elements other than Al, In, Pb, Ga, Mg, Sb, Bi, Sn and Zn and capable of forming an alloy with lithium. On the other hand, the third element is at least one kind of element capable of forming an intermetallic compound with the first and second elements.

(Formation of Melt)

The melt can be obtained according to, for instance, methods explained in the following (a) or (b).

(a) The first through third elements are mixed so as to be a predetermined atomic ratio (atomic percent) followed by melting the mixture, and thereby a melt is obtained.

(b) With the first through third elements, by use of, for instance, a casting process, an alloy having a target composition is prepared. The obtained alloy is melted, and thereby a melt is obtained.

Among the first elements, Al is desirable. When one that contains Al as the first element is used, as the second element, Si is preferably used. As the third elements that can form an intermetallic compound with both elements of Al and Si, for instance, Ni and Co can be cited. The Ni may be partially replaced by other element. As the other elements, the transition metal elements such as, for instance, Co, Fe and Nb and rare earth elements such as La can be used. On the other hand, as the other elements that can partially replace Co, the transition metal elements such as, for instance, Fe and Nb and the rare earth elements such as La can be cited. The kind of the other elements may be one kind or two or more kinds.

Among the melts that contain the first through third elements, ones that include Al, an element N1 consisting essentially of Si or Si and Mg, an element N2 consisting essentially of at least one of Ni and Co, and an element N3 consisting essentially of at least one kind selected from the group consisting of In, Bi, Pb, Sn, Ga, Sb, Zn, Fe, Cu, Mn, Cr, Ti, Zr, Nb, Ta and rare earth elements are preferable. When an Al content in the melt is h atomic percent, a content of the element N1 in the melt i atomic percent, a content of the element N2 in the melt j atomic percent and a content of the element N3 in the melt k atomic percent, the h, i, j, and k, respectively, satisfy 12.5≦h<95, 0<i≦71, 5≦j≦40, and 0≦k<20.

When the melt having such a composition is ejected on a single roll so that the thickness can be 10 to 500 μm and quenched, the melt can be solidified into an alloy having a metal texture that comprises a high melting point intermetallic compound phase that contains Al and the element N1 and the element N2, and a second phase that contains Al as a principal element and is lower in its melting point than that of the intermetallic compound phase.

Among the melt compositions, ones expressed by the aforementioned formulas (3) and (7), ones in which an element A is made of Si and Mg in the compositions expressed by formulas (4) and (8), and ones expressed by the formula (9) are more preferable.

When the composition of the melt is made one that is expressed by the aforementioned formula (9), an intermetallic compound having a crystal structure in which Al is dissolved in a fluorite (CaF₂) type Si₂Ni lattice to form a solid solution, or an intermetallic compound having a crystal structure in which Al is dissolved in a fluorite type Si₂Co lattice to form a solid solution can be precipitated as a primary crystal. At the same time, in the intermetallic compound phase, the crystal grain size, the distance between the crystal grains and the number of the crystal grains a unit area can be optimized.

(Crystal Grains of Intermetallic Compound)

Crystal grains of the intermetallic compound are preferable to have a crystal structure A in which Al is partially dissolved in the fluorite (CaF₂) type Si₂Ni lattice to form a solid solution, or a crystal structure B in which Al is dissolved in the fluorite type Si₂Co lattice to form a solid solution. In the crystal structure A, Ni or Si in the Si₂Ni lattice may be partially replaced by other elements (for instance, Co, Fe, Cu, Mn, Ti, Zr, Hf, Nb, Ta, Cr, La, Ce, Pr and Nd). On the other hand, in the crystal structure B, Co or Si in the Si₂Co lattice may be partially replaced by other elements (for instance, Fe, Ni, Nb, and La).

(Second Phase)

Although the second phase contains the first element, other constituent elements may be contained therein by 10 atomic percent or less (including 0). In particular, when the second element is contained in the second phase by an amount of 10 atomic percent or less, a capacity that the second phase bears can be preferably increased. The reason for the melting point of the second phase being made lower than that of the first phase, when the melting point of the second phase is equal to or more than that of the intermetallic compound phase, the first phase becomes difficult to precipitate as the primary crystal, resulting in a difficulty in the formation of the island structure of the present invention.

Preferable ones of the second phases are ones that contains Al. The second phases containing Al are desirable to contain the M element such as Ni and Co, or the M′ element by an amount of 10 atomic percent or less. When the M element such as Ni and Co or the M′ element is dissolved in the second phase to form the solid solution, a pulverization suppression effect due to an improvement of the mechanical strength can be obtained.

(Quenching Conditions)

The best roll material is determined in view of the wettability with the alloy melt, and Cu base alloys (for instance, Cu, TiCu, ZrCu, and BeCu) and Fe base alloys are preferable. Instead of the use of the Cu base alloys or the Fe base alloys, a surface of a roll may be plated with Cr or Ni with a thickness of 1 to 100 μm.

A thickness of a sample on the roll is desirable to be set in the range of 10 to 500 μm. This is due to the following reasons. When the thickness of the sample is thicker than 500 μm, since a cooling speed becomes slower, it becomes difficult to dissolve in the form of the solid solution the first element in an intermetallic compound that consists essentially of the second and third elements. The thinner the thickness of the sample is, the higher cooling speed can be obtained. However, when the thickness of the sample is made thinner than 10 μm, since strength of the obtained alloy becomes deficient, the alloy can be handled with difficulty. A more preferable range of the thickness is 15 to 300 μm.

When a roll peripheral speed, through depending on a material composition, is set mainly in the range of 10 to 60 m/s, a nonequilibrium phase such as a solid solution phase, a quasi-crystal phase and so on can be formed with ease.

A nozzle opening is preferable to be in the range of 0.3 to 1 mm. When the nozzle opening is less than 0.3 mm, it is difficult to eject the melt from the nozzle. On the other hand, when the nozzle opening exceeds 1 mm, since a thicker sample tends to be formed, it is difficult to obtain a sufficient cooling speed.

Furthermore, a gap between the roll and the nozzle is preferably set in the range of 0.2 to 10 mm. Even when the gap exceeds 10 mm, a cooling speed can be uniformly increased as the melt is flowed in a laminar flow. However, when the gap is made wider, the cooling speed becomes slower since a thicker sample is obtained.

When a mass-production is carried out, since a lot of heat is necessary to be deprived of the alloy melt, it is preferable to make larger a heat capacity of the roll. From the above situations, a roll diameter is preferably set at 300 mmφ or more, a more preferable range being 500 mmφ or more. Furthermore, a roll width is preferable to be 50 mm or more, a more preferable width being 100 mm or more.

Subsequently, thirteenth and fourteenth negative electrode materials for use in nonaqueous electrolyte batteries according to the present invention will be explained.

The thirteenth negative electrode material for use in nonaqueous electrolyte batteries according to the present invention includes a plurality of intermetallic compound phases and a phase containing a simple substance of an element that is capable of forming an alloy with lithium.

Each of at least two kinds of the plurality of intermetallic compound phases (hereinafter referred to as two kinds or more of intermetallic compound phases X) contains a first element that can form an alloy with lithium (hereinafter referred to as element P) and a second element that does not form an alloy with lithium (hereinafter referred to as element Q), and a combination of the element P and the element Q are different from each other.

(Simple Substance Phase of Element)

As the first elements that can form an alloy with lithium, for instance, Zn, Cd, Al, Ga, In, Si, Ge, Sn, Pb, P, Sb, Bi, S, Se, and Te can be cited. Among these, Al, Sn, Si, Bi and Pb are preferable.

In the simple substance phase of element, other element that can form an alloy with the first element may be contained. The other element is in many cases dissolved in the form of the solid solution in a metal that is capable of forming an alloy with lithium. Furthermore, a content of the other element in the simple substance phase of element is preferably small to the extent that does not damage the battery characteristics, for instance, 10 atomic percent or less.

The kind of the simple substance phase of element contained in the thirteenth negative electrode material may be one kind or two or more kinds.

(A Plurality of Intermetallic Compound Phases)

First, the two kinds or more of the intermetallic compound phases X will be explained.

Each of the two kinds or more of the intermetallic compound phases X is preferable to be a stoichiometric intermetallic compound phase. Here, the stoichiometric intermetallic compound denotes an intermetallic compound in which a ratio of constituent atoms can be expressed with a simple integer ratio (National Research Institute for Metals ed. Jan. 30, 2000. Zusetu Kinzokuzairyo Gijyutu Yogo Jiten (second edition), Nikkan Kogyo Shinbunsha, pp.394).

As the element P that is contained in each of the intermetallic compound phases X and forms an alloy with lithium, for instance, ones similar to the kinds explained in the aforementioned simple substance phase of element can be cited. Furthermore, the kind of the element that constitutes the element P may be one kind or two or more kinds. On the other hand, as the element Q that does not form an alloy with lithium, for instance, Cr, Mn, Fe, Co, Ni and Cu can be cited. Among these, Fe, Ni, Cu and Cr are preferable. The kind of the element that constitutes the element Q may be one kind or two or more kinds.

In the two kinds or more of intermetallic compound phases X, the kind of total elements of the element P and the element Q is different from each other. By configuring thus, since the kind of sites where lithium can be stored can be increased, the lattice distortion at the lithium storage can be alleviated. When a combination of the element P and the element Q is made different between the intermetallic compound phases X, it is necessary that the kind of element that constitutes the element P of each of the intermetallic compound phases X is made different, the kind of element that constitutes the element Q is made different, or both kinds of element P and the element Q are made different. In order to improve the charge/discharge cycle life, the kind of the element that constitutes the element P is preferably made different between the intermetallic compound phases X. This is considered that because an intermetallic compound that contains an element P capable of relatively easily forming an alloy with lithium can be made function as a lithium storage phase, and an intermetallic compound that contains an element P relatively difficult to form an alloy with lithium can be made function as a base for storage and release of lithium, as a result, the distortion of the crystal lattice caused by the storage and release of lithium can be effectively alleviated.

In the plurality of intermetallic compound phases, other than the aforementioned two kinds or more of intermetallic compound phases X, other kind of intermetallic compound phase may be included. As the other kind of intermetallic compound phase, for instance, an intermetallic compound phase having a stoichiometric composition other than the intermetallic compound phases X, an intermetallic compound phase having a nonstoichiometric composition and so on can be cited. As the intermetallic compound phase having a stoichiometric composition other than the intermetallic compound phases X, for instance, two kinds or more of intermetallic compound phases in which the kind of the constituent elements is the same and a composition ratio of the constituent elements is different from each other may be used.

An average crystal grain size of the plurality of intermetallic compound phases is preferable, from a viewpoint of a balance between the capacity and the cycle life and furthermore of the rate characteristics, to be in the range of 5 nm to 500 nm. When the average crystal grain size exceeds 500 nm, there is a likelihood of difficulty in obtaining a longer cycle life. Furthermore, when the average crystal grain size is made less than 5 nm, excellent rate characteristics may not be obtained. A more preferable range of the average crystal grain size is 10 to 400 nm.

The average crystal grain size is obtained in the following way. With the longest portion of each of crystal grains obtained in the TEM microgram (transmission electron microscope) as a crystal grain size, in the TEM microgram (for instance, 10⁵ magnification), each of mutually adjacent 50 crystal grains is measured of the crystal grain size, the obtained values are averaged, and the averaged value is taken as an average crystal grain size. The magnification of the TEM microgram can be changed according to the crystal grain sizes.

In the thirteenth negative electrode material for use in nonaqueous electrolyte batteries according to the present invention, other than a plurality of intermetallic compound phases and a simple substance phase of element, a nonequilibrium phase such as an amorphous phase may be contained.

The thirteenth negative electrode material is preferable to have one of compositions explained in the following (9) through (13) and (9)′ through (13)′.

<Composition 1>

XₓT1_{y}J_{z} (9)

However, the X denotes at least two kinds of elements selected from the group consisting of Al, Si, Mg, Sn, Ge, In, Pb, P and C, the T1 denotes at least one kind of element selected from the group consisting of Fe, Co, Ni, Cr and Mn, the J denotes at least one kind of element selected from the group consisting of Cu, Ti, Zr, Hf, V, Nb, Ta, Mo, W and rare earth elements, and x, y and z satisfy the following corresponding formulas, x+y+z=100 atomic percent, 50≦x≦90, 10≦y≦33, and 0≦z≦10.

(Element X)

The element X is an element that is high in affinity with lithium and fundamental for the storage of lithium. When the kind of element that constitutes the element X is made two or more, the distortion of the crystal lattice resulting from the storage and release of lithium can be alleviated. Furthermore, the reasons for an atomic ratio x of the element X being set in the above range are as follows. When the atomic ratio x is less than 50 atomic percent, a simple substance phase of an element that can form an alloy with lithium precipitates with difficulty at the preparing the negative electrode material according to the single roll method and the melt quenching method such as atomization or the like. On the other hand, when the atomic ratio x exceeds 90 atomic percent, the lithium release characteristics at the charge/discharge of the negative electrode material may be damaged. Since as the atomic ratio x is made larger, the simple substance phase of element becomes easy to precipitate, the atomic ratio x is preferable to be set in the range of larger than 67 atomic percent and 90 atomic percent or less, a more preferable range being 70 to 90 atomic percent.

(Element T1)

The reasons for the atomic ratio y of the element T1 being provided in the above range are as follows. When the atomic ratio y of the element T1 is less than 10 atomic percent, since the formation of the amorphous phase or nanocrystalline phase becomes difficult, the cycle characteristics deteriorates. On the other hand, when the atomic ratio y exceeds 33 atomic percent, the discharge capacity of the battery remarkably deteriorates. When the atomic ratio y of the element T1 is in the range of 10 to 33 atomic percent, the formation of the amorphous phase and the nanocrystalline phase can be advanced, and at the same time, the pulverization of the negative electrode material at the storage/release of lithium can be suppressed. In particular, when Al, Si or Mg is contained in the element X, the formation of the amorphous phase and the nanocrystalline phase can be further promoted. A more preferable range of the atomic ratio y of the element T1 is 15 to 25 atomic percent.

(Element J)

As the rare earth elements, for instance, La, Ce, Pr, Nd, Pm, Sm, Eu, Gd, Tb, Dy, Ho, Er, Tm, Yb and Lu can be cited. Among these, La, Ce, Pr, Nd and Sm are desirable.

When the element J is contained 10 atomic percent or less by atomic ratio, the formation of the amorphous phase and the nanocrystalline phase can be promoted. In particular, an average crystal grain size of the microcrystalline phase can be easily controlled to 500 nm or less. Among elements J, in the case of 4d and 5d transition metals such as Zr, Hf, Nb, Ta, Mo, and W, only a slight amount of addition generates a higher promotion effect in the microcrystallization. Among elements J, Ti and V exhibits a higher microcrystallization promotion effect when an addition is increased. Furthermore, the element J is effective also in the release of the stored lithium. A more preferable range of the atomic ratio z is 8 atomic percent or less. However, when the kind of the element T1 is one, when the atomic ratio z is made less than 0.01 atomic percent, there is a likelihood of incapability of obtaining an effect that promotes the formation of the amorphous phase and the nanocrystalline phase and an effect that suppresses the lowering of the capacity at the charge/discharge. Accordingly, the lower limit of the atomic ratio z is preferable to be 0.01 atomic percent.

The nonaqueous electrolyte secondary battery comprising the alloy expressed by the aforementioned composition formula (9) does not exhibit a change in the composition of the alloy before the charge/discharge is applied, however, when once the charge/discharge is applied, because of Li remaining as an irreversible capacity, the composition of the alloy can vary. The composition of the alloy after the change has occurred can be expressed by a general formula (9′) that will be described below.

<Composition 1′>

[XₓT1_{y}J_{z}]ᵥLi_{w} (9′)

Here, the X denotes at least two kinds of elements selected from the group consisting of Al, Si, Mg, Sn, Ge, In, Pb, P and C, the T1 is at least one kind of element selected from the group consisting of Fe, Co, Ni, Cr and Mn, the J is at least one kind of element selected from the group consisting of Cu, Ti, Zr, Hf, V, Nb, Ta, Mo, W and rare earth elements, and the x, y, z, v and w satisfy the following corresponding formulas, x+y+z=1, 0.5≦x≦0.9, 0.1≦y≦0.33, 0≦z≦0.1, v+w=100 atomic percent, and 0<w≦50.

The reasons for the atomic ratios x, y, and z of the element X, the element T1 and the element J being provided in the above ranges are due to the reasons similar to those explained in the aforementioned composition 1.

(Li)

Lithium is an element that shoulders a charge transfer in a nonaqueous electrolyte battery. Accordingly, when lithium is contained as an alloy constituent element, since an amount of lithium storage and release at a negative electrode can be improved, the discharge capacity and the charge/discharge cycle life can be improved. Furthermore, since the negative electrode material having the composition 1′ can be easily activated in comparison with the negative electrode material having the composition 1, the maximum discharge capacity can be attained at a relatively earlier stage of the charge/discharge cycle.

When the lithium is not contained in the constituent elements as in the negative electrode material having the composition 1, in a positive electrode active material, a lithium-containing compound such as a lithium composite oxide is necessary to be used. According to the negative electrode material having the composition 1′, since a compound that does not contain lithium in the constituent elements can be used as a positive electrode active material, kinds of usable positive electrode active materials can be expanded. However, when the content w of lithium exceeds 50 atomic percent, the formation of the amorphous phase and the nanocrystalline phase becomes difficult. A more preferable range of the lithium content w is 25 atomic percent or less.

<Composition 2>

A1ₐT1_{b}J_{c}Z_{d} (10)

Here, the A1 is at least one kind of element selected from the group consisting of Si, Mg and Al, the T1 is at least one kind of element selected from the group consisting of Fe, Co, Ni, Cr and Mn, the J is at least one kind of element selected from the group consisting of Cu, Ti, Zr, Hf, V, Nb, Ta, Mo, W and rare earth elements, the Z is at least one kind of element selected from the group consisting of C, Ge, Pb, P and Sn, and the a, b, c, and d satisfy the following corresponding formulas, a+b+c+d=100 atomic percent, 50≦a≦95, 5≦b≦40, 0≦c≦10, and 0≦d<20.

(Element A1)

The element A1 is a fundamental element for the storage of lithium. The reasons for the atomic ratio “a” of the element A1 being provided in the above range are as follows. When the atomic ratio “a” is less than 50 atomic percent, a simple substance phase of element that is capable of forming an alloy with lithium is precipitated with difficulty at preparing the negative electrode material according to the single roll method and the melt quenching method such as atomization or the like. On the other hand, when the atomic ratio “a” exceeds 95 atomic percent, the lithium release characteristics at the charge/discharge of the negative electrode material may be damaged. Since as the atomic ratio “a” is made larger, the simple substance phase of element becomes easy to precipitate, the atomic ratio “a” is preferable to be provided in the range of larger than 67 atomic percent and 95 atomic percent or less, a more preferable range being 70 to 95 atomic percent.

(Element T1)

The reasons for the atomic ratio b of the element T1 being provided in the above range are as follows. When the atomic ratio b of the element T1 is made less than 5 atomic percent, since the formation of the amorphous phase or nanocrystalline phase becomes difficult, the cycle characteristics deteriorates. On the other hand, when the atomic ratio b exceeds 40 atomic percent, the discharge capacity of the battery remarkably deteriorates. When the atomic percent b of the element T1 is in the range of 5 to 40 atomic percent, the formation of the amorphous phase and the nanocrystalline phase can be promoted, and the pulverization of the negative electrode material at the storage and release of lithium can be suppressed. A more preferable range of the atomic ratio b of the element T1 is 7 to 35 atomic percent.

(Element J)

As the rare earth elements, for instance, La, Ce, Pr, Nd, Pm, Sm, Eu, Gd, Tb, Dy, Ho, Er, Tm, Yb and Lu can be cited. Among these, La, Ce, Pr, Nd and Sm are desirable.

When the element J is contained by 10 atomic percent or less by atomic ratio, the formation of the amorphous phase and the nanocrystalline phase can be advanced. In particular, it becomes easier to control an average crystal grain size of the microcrystalline phase to 500 nm or less. Among the elements J, in the case of 4d and 5d transition metals, such as Zr, Hf, Nb, Ta, Mo, and W, only a slight addition thereof can cause a higher promotion effect in the microcrystallization. Among the elements J, Ti and V exhibits a higher microcrystallization promotion effect when an addition amount is increased. Furthermore, the element J is also effective in the release of the stored lithium. A more preferable range of the atomic ratio c is 8 atomic percent or less. However, when the kind of the element T1 is one, when the atomic ratio c is made less than 0.01 atomic percent, there is a likelihood of incapability of obtaining an effect that promotes the formation of the amorphous phase and the nanocrystalline phase and an effect that suppresses the lowering of the capacity at the charge/discharge. Accordingly, the lower limit of the atomic ratio c is preferable to be 0.01 atomic percent.

(Element Z)

The element Z can promote the formation of the amorphous phase and the nanocrystalline phase. When the element Z is contained in the range of less than 20 atomic percent by atomic ratio d, the capacity or the life can be improved. However, when the atomic ratio d is made 20 atomic percent or more, the cycle life characteristics deteriorates. A more preferable range of the atomic ratio d is 15 atomic percent or less.

A nonaqueous electrolyte secondary battery comprising the alloy expressed by the aforementioned composition formula (10) does not exhibit a change in the composition of the alloy before the charge/discharge is applied. However, when once the charge/discharge is applied, because of Li remaining as an irreversible capacity, the composition of the alloy can vary. The composition of the alloy after the change has occurred can be expressed by the general formula (10′) that will be described below.

<Composition 2′)

[A1ₐT1_{b}J_{c}Z_{d}]_{y}Li_{z} (10′)

Here, the A1 denotes at least one kind of element selected from the group consisting of Si, Mg and Al, the T1 is at least one kind of element selected from the group consisting of Fe, Co, Ni, Cr and Mn, the J is at least one kind of element selected from the group consisting of Cu, Ti, Zr, Hf, V, Nb, Ta, Mo, W and rare earth elements, the Z is at least one kind of element selected from the group consisting of C, Ge, Pb, P and Sn, and a, b, c, d, y and z satisfy the following corresponding formulas, a+b+c+d=1, 0.5≦a≦0.95, 0.05≦b≦0.4, 0≦c≦0.1, 0≦d<0.2, y+z=100 atomic percent, and 0<z≦50.

The reasons for the atomic ratios a, b, c and d, respectively, of the element A1, element T1, element J and element Z being provided in the aforementioned ranges are due to the reasons similar to those explained in the composition 2.

(Li)

Li is an element that carries out a charge transfer in a nonaqueous electrolyte battery. Accordingly, when the lithium is contained as an alloy constituent element, since an amount of the storage and release of lithium at the negative electrode can be improved, the battery capacity and charge/discharge cycle life can be improved. Furthermore, the negative electrode material having the composition 2′ can be easily activated in comparison with the negative electrode material having the composition 2 that does not contain lithium. Accordingly, at the relatively early stage during the charge/discharge cycle, the maximum discharge capacity can be obtained.

When the lithium is not contained in the constituent elements as in the negative electrode material having the composition 2, in a positive electrode active material, a lithium-containing compound such as a lithium composite oxide is necessary to be used. According to the negative electrode material having the composition 2′, since a compound that does not contain lithium in the constituent elements can be used as a positive electrode active material, kinds of usable positive electrode active materials can be expanded. However, when the content z of lithium exceeds 50 atomic percent, the formation of the amorphous phase and the nanocrystalline phase becomes difficult. A more preferable range of the lithium content z is 25 atomic percent or less.

<Composition 3>

T1_{100-a-b-c}(A2₁₋ₓJ′ₓ)ₐB_{b}J_{c} (11)

Here, the T1 is at least one kind of element selected from the group consisting of Fe, Co, Ni, Cu, Cr and Mn, the element A2 is at least one element of Al and Si, the J is at least one kind of element selected from the group consisting of Ti, Zr, Hf, V, Nb, Ta, Mo, W and rare earth elements, the J′ is at least one kind of element selected from the group consisting of C, Ge, Pb, P, Sn and Mg, and a, b, c, and x satisfy the following corresponding formulas, 10 atomic percent ≦a≦85 atomic percent, 0<b≦35 atomic percent, 0≦c≦10 atomic percent, and 0≦x≦0.3, and a content of Sn is less than 20 atomic percent (including 0 atomic percent).

(Element A2)

Al and Si are elements fundamental for the storage of lithium. The reasons for the atomic ratio “a” being provided in the above range will be explained. When the atomic ratio “a” is made less than 10 atomic percent, the discharge capacity deteriorates. On the other hand, when the atomic ratio “a” exceeds 85 atomic percent, the cycle life becomes shorter. A more preferable range of the atomic ratio “a” is 15 to 80 atomic percent.

(Element J′)

When the element A2 is partially replaced with the element J′, the cycle life can be made furthermore longer. However, when an amount of replacement x exceeds 0.3, the discharge capacity deteriorates, or an effect for improving the cycle life cannot be obtained. Furthermore, when an entire alloy is made 100 atomic percent, the content of Sn is set at less than 20 atomic percent (includes 0 atomic percent). It is because that when the content of Sn is made 20 atomic percent or more, the discharge capacity deteriorates or the charge/discharge cycle life becomes shorter.

(Boron)

When an atomic ratio b exceeds 35 atomic percent, the discharge capacity and the cycle life deteriorate, the discharge capacity when the discharge rate is set at a higher rate becomes lower, in addition to the above, the number of repetitions of charge/discharge until the maximum discharge capacity is attained becomes larger. When the atomic ratio b is made 35 atomic percent or less, the microcrystallization (the formation of nanocrystalline phase) of the crystal grains can be promoted, in addition to the above, the discharge capacity, cycle life and the rate characteristics can be improved and the number of repetitions of charge/discharge until the maximum discharge capacity is attained can be reduced. In order to promote the formation of an amorphous phase, the atomic ratio b is preferably set at 30 atomic percent or less. A more preferable range of the atomic ratio b is 0.1 to 28 atomic percent. A further preferable range is 1 to 25 atomic percent.

Boron affects a larger influence on the formation of the amorphous phase and the microcrystallization of the crystal grains. When boron and element T are contained, the formation of the amorphous phase and the pulverization of the crystal grains can be largely promoted.

(Element J)

As the rare earth elements, for instance, La, Ce, Pr, Nd, Pm, Sm, Eu, Gd, Tb, Dy, Ho, Er, Tm, Yb and Lu can be cited. Among these, La, Ce, Pr, Nd and Sm are desirable.

The element J is effective in promoting the formation of an amorphous phase and a microcrystalline phase. In addition, it also has an effect of suppressing the pulverization due to the storage and release reaction of lithium. Furthermore, it is also effective in suppressing the stored lithium from lingering in the alloy and in suppressing the capacity at the charge/discharge from lowering. However, when the atomic ratio c exceeds 10 atomic percent, the discharge capacity deteriorates. Accordingly, the atomic ratio c is preferably set at 10 atomic percent or less. A more preferable range of the atomic ratio c is 8 atomic percent or less, a furthermore preferable range being 5 atomic percent or less.

(Element T1)

The element T1 is an element that has a function of releasing the stored lithium and is indispensable in combining with B to promote the formation of an amorphous phase and a microcrystalline phase.

A nonaqueous electrolyte secondary battery comprising the alloy expressed by the aforementioned composition formula (11) does not exhibit a change in the composition of the alloy before the charge/discharge is applied, however, when once the charge/discharge is applied, because of Li remaining as an irreversible capacity, the composition of the alloy can change. The composition of the alloy after the change has occurred can be expressed by the general formula (11′) that will be described below.

<Composition 3′>

[T1_{1-a-b-c}(A2₁₋ₓJ′ₓ)ₐB_{b}J_{c}]_{y}Li_{z} (11′)

Here, the T1 is at least one kind of element selected from the group consisting of Fe, Co, Ni, Cu, Cr and Mn, the A2 is at least one element of Al and Si, the J is at least one kind of element selected from the group consisting of Ti, Zr, Hf, V, Nb, Ta, Mo, W and rare earth elements, the J′ is at least one kind of element selected from the group consisting of C, Ge, Pb, P, Sn and Mg, and a, b, c, x, y and z satisfy the following corresponding formulas, 0.1≦a≦0.85, 0<b≦0.35, 0≦c≦0.1, 0≦x≦0.3, 0<z≦50 atomic percent, and (y+z)=100 atomic percent, and a content of Sn is less than 20 atomic percent (including 0 atomic percent).

The reasons for the atomic ratios a, b, c and x, respectively, of the element T1, the element A2, the element J′, boron, and the element J being provided in the above ranges are due to the reasons similar to those explained in the above composition 3.

(Li)

Li is an element that shoulders a charge transfer in a nonaqueous electrolyte battery. Accordingly, when lithium is contained as an alloy constituent element, since the storage and release amount of lithium of the negative electrode can be improved, the battery capacity and charge/discharge cycle life can be improved. Furthermore, the negative electrode material having the composition 3′ can be more easily activated in comparison with the negative electrode material having the composition 3 that does not contain lithium. Accordingly, at the relatively earlier stage during the charge/discharge cycle, the maximum discharge capacity can be obtained. Furthermore, according to the negative electrode material having the composition 3′, since a compound that does not contain lithium in the constituent elements can be used as a positive electrode active material, kinds of usable positive electrode active materials can be expanded. However, when the content z of lithium exceeds 50 atomic percent, the formation of the amorphous phase and the nanocrystalline phase becomes difficult. A more preferable range of the lithium content z is 25 atomic percent or less.

<Composition 4>

(Mg₁₋ₓA3ₓ)_{100-a-b-c-d}(RE)ₐT1_{b}M1_{c}A4_{d} (12)

Here, the element A3 is at least one kind of element selected from the group consisting of Al, Si and Ge, the RE is at least one kind of element selected from the group consisting of Y and rare earth elements, the T1 is at least one kind of element selected from the group consisting of Fe, Co, Ni, Cu, Cr and Mn, the M1 is at least one kind of element selected from the group consisting of Ti, Zr, Hf, V, Nb, Ta, Mo, and W, the A4 is at least one kind of element selected from the group consisting of Sn, Pb, Zn, P and C, and a, b, c, d and x satisfy the following corresponding formulas, 0<a≦40 atomic percent, 0<b≦40 atomic percent, 0≦c≦10 atomic percent, 0≦d<20 atomic percent, and 0≦x≦0.5.

(Magnesium and Element A3)

Mg is an element fundamental for lithium storage capacity. Mg may be partially replaced with the element A3 (one kind or more of elements selected from Al, Si and Ge). However, when an atomic ratio x exceeds 0.5, the cycle life becomes shorter.

(RE Element)

The RE element is an indispensable element for obtaining an amorphous phase or a nanocrystal phase. The reason for the atomic ratio “a” being made 40 atomic percent or less is in that when the atomic ratio “a” exceeds 40 atomic percent, the capacity deteriorates. In order to promote the formation of the amorphous phase and improve the capacity, a range of the atomic ratio “a” is preferably made 5 to 40 atomic percent, a more preferable range being 7 to 30 atomic percent. Furthermore, in order to promote the formation of the nanocrystalline phase and improve the capacity, a range of the atomic ratio “a” is preferable to be 40 atomic percent or less, a more preferable range being 2 to 30 atomic percent.

(Element T1)

The element T1, in combination with Mg and the element RE, can promote the formation of an amorphous phase and a microcrystalline phase. A reason for the atomic ratio b being made 40 atomic percent or less is in that when the atomic ratio b exceeds 40 atomic percent, the capacity decreases. In order to promote the formation of the amorphous phase and to improve the capacity, a range of the atomic ratio b is preferably made 5 to 40 atomic percent, a more preferable range being 7 to 30 atomic percent. Furthermore, in order to promote the formation of the nanocrystalline phase and to improve the capacity, a range of the atomic ratio b is preferably made 40 atomic percent or less, a more preferable range being 2 to 30 atomic percent.

(Element M1)

The element M1 can promote the formation of the amorphous phase and the microcrystalline phase. Furthermore, it is also effective in reducing the stored lithium to linger in the alloy and in suppressing the capacity to decrease at the charge/discharge. A more preferable range of the atomic ratio c is 8 atomic percent or less.

(Element A4)

When the element A4 is contained less than 20 atomic percent by atomic ratio d, the capacity or the cycle life can be improved. However, when the atomic ratio d is made 20 atomic percent or more, the cycle life deteriorates.

A nonaqueous electrolyte secondary battery comprising the alloy expressed by the aforementioned composition formula (12) does not exhibit a change in the composition of the alloy before the charge/discharge is applied, however, once the charge/discharge is applied, because of Li remaining as an irreversible capacity, the composition of the alloy can change. The composition of the alloy after the change has occurred can be expressed by the general formula (12′) that will be described below.

<Composition 4′>

[(Mg₁₋ₓA3ₓ)_{1-a-b-c-d}(RE)ₐT1_{b}M1_{c}A4_{d}]_{y}Li_{z} (12′)

Here, the A3 is at least one kind of element selected from the group consisting of Al, Si and Ge, the RE is at least one kind of element selected from the group consisting of Y and rare earth elements, the T1 is at least one kind of element selected from the group consisting of Fe, Co, Ni, Cu, Cr and Mn, the M1 is at least one kind of element selected from the group consisting of Ti, Zr, Hf, V, Nb, Ta, Mo, and W, the A4 is at least one kind of element selected from the group consisting of Sn, Pb, Zn, P and C, and a, b, c, d, x, y and z satisfy the following corresponding formulas, 0<a≦0.4, 0<b≦0.4, 0≦c≦0.1, 0≦d<0.2, 0≦x≦0.5, 0<z≦50 atomic percent, and (y+z)=100 atomic percent.

The reasons for the atomic ratios a, b, c, d and x, respectively, of Mg, element A3, element RE, element T1 and element A4 being provided in the above ranges are similar to those explained in the above composition 4. Furthermore, reasons for the atomic ratio z of Li being provided in the above range are similar to those explained in the above composition 3′.

<Composition 5>

(A1₁₋ₓA5ₓ)ₐT1_{b}J_{c}Z_{d} (13)

Here, the element A5 is at least one kind of element selected from the group consisting of Si and Mg, the T1 is at least one kind of element selected from the group consisting of Fe, Co, Ni, Cr and Mn, the J is at least one kind of element selected from the group consisting of Cu, Ti, Zr, Hf, V, Nb, Ta, Mo, W and rare earth elements, the Z is at least one kind of element selected from the group consisting of C, Ge, Pb, P and Sn, and a, b, c, d and x satisfy the following corresponding formulas, a+b+c+d=100 atomic percent, 50≦a≦95, 5≦b≦40, 0≦c≦10, 0≦d≦20, and 0<x≦0.9.

(Aluminum and Element A5)

When Si is used as the A5, the atomic ratio x is preferable to be set in the range of 0<x≦0.75. It is because when the atomic ratio x of Si exceeds 0.75, the cycle life of the secondary battery decreases. A more preferable range of the atomic ratio x is 0.2 or more and 0.6 or less.

When Si is used as the A5, a total atomic ratio “a” of Al and Si is preferably made in the range of 50 to 95 atomic percent. When the total atomic ratio is made less than 50 atomic percent, since the lithium storage capacity of the negative electrode material becomes lower, it becomes difficult to improve the discharge capacity, cycle life and discharge rate characteristics of the secondary battery. On the other hand, when the total atomic ratio exceeds 95 atomic percent, the lithium release reaction hardly occurs in the negative electrode material. A more preferable range of the total atomic ratio is more than 67 atomic percent and 90 atomic percent or less, a furthermore preferable range being 70 to 90 atomic percent.

When Mg, or Mg and Si are used as the A5, the atomic ratio x is preferable to be in the range of 0<x≦0.9. It is because when the atomic ratio x of the element A5 exceeds 0.9, the cycle life and the rate characteristics of the secondary battery deteriorate. A more preferable range of the atomic ratio x is in the range of 0.3≦x≦0.8.

When Mg, or Mg and Si is used as the A5, a total atomic ratio “a” of Al and the element A5is preferably made in the range of 50 to 95 atomic percent. When the total atomic ratio is made less than 50 atomic percent, since the lithium storage capacity of the negative electrode material becomes lower, it becomes difficult to improve the discharge capacity, cycle life and rate characteristics of the secondary battery. On the other hand, when the total atomic ratio exceeds 95 atomic percent, the lithium release reaction hardly occurs in the negative electrode material. A more preferable range of the total atomic ratio is more than 67 atomic percent and 90 atomic percent or less, a furthermore preferable range being 70 to 85 atomic percent.

(Element T1)

Reasons for the atomic ratio b of the element T1 being provided in the above range are due to the followings. When the atomic ratio b of the element T1 is made less than 5 atomic percent, the formation of the amorphous phase and nanocrystalline phase becomes difficult. On the other hand, when the atomic ratio b of the element T1 exceeds 40 atomic percent, the discharge capacity of the secondary battery is remarkably deteriorated. When the atomic ratio b of the element T1 is made in the range of 10 to 33 atomic percent, the formation of the amorphous phase and nanocrystalline phase can be promoted, in addition, the pulverization when lithium is stored in and released from the negative electrode material can be suppressed. A more preferable range of the atomic ratio b of the element T1 is 15 to 30 atomic percent.

(Element J)

As the rare earth elements, for instance, La, Ce, Pr, Nd, Pm, Sm, Eu, Gd, Tb, Dy, Ho, Er, Tm, Yb and Lu can be cited. Among these, La, Ce, Pr, Nd and Sm are desirable.

When the element J is contained 10 atomic percent or less by atomic ratio, the formation of the amorphous phase and the nanocrystalline phase can be promoted. Furthermore, it is also effective in suppressing the stored lithium from lingering in the alloy and in suppressing the capacity at the charge/discharge from lowering. A more preferable range of the atomic ratio c is 8 atomic percent or less. However, in the case of the kind of the element T1 being one, when an amount of the atomic ratio c is made less than 0.01 atomic percent, there is a likelihood of being incapable of promoting the formation of the amorphous phase and the nanocrystalline phase and incapable of obtaining a capacity decrease suppression effect at the charge/discharge. Accordingly, the lower limit of the atomic ratio is preferably made 0.01 atomic percent.

(Element Z)

The element Z can promote the formation of the amorphous phase and nanocrystalline phase. When the element Z is contained less than 20 atomic percent by atomic ratio d, the capacity or cycle life can be improved. However, when the atomic ratio d is made 20 atomic percent or more, the cycle life deteriorates. A more preferable range of the atomic ratio d is 15 atomic percent or less.

A nonaqueous electrolyte secondary battery comprising the alloy expressed by the aforementioned composition formula (13) does not exhibit a change in the composition of the alloy before the charge/discharge is applied, however, once the charge/discharge is applied, because of Li remaining as an irreversible capacity, the composition of the alloy can change. The composition of the alloy after the change has occurred can be expressed by the general formula (13′) that will be described below.

<Composition 5′>

[(A1₁₋ₓA5ₓ)ₐT1_{b}J_{c}Z_{d}]_{y}Li_{z} (13′)

Here, the element A5is at least one kind of element selected from the group consisting of Si and Mg, the T1 is at least one kind of element selected from the group consisting of Fe, Co, Ni, Cr and Mn, the J is at least one kind of element selected from the group consisting of Cu, Ti, Zr, Hf, V, Nb, Ta, Mo, W and rare earth elements, the Z is at least one kind of element selected from the group consisting of C, Ge, Pb, P and Sn, and a, b, c, d, x, y and z satisfy the following corresponding formulas, a+b+c+d=1, 0.5≦a≦0.95, 0.05≦b≦0.4, 0≦c≦0.1, 0≦d<0.2, 0<x≦0.9, y+z=100 atomic percent, and 0<z≦50 atomic percent.

The reasons for the atomic ratios a, b, c and d, respectively, of the element A5, element T1, element J and element Z and x being provided in the above ranges are due to reasons similar to those explained in the above composition 5. Furthermore, reasons for the atomic ratio z of Li being provided in the above range are due to reasons similar to those explained in the above composition 3′.

Furthermore, in the negative electrode materials for use in nonaqueous electrolyte batteries having the compositions expressed by the general formulas (9), (10), (11), (12) and (13), the constituent elements of the alloys do not contain lithium. Accordingly, the handling of the elements at the synthesis of the negative electrode material is simple, and since when the negative electrode material is prepared according to the melt quenching method, there is no risk of catching fire and so on, mass-production thereof can be easily performed. Furthermore, in the alloy system that does not contain lithium, since activation energy when the amorphous phase, quasi-stable phase makes a transition to a stable phase is higher, or the crystal grain growth of the microcrystalline phase is slower, the crystal structure of the alloy is stable. Accordingly, it is advantageous for the cycle life of the electrode characteristics. Furthermore, since it is hardly subjected to the fluctuation of the heat treatment conditions, the product yield of the negative electrode materials can be increased.

According to the thirteenth negative electrode material for use in nonaqueous electrolyte batteries according to the present invention, without damaging the discharge capacity and the charge/discharge cycle life, the rate characteristics can be improved. Accordingly, a nonaqueous electrolyte secondary battery that can simultaneously satisfy the discharge capacity, the charge/discharge cycle life and the rate characteristics can be provided. Furthermore, the secondary battery can reduce the number of repetitions of charge/discharge cycle that is required to attain the maximum discharge capacity.

That is, a simple substance phase of element that can form an alloy with lithium can improve the maximum storage and release speed of lithium and can improve the capacity. On the other hand, the intermetallic compound phase is effective in improving the storage and release speed of lithium. Furthermore, in a plurality of intermetallic compound phases including two kinds or more of intermetallic compound phases X, there is a clear difference in the easiness of storing lithium between the intermetallic compound phases. Accordingly, since one in which lithium storage reaction can occur relatively easily can be made a lithium reservoir and one where the lithium storage reaction can occur with relative difficulty can be made a base for lithium storage and release, the distortion of the crystal lattice at the lithium storage and release can be alleviated. As a result, without damaging the discharge capacity and the charge/discharge cycle life, the rate characteristics can be improved and the number of repetitions of charge/discharge cycle until the maximum discharge capacity is attained can be reduced.

In the thirteenth negative electrode material for use in nonaqueous electrolyte batteries according to the present invention, when the composition thereof is made one of those that are expressed by the general formulas (9) through (13) and (9′) through (13′), the discharge capacity, charge/discharge cycle life and the rate characteristics of the nonaqueous electrolyte secondary batteries can be furthermore improved. Among these, the compositions expressed by the general formulas (13) and (13′) are preferable because the charge/discharge cycle life can be further improved.

<Fourteenth Negative Electrode Material for Use in Nonaqueous Electrolyte Batteries>

A fourteenth negative electrode material for use in nonaqueous electrolyte batteries according to the present invention includes an intermetallic compound phase, a nonequilibrium phase and a phase containing a simple substance of an element that is capable of forming an alloy with lithium.

(Simple Substance Phase of Element)

As the simple substance phase of element, one similar to that explained in the above thirteenth negative electrode material for use in nonaqueous electrolyte batteries can be cited.

(Intermetallic Compound Phase)

The kind of the intermetallic compound phase contained in the fourteenth negative electrode material may be one or two or more.

The intermetallic compound phase desirably contains an element that can form an alloy with lithium and an element that cannot form an alloy with lithium. As the element that can form an alloy with lithium and the element that cannot form an alloy with lithium, ones similar to those explained in the thirteenth negative electrode material can be cited. In view of an improvement in the charge/discharge cycle life, the kind of the element that can form an alloy with lithium is desirable to be made two or more.

The intermetallic compound phase is desirable to have a stoichiometric composition. As such intermetallic compound phase having the stoichiometric composition, for instance, the intermetallic compound phase (two kinds or more of intermetallic compound phases X) explained in the thirteenth negative electrode material, two kinds or more of intermetallic compound phases in which the constituent elements are the same in the kind but the composition ratio of the constituent elements is different from each other, and a plurality of kinds of intermetallic compounds phases between the compositions of which there is no particular relationship can be cited.

An average crystal grain size of the intermetallic compound phase, from the reasons similar to those explained in the thirteenth negative electrode material, is preferable to be made in the range of 5 nm to 500 nm. A more preferable range of the average diameter is 10 to 400 nm.

(Nonequilibrium Phase)

As the nonequilibrium phase, for instance, an amorphous phase, a quasi-crystal phase, and an intermetallic compound phase having a nonstoichiometric composition can be cited. The nonequilibrium phase may be a single phase or a composite phase.

The nonequilibrium phase can be confirmed with a method explained in the following.

First, by applying a thermal analysis on a negative electrode material, whether or not a peak of heat generation appears is confirmed. When the peak of heat generation is detected (the peak of heat generation is detected in the range of 200 to 700° C. under a speed of, for instance, 10° C./min.), the nonequilibrium phase is contained in the negative electrode material. Subsequently, with an X-ray diffractometer or a transmission electron microscope, a microstructure of the nonequilibrium phase can be observed. In the X-ray diffraction of the negative electrode material including the nonequilibrium phase, diffraction data due to a known intermetallic compound is not observed. When after the heat treatment is applied in the neighborhood of a temperature where the peak of heat generation appeared, the X-ray diffraction is applied again, a diffraction peak derived from a known intermetallic compound can be confirmed.

As the composition of the fourteenth negative electrode material according to the present invention, ones expressed by the above general formulas (9) through (13′) can be cited. Among these, the compositions expressed by the general formulas (13) and (13′) can further improve the charge/discharge cycle life and are accordingly preferable.

According to the fourteenth negative electrode material for use in nonaqueous electrolyte batteries according to the present invention, without damaging the discharge capacity and the charge/discharge cycle life, the rate characteristics can be improved. Accordingly, a nonaqueous electrolyte secondary battery that can simultaneously satisfy the discharge capacity, the charge/discharge cycle life and the rate characteristics can be provided. Furthermore, the secondary battery can reduce the number of repetitions of charge/discharge cycle that is required to attain the maximum discharge capacity.

That is, the simple substance phase of element that can form an alloy with lithium and the intermetallic compound phase can improve a storage and release speed of lithium and can improve the capacity. On the other hand, the nonequilibrium phase, because the crystal structure is in advance distorted, can alleviate the distortion when lithium is inserted. Accordingly, the negative electrode material can be hindered from pulverizing. As a result, without damaging the discharge capacity and the charge/discharge cycle life, the rate characteristics can be improved and the number of repetitions of charge/discharge cycle until the maximum discharge capacity is attained can be reduced.

The thirteenth and fourteenth negative electrode materials can be prepared by use of, for instance, a melt quenching method, a mechanical alloying method, or a mechanical grinding method.

(Melt Quenching Method)

The melt quenching method is one in which an alloy melt whose composition is adjusted to be a predetermined one is ejected from a small nozzle onto a cooling body (for instance, a roll) that is rotating at a high speed and is cooled. As a shape of a sample that can obtained according to the melt quenching method, there can be cited, for instance, a long ribbon, a flake or the like. When the composition of the sample changes, a melting point thereof and amorphous phase formation capability or microcrystalline phase formation capability becomes different, the shape of the sample tends to change according to the composition. On the other hand, a cooling speed is mainly dependent on a thickness of the sample obtained by the quenching, and the thickness of the sample is desirably adjusted with a roll material, a roll peripheral speed and a nozzle opening.

The melt composition is desirably made any one of the compositions expressed by the formulas (9) through (13) and (9′) through (13′).

The optimum roll material is determined in accordance with the wettability with the alloy melt, and a copper system alloy (for instance, Cu, TiCu, ZrCu, and BeCu) is preferable.

At a roll peripheral speed, though dependent on the material composition, in the range of 10 m/s or more, target microcrystalline phase can be obtained. When the roll peripheral speed is 20 m/s or less, a mixture of a microcrystalline phase and an amorphous phase tends to obtain. On the other hand, when the roll peripheral speed exceeds 60 m/s, the alloy melt is difficult to be arranged on the cooling roll that is rotating at a high-speed. Accordingly, contrary to expectation, the cooling speed becomes lower and the microcrystalline phase tends to precipitate. As a result, though depending also on the composition, roughly speaking, when the roll peripheral speed is made in the range of 20 to 60 m/s, the amorphous phase can be easily obtained.

The nozzle opening is preferably set in the range of 0.3 to 2 mm. When the nozzle opening is less than 0.3 mm, the melt is ejected from the nozzle with difficulty. On the other hand, when the nozzle opening exceeds 2 mm, since a thicker sample tends to be formed, a sufficient cooling speed cannot be obtained.

Furthermore, a gap between the roll and the nozzle is preferably set in the range of 0.2 to 10 mm. However, even when the gap exceeds 10 mm, the cooling speed can be uniformly increased as the melt can be flowed in a laminar flow. However, when the gap is made wider, the cooling speed tends to be slower since a thicker sample tends to be obtained.

Since when the mass-production is performed, a large amount of heat is necessary to be deprived of the alloy melt, a heat capacity of the roll is preferably made larger. From the above situations, a roll diameter is preferably made larger and a roll width is preferably made wider. Specifically, the roll diameter is preferable to be 300 mm or more, a more preferable range being 500 mm or more. On the other hand, a width of the roll is preferable to be 50 mm or more, a furthermore preferable range being 100 mm or more.

(Mechanical Alloying/Mechanical Grinding Method)

Mechanical alloying and mechanical grinding are a method in which powder prepared so as to be a predetermined composition is put into a pot in an inert atmosphere, owing to the rotation of the pot, the powder therein is sandwiched between balls in the pot and transformed into an alloy owing to energy at that time.

The alloy prepared according to the melt quenching method, or the mechanical alloying or mechanical grinding method can undergo heat treatment to make brittle. From a viewpoint of suppressing an advancement of the formation of the crystal phase, when the peak of heat generation is one, a temperature for the heat treatment is preferably set in the range of from a temperature 50° C. lower than a heat generation occurring temperature (a crystallization temperature) to a temperature 50° C. higher than the heat generation occurring temperature. Furthermore, when there are a plurality of peaks of heat generation, the heat treatment temperature is preferably set in a range of from a temperature that is 50° C. lower than a heat generation occurring temperature of a heat generation peak appeared at the lowest temperature to a temperature of a heat generation peak appeared at the highest temperature.

Other than the aforementioned the melt quenching method, the mechanical alloying method and the mechanical grinding method, a gas atomization method, a rotating disc method, and a rotating electrode method can be applied to obtain powdery samples. Since these methods, when applied under the selected conditions, can generate spherical samples, the negative electrode material can be most closely packed in the negative electrode and is preferable in realizing a higher capacity battery.

A nonaqueous electrolyte battery according to the present invention comprises a negative electrode that contains at least one kind of the first to fourteenth negative electrode materials, a positive electrode, and a nonaqueous electrolyte layer arranged between the positive electrode and the negative electrode.

1) Negative Electrode

The negative electrode includes a collector and a negative electrode layer that is formed on one or both surfaces of the collector. And the negative electrode layer includes at least one kind of the first to fourteenth negative electrode materials.

The negative electrode can be prepared by, for instance, kneading powder of the negative electrode material and a binder in the presence of an organic solvent, coating an obtained suspension on the collector followed by drying and pressing.

When powders of the first, second, fifth, sixth, thirteenth and fourteenth negative electrode materials are obtained, prior to pulverization, the powders may be made brittle by applying heat-treatment at a temperature equal to or less than a crystallization temperature for 0.1 to 24 hours. As a method for pulverizing the negative electrode material, for instance, a pin mill, a jet mill, a hammer mill and a ball mill can be adopted.

On the other hand, as for the third, fourth, seventh, eighth, thirteenth and fourteenth negative electrode materials, a sample that is previously made amorphous is heat-treated at a temperature equal to or more than the crystallization temperature for 0.1 to 24 hours and thereby obtaining the negative electrode material. The pulverization can be preferably performed after the heat-treatment. When a negative electrode material is prepared by heat-treating at a temperature equal to or more than the crystallization temperature thereof a sample that is made amorphous, a production cost of the negative electrode material can be reduced. The crystallization temperature of a sample that is made amorphous can be obtained from a peak of heat generation in a differential scanning calorimetry (DSC) under a temperature rise speed of, for instance, 10° C./min. Specifically, when a peak of heat generation to be detected is one, a transition temperature at which an amorphous phase in the sample transfers to an equilibrium phase is measured from the peak of heat generation, the obtained transition temperature can be made a crystallization temperature. On the other hand, when there are a plurality of peaks of heat generation being detected, the transition temperature of the sample is measured from a peak of heat generation detected at the most lowest temperature side, the obtained transition temperature can be made a crystallization temperature. The measurement of the transition temperature from the peak of heat generation can be carried out by a method explained in differential scanning calorimetry in, for instance, Example 52 that will be described below. Furthermore, though a sample may be synthesized by precipitating a microcrystalline phase with a melt quenching method, in this case, the heat treatment prior to the pulverization may be applied or may not.

These samples are pulverized with a pulverizer such as a jet mill, a pin mill, a hammer mill or the like to an average particle diameter in the range of from 5 to 80 μm. The average particle diameter can be measured by means of a micro-track method that use a laser light. Among the samples to be used in the present invention, there are ones that have a plane plate like shape. According to the measurement due to the micro-track method, the samples having the plane plate like shape are also assumed to be spherical and based on this assumption data is processed, and thereby an average particle diameter can be obtained.

As the binder, for instance, polytetrafluoroethylene (PTFE), polyvinylidene fluoride (PVdF), ethylene-propylene-diene copolymer (EPDM), styrene-butadiene rubber (SBR), carboxymethyl cellulose (CMC) and so on can be used.

A compounding ratio of the negative electrode material and the binder is preferable to be in the range of 90 to 98% by weight of the negative electrode material and 1 to 10% by weight of the binder.

There is no particular restriction on the collector as far as it is made of conductive materials. Among these, a foil, a mesh, a punched metal, a metal lath and so on can be used. As the conductive material, for instance, copper, stainless steel, nickel and so on can be used.

2) Positive Electrode

A positive electrode includes a collector and a positive electrode active material-containing layer that is formed on one or both surfaces of the collector. And the positive electrode active material-containing layer contains a positive electrode active material.

The positive electrode can be prepared in a way that, for instance, the positive electrode active material, a conductive agent, and a binder are appropriately suspended in a solvent, and an obtained suspension is coated on a surface of the collector followed by drying and pressing.

On the positive electrode active materials, there is no particular restriction when these materials can store an alkali metal such as lithium at the discharge of a battery and can release the alkali metal at the charge thereof. As such positive electrode active materials, various kinds of oxides and sulfides can be cited. For instance, manganese dioxide (MnO₂), lithium-manganese composite oxides (for instance, LiMn₂O₄, LiMnO₂), lithium-nickel composite oxides (for instance, LiNiO₂), lithium-cobalt composite oxides (for instance, LiCoO₂), lithium-nickel-cobalt composite oxides (for instance, LiNi_{1-X}Co_{X}O₂), lithium-manganese-cobalt composite oxides (for instance, LiMn_{X}Co_{1-X}O₂), vanadium oxides (for instance, V₂O₅) can be cited. Furthermore, conductive polymer materials, organic materials such as disulfide polymers can be cited. As the more preferable positive electrode active materials, lithium-manganese composite oxides (for instance, LiMn₂O₄), lithium-nickel composite oxides (for instance, LiNiO₂), lithium-cobalt composite oxides (for instance, LiCoO₂), lithium-nickel-cobalt composite oxides (for instance, LiNi_{0.8}Co_{0.2}O₂), lithium-manganese-cobalt composite oxides (for instance, LiMn_{X}Co_{1-X}O₂), all of which are high in a battery voltage, can be cited.

For the binder, for instance, polytetrafluoroethylene (PTFE), polyvinylidene fluoride (PVdF), and fluororubber can be cited.

For the conductive agents, for instance, acetylene black, carbon black, graphite and so on can be cited.

A compounding ratio of the positive electrode active material, the conductive agent and the binder is preferable to be in the range of from 80 to 95% by weight for the positive electrode material, in the range of from 3 to 20% by weight for the conductive agent, and in the range of from 2 to 7% by weight for the binder.

For the collector, although there is no particular restriction on the material being used when it is a conductive material, in particular as the collector for use in the positive electrode it is preferable to use a material that is resistant against oxidation during the battery reaction. For instance, aluminum, stainless steel, titanium and so on can be used.

3) Nonaqueous Electrolyte Layer

The nonaqueous electrolyte layer can endow with an ionic conductivity between the positive electrode and the negative electrode.

As the nonaqueous electrolyte layer, for instance, a separator holding the nonaqueous electrolyte, a layer of a gel-like nonaqueous electrolyte, a separator holding a gel-like nonaqueous electrolyte, a layer of a solid polymer electrolyte, and a layer of an inorganic solid electrolyte can be cited.

For the separator, for instance, a porous material can be used. For such the separator, for instance, nonwoven synthetic fiber fabric, porous polyethylene film, and porous polypropylene film can be cited.

The nonaqueous electrolyte can be prepared by, for instance, dissolving a solute in a nonaqueous solvent.

As the nonaqueous solvent, for instance, cyclic carbonates such as ethylene carbonate (EC) and propylene carbonate (PC), and nonaqueous solvent that is principally made of a solvent mixture between the cyclic carbonates and a nonaqueous solvent lower in viscosity than the cyclic carbonates can be used. For the low viscosity nonaqueous solvent, for instance, chain carbonate (for instance, dimethyl carbonate, methyl ethyl carbonate, and diethyl carbonate), γ-butyrolactone, acetonitrile, methyl propionate, ethyl propionate, cyclic ethers (for instance, tetrahydrofuran, 2-methyltetrahydrofuran and so on), and chain ethers (for instance, dimethoxy ethane, diethoxy ethane and so on) can be cited.

As the solutes, lithium salts can be used. Specifically, lithium hexafluorophosphate (LiPF₆), lithium tetrafluoro borate (LiBF₄), lithium hexafluoroarsenate (LiAsF₆), lithium perchlorate (LiClO₄), and lithium trifluoromethanesulfonate (LiCF₃SO₃) can be cited. In particular, lithium hexafluorophosphate (LiPF₆) and lithium tetrafluoro borate (LiBF₄) can be cited as preferable examples.

A dissolving amount of a solute in a nonaqueous solvent is preferably set in the range of 0.5 to 2 mol/L.

The gel-like nonaqueous electrolyte can be obtained by, for instance, forming a composite from the nonaqueous electrolyte and a polymer material. As the polymer materials, for instance, polymers such as polyacrylonitrile, poly acrylate, polyvinylidene fluoride (PVdF) and polyethylene oxide (PEO), copolymers between one of these monomers and other monomers can be cited.

The layer of solid polymer electrolyte can be obtained by, for instance, dissolving a solute in a polymer material and solidifying it. As such the polymers, for instance, polymers such as polyacrylonitrile, polyvinylidene fluoride (PVdF) and polyethylene oxide (PEO), copolymers between one of these monomers and other monomers can be cited.

As inorganic solid solutes, for instance, ceramic materials containing lithium can be cited, specifically, Li₃N, Li₃PO₄—Li₂S—SiS₂, LiI—Li₂S—SiS₂ glass and the like can be cited.

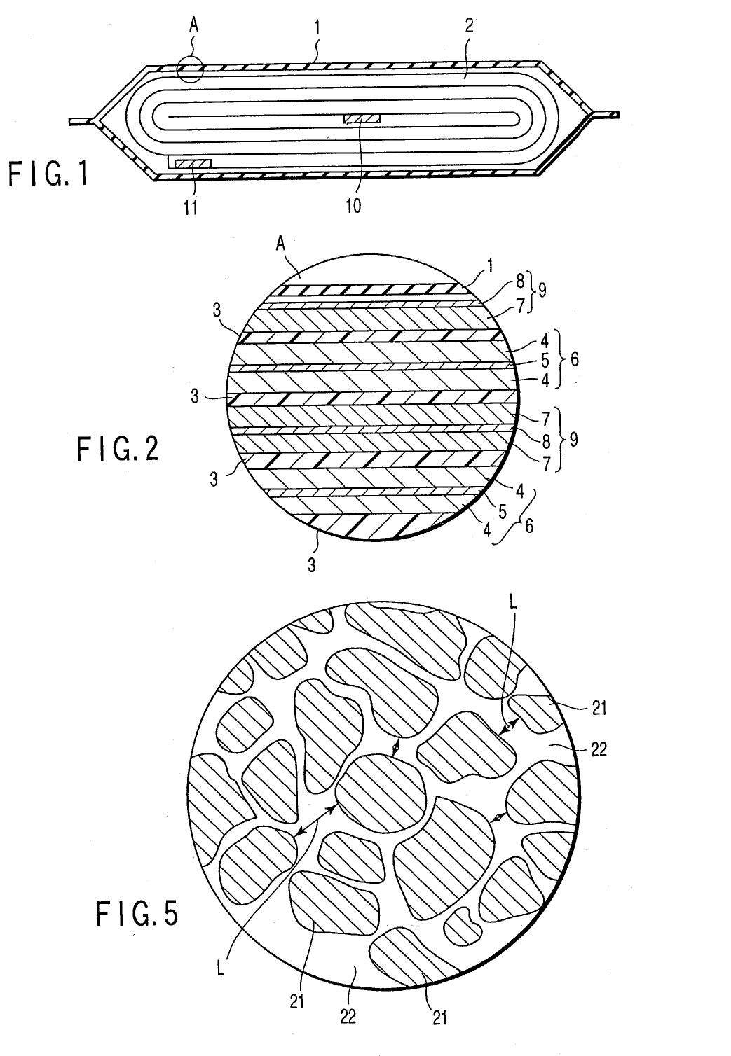

A thin nonaqueous electrolyte secondary battery that is an example of a nonaqueous electrolyte battery according to the present invention will be detailed with reference to FIG. 1 and FIG. 2.

FIG. 1 is a sectional view showing the thin nonaqueous electrolyte secondary battery that is an example of the nonaqueous electrolyte battery according to the present invention, and FIG. 2 is an enlarged sectional view showing an A portion of FIG. 1.

As shown in FIG. 1, in a packaging material 1 made of, for instance, a laminate film, an electrode group 2 is accommodated. The electrode group 2 has a structure in which a laminate comprising a positive electrode, a separator, and a negative electrode is wound in a flat shape. The laminate, as shown in FIG. 2, is formed by laminating (from bottom to top) a separator 3, a positive electrode 6 comprising a positive electrode layer 4 and a positive electrode collector 5 and a positive electrode layer 5, a separator 3, a negative electrode 9 comprising a negative electrode layer 7 and a negative electrode collector 8 and a negative electrode layer 7, a separator 3, a positive electrode 6 comprising a positive electrode layer 4 and a positive electrode collector 5 and a positive electrode layer 5, a separator 3, and a negative electrode 9 comprising a negative electrode layer 7 and a negative electrode collector 8 in this order. The electrode group 2 has the negative electrode collector 8 at the outermost layer. A ribbon-like positive electrode lead 10 is connected, at one end thereof, to the positive electrode collector 5 of the electrode group 2, and other end thereof is extended from the packaging material 1. On the other hand, a ribbon-like negative electrode 11 is connected, at one end thereof, to the negative electrode collector 8 of the electrode group 2, and other end thereof is extended from the packaging material 1.

In the above FIGS. 1 and 2, an example in which an electrode group in which a positive electrode and a nonaqueous electrolyte layer and a negative electrode are wound in a flattened shape is used is explained. However, the present explanation can be applied to an electrode group that consists essentially of a laminate comprising a positive electrode and a nonaqueous electrolyte layer and a negative electrode, and to an electrode group having a structure in which a laminate comprising a positive electrode and a nonaqueous electrolyte layer and a negative electrode is folded one or more times.

In the following, embodiments of the present invention will be explained with reference the drawings.

### EXAMPLES 1 TO 10

<Preparation of Negative Electrode>

Elements each of which has a ratio shown in Table 1 are heated and melted followed by solidifying in an inert atmosphere with a single roll, and thereby a ribbon like alloy is obtained. Specifically, in an inert atmosphere, an alloy melt is ejected from a nozzle opening having a diameter of 0.6 mm onto a BeCu alloy cooling roll that is rotating at a peripheral speed of 40 m/s followed by quenching, and thereby a ribbon like alloy is prepared. The quenching can be performed in an air atmosphere, or an inert gas may be flowed to a tip end of the nozzle. In either case, a similar alloy can be obtained.

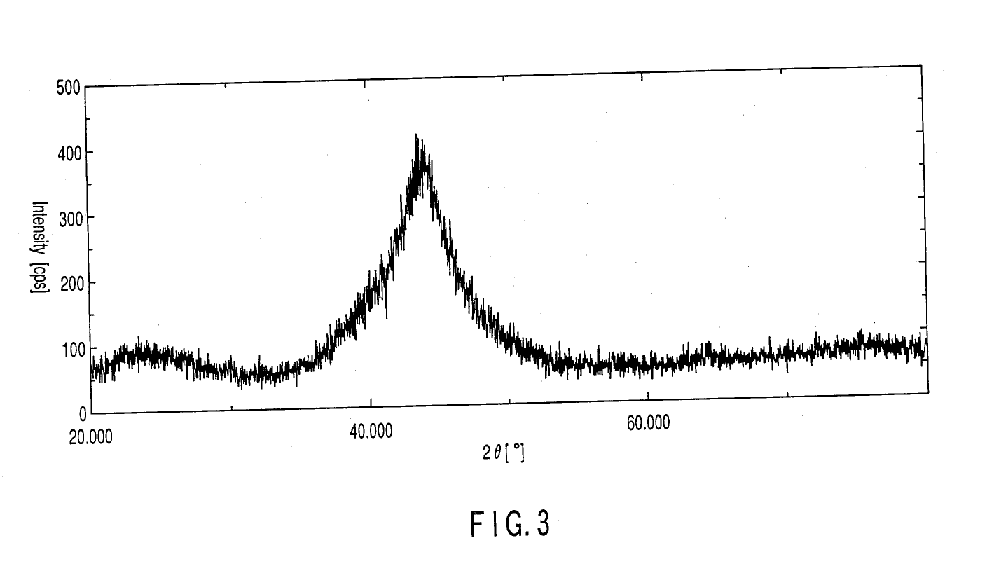

Crystallinity of the alloys obtained in Examples 1 to 10 is studied by X-ray diffractometry. As a result, it is confirmed that there is not observed any peak derived from a crystalline phase. In FIG. 3, an X-ray diffraction pattern (X-ray; CuKα) of an alloy according to Example 1 is shown.

The ribbon-like alloys according to Examples 1 to 3, and 7 and 8 are, after cutting out, pulverized by use of a jet mill to powders having an average particle diameter of 10 μm. Furthermore, the ribbon-like alloys according to Examples 4 to 6, and 9 and 10 are, after cutting out, heat-treated at 250° C. that is equal to or less than a crystallization temperature for 3 hours, thereby the alloys are made brittle while keeping an amorphous phase followed by pulverizing by use of a jet mill, and thereby alloy powders having an average particle diameter of 10 μm are obtained.

The alloy powder 94% by weight, carbon powder, that is, a conductive material, 3% by weight, styrene butadiene rubber, that is, a binder, 2% by weight, and carboxymethyl cellulose, that is, an organic solvent, 1% by weight are mixed and dispersed in water, and thereby a suspension is prepared. The suspension is coated on a copper foil, a collector, having a foil thickness of 18 μm followed by drying and pressing, and thereby a negative electrode is prepared.

<Preparation of Positive Electrode>

Lithium cobalt oxide powder 91% by weight, graphite powder 6% by weight, and polyvinylidene fluoride 3% by weight are mixed and dispersed in N-methyl-2-pyrrolidone, and thereby a suspension is prepared. The suspension is coated on an aluminum foil, a collector, followed by drying and pressing, and thereby a positive electrode is prepared.

<Preparation of Lithium Ion Secondary Battery>

A separator made of a porous polyethylene film is prepared. The positive electrode and the negative electrode with the separator interposed therebetween are spirally wound, and thereby an electrode group is prepared. Furthermore, lithium hexafluorophosphate as the solute is dissolved in a mixture (at a volume ratio of 1:2) of ethylene carbonate and methyl ethyl carbonate at a concentration of 1 mol/litter, and thereby a nonaqueous electrolyte is prepared.

The electrode group is accommodated in a cylindrical stainless case followed by filling therein the nonaqueous electrolyte further followed by sealing, and thereby a cylindrical lithium ion secondary battery is assembled.

### EXAMPLES 11 AND 12

By use of mechanical alloying, alloys having compositions shown in the following Table 1 are prepared. The crystallinity of the obtained alloys is studied by X-ray diffractometry and it is found that there is not observed any peak due to a crystalline phase. Subsequently, each of the alloys is pulverized with a jet mill and an alloy powder having an average particle diameter of 10 μm is prepared.

Except for the use of each of such alloy powders, similarly to the aforementioned Example 1, a lithium ion secondary battery is assembled.

### EXAMPLES 13 AND 14

After elements each of which has a ratio shown in Table 2 are heated and melted, in an inert atmosphere, an alloy melt is ejected from a nozzle opening having a diameter of 0.8 mm onto a BeCu alloy cooling roll that is rotating at a peripheral speed of 45 m/s and quenched, and thereby a ribbon-like or flake-like alloy is prepared. The crystallinity of each of the obtained alloys is studied by X-ray diffraction. As a result, it is confirmed that there is not observed any peak due to a crystalline phase. The atmosphere when the quenching process is performed may be an air atmosphere or an inert gas may be flowed to a nozzle tip end. In all cases, a similar alloy can be obtained.

Each of the alloys is, after the heat-treatment is applied at 300° C. that is a temperature equal to or more than the crystallization temperature for 1 hour in an inert atmosphere, cut and pulverized with a jet mill, and thereby an alloy powder having an average particle diameter of 10 μm is obtained.

1) Measurement of Ratio of Microcrystalline Phase in Alloy

An amount of heat generation due to differential scanning calorimetry (DSC) at a temperature rise speed of 10° C./min. is measured of each of alloys having compositions similar to those of Examples 13 and 14 and consisting essentially of an amorphous phase, and thereby a standard amount of heat generation is obtained. Furthermore, an amount of heat generation due to differential scanning calorimetry (DSC) at a temperature rise speed of 10° C./min. is measured of each of alloys according to Examples 13 and 14 whose ratio of a microcrystalline phase is unknown, and thereby an amount of heat generation is obtained. By comparing this amount of heat generation with the standard amount of heat generation, a ratio of the microcrystalline phase is measured. Results are shown in Table 2.

2) Measurement of Average Crystal Grain Size of Microcrystalline Phase

A transmission electron microgram (TEM) is taken, the maximum diameter of each of crystal grains is measured of 50 crystal grains adjacent to each other, and an average thereof is shown as an average crystal grain size in the following Table 2.

Except for the use of each of such alloy powders, similarly to the aforementioned Example 1, a lithium ion secondary battery is assembled.

### EXAMPLES 15 AND 16

Elements each of which has a ratio shown in Table 2 are heated and melted followed by solidifying with a single roll method in an inert atmosphere, and thereby an alloy is obtained. Specifically, in an inert atmosphere, an alloy melt is ejected from a nozzle opening having a diameter of 0.8 mm onto a BeCu alloy cooling roll that is rotating at a peripheral speed of 25 m/s and quenched, and thereby a flake-like alloy is prepared. The alloy is cut, pulverized with a jet mill, and an alloy powder having an average particle diameter of 10 μm is prepared.

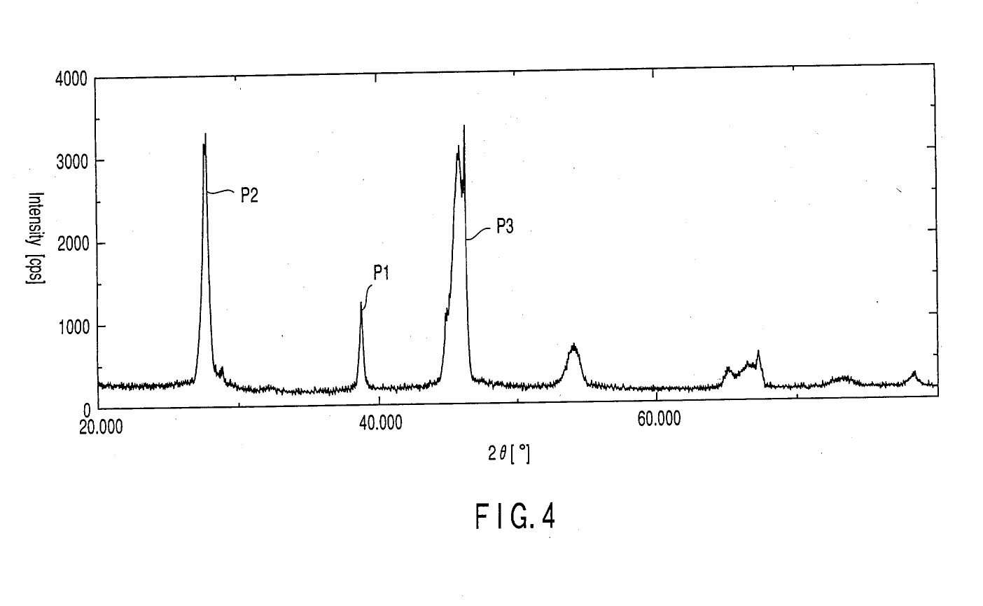

Of each of the obtained alloys, similarly to the aforementioned Example 13, a ratio of a microcrystalline phase and an average crystal grain size of the microcrystalline phase are measured, and results are shown in the following Table 2. Furthermore, in FIG. 4, an X-ray diffraction pattern (X-ray; CuKα) of the alloy according to Example 15 is shown. As obvious from FIG. 4, the alloy according to the Example 15 is found to show peaks due to a crystalline phase in the X-ray diffraction pattern. In FIG. 4, a peak P₁ in the neighborhood of 2θ of 40° is due to an Al phase, on the other hand, a peak P₂ in the neighborhood of 2θ of 30° and a peak P₃ in the neighborhood of 2θ of 45° are due to the microcrystalline phase. Furthermore, from the X-ray diffraction pattern of FIG. 4, a crystal structure of the microcrystalline phase contained in the alloy according to Example 15 is found to be a fluorite structure having a lattice constant of 5.52 Å.

Except for the use of each of such alloy powders, similarly to the aforementioned Example 1, a lithium ion secondary battery is assembled.

### EXAMPLES 17 AND 18

Elements each of which has a ratio shown in Table 2 are heated and melted followed by solidifying with a single roll in an inert atmosphere, and thereby an alloy is obtained. Specifically, in an inert atmosphere, an alloy melt is ejected from a nozzle opening having a diameter of 0.8 mm onto a BeCu alloy cooling roll that is rotating at a peripheral speed of 25 m/s and quenched, and thereby a flake-like alloy is prepared. The alloy is heat-treated at a temperature of 300° C. for 1 hour and thereby a metal texture is controlled. Subsequently, the alloy is cut, pulverized with a jet mill, and thereby an alloy powder having an average particle diameter of 10 μm is obtained.

Of each of the obtained alloys, similarly to the aforementioned Example 13, a ratio of a microcrystalline phase and an average crystal grain size of the microcrystalline phase are measured, and results are shown in the following Table 2.

Except for the use of each of such alloy powders, in a way similar to that explained in the aforementioned Example 1, a lithium ion secondary battery is assembled.

### EXAMPLES 19 AND 20

Elements each of which has a ratio shown in Table 2 are heated and melted followed by solidifying in an inert atmosphere with a single roll, and thereby an alloy is obtained. Specifically, in an inert atmosphere, an alloy melt is ejected from a nozzle opening having a diameter of 0.6 mm onto a BeCu alloy cooling roll that is rotating at a peripheral speed of 40 m/s and quenched, and thereby a ribbon-like or flake-like alloy is prepared. The crystallinity of each of the alloys is studied by X-ray diffraction. As a result, it is confirmed that there is not observed any peak due to a crystalline phase. The atmosphere when the quenching process is performed may be an air atmosphere or an inert gas may be flowed to a nozzle tip end. In either case, a similar alloy can be obtained.

Each of the alloys is, after the heat-treatment at 300° C. in an inert atmosphere for 1 hour, cut, and pulverized with a jet mill, and thereby an alloy powder having an average particle diameter of 10 μm is prepared.

1) Measurement of Ratio of Microcrystalline Phase in Alloy

With a diffraction intensity of the strongest peak in an X-ray diffraction pattern of an alloy that has a composition similar to those of Examples 19 and 20 and whose ratio of a microcrystalline phase is 100% as a reference, an intensity of a strongest peak of each of the alloys according to Examples 19 and 20 whose ratio of the microcrystalline phase is unknown is measured and compared with the reference intensity, and thereby a ratio of the microcrystalline phase of the alloy is evaluated. Results are shown in Table 2.

2) Measurement of Average Crystal Grain Size of Microcrystalline Phase

Similarly to the aforementioned Example 13, an average crystal grain size of the microcrystalline phase is measured, and results are shown in the following Table 2.

Except for the use of each of such alloy powders, similarly to the aforementioned Example 1, a lithium ion secondary battery is assembled.

### EXAMPLES 21 AND 22

Elements each of which has a ratio shown in Table 2 are heated and melted followed by solidifying with a single roll in an inert atmosphere, and thereby an alloy is obtained. Specifically, in an inert atmosphere, an alloy melt is ejected from a nozzle opening having a diameter of 0.7 mm onto a BeCu alloy cooling roll that is rotating at a peripheral speed of 20 m/s and quenched, and thereby a flake-like alloy is prepared. When the crystallinity of each of the obtained alloys is studied by X-ray diffraction, there is observed a peak due to the crystalline phase.

The alloy is heat-treated at a temperature of 300° C. for 1 hour to make brittle. Subsequently, the alloy is cut, pulverized with a jet mill, and thereby an alloy powder having an average particle diameter of 10 μm is prepared.

Of each of the obtained alloys, similarly to the aforementioned Example 19, a ratio of a microcrystalline phase and an average crystal grain size of the microcrystalline phase are measured, and results are shown in the following Table 2.

Except for the use of each of such alloy powders, similarly to the aforementioned Example 1, a lithium ion secondary battery is assembled.

### EXAMPLES 23 AND 24

Each of alloys having compositions shown in the following Table 2 is prepared with a mechanical alloying method. Subsequently, the alloy is pulverized with a jet mill, and an alloy powder having an average particle diameter of 10 μm is prepared.

Of each of the obtained alloys, similarly to the aforementioned Example 19, a ratio of a microcrystalline phase and an average crystal grain size of the microcrystalline phase are measured, and results are shown in the following Table 2.

Except for the use of each of such alloy powders, similarly to the aforementioned Example 1, a lithium ion secondary battery is assembled.

### EXAMPLES 25 TO 27

Elements each of which has a ratio shown in Table 2 are heated and melted followed by solidifying with a single roll in an inert atmosphere, and thereby an alloy is obtained. Specifically, in an inert atmosphere, an alloy melt is ejected from a nozzle opening having a diameter of 0.5 mm onto a BeCu alloy cooling roll that is rotating at a peripheral speed of 40 m/s and quenched, and thereby a ribbon-like or flake-like alloy is prepared. The crystallinity of each of the obtained alloys is studied by X-ray diffraction, and it is confirmed that there is observed no peak due to the crystalline phase.

Each of the alloys is heat-treated in an inert atmosphere at a temperature of 300° C. for 1 hour. Subsequently, the alloy is cut, pulverized with a jet mill, and thereby an alloy powder having an average particle diameter of 10 μm is prepared.

Of each of the obtained alloys, similarly to the aforementioned Example 13, a ratio of a microcrystalline phase and an average crystal grain size of the microcrystalline phase are measured, and results are shown in the following Table 2.

Except for the use of each of such alloy powders, similarly to the aforementioned Example 1, a lithium ion secondary battery is assembled.

### Comparative Example 1

Except for the use of carbonaceous material powder of mesophase pitch-based carbon fiber (average fiber diameter; 10 μm, average fiber length; 25 μm, interplanar spacing d₀₀₂; 0.3355 nm, and specific surface area due to BET; 3 m²/g) in place of the alloy powder, similarly to the aforementioned Example 1, a lithium ion secondary battery is assembled.

### Comparative Example 2

Except for the use of Al powder having an average particle diameter of 10 μm in place of the alloy powder, similarly to the aforementioned Example 1, a lithium ion secondary battery is assembled.

### Comparative Example 3

A Sn₃₀Co₇₀ alloy is prepared by spending 100 hours by use of the mechanical alloying. The obtained alloy is confirmed to be amorphous by X-ray diffraction. Except for the use of the alloy like this, similarly to the aforementioned Example 1, a lithium ion secondary battery is assembled.

### Comparative Examples 4 to 6

As negative electrode materials, a Si₃₃Ni₆₇ alloy, a (Al_{0.1}Si_{0.9})₃₃Ni₆₇ alloy, and a Cu₅₀Ni₂₅Sn₂₅ alloy are prepared according to a single-roll process. Roll material used is a BeCu alloy and a roll peripheral speed is 25 m/s. Each of the obtained alloys is confirmed to be microcrystallized by X-ray diffraction. Average crystal grain sizes are calculated according to Scherrer's equation and results are shown in the following Table 3. Except for the use of each of such alloys, similarly to the aforementioned Example 1, a lithium ion secondary battery is assembled.

### Comparative Example 7

As a negative electrode material, an Fe₂₅Si₇₅ alloy is obtained by atomization. When an average crystal grain size is calculated according to Scherrer's equation, it is found to be 300 nm. Except for the use of such an alloy, similarly to the aforementioned Example 1, a lithium ion secondary battery is assembled.

### Comparative Examples 8 to 10

After elements each of which has a ratio shown in Table 3 are heated and melted, in an inert atmosphere, an alloy melt is ejected from a nozzle opening having a diameter of 0.7 mm onto a cooling roll (roll material is BeCu alloy) that is rotating at a peripheral speed of 30 m/s according to a single roll method and quenched, and thereby a ribbon-like or a flake-like alloy is prepared. The crystallinity of each of the obtained alloys is studied by X-ray diffraction, and it is confirmed that there is observed no peak due to the crystalline phase.

Each of the alloys is heat-treated at a temperature of 300° C. in an inert atmosphere for 1 hour followed by cutting, and pulverizing with a jet mill, and thereby an alloy powder having an average particle diameter of 10 μm is prepared.

Of each of the obtained alloys, similarly to the aforementioned Example 13, a ratio of a microcrystalline phase and an average crystal grain size of the microcrystalline phase are measured, and results are shown in the following Table 2.

Except for the use of each of such alloy powders, similarly to the aforementioned Example 1, a lithium ion secondary battery is assembled.

To each of the secondary batteries according to Examples 1 to 27 and Comparative examples 1 to 10, a charge/discharge cycle test is applied in which the secondary battery is subjected to a repetition of charging under a charge current of 1.5 A up to a voltage of 4.2 V for 2 hours at 20° C. followed by discharging at 1.5 A to 2.7 V. Thereby, a discharge capacity ratio and a capacity maintenance rate at 300 cycles are measured, results thereof are shown in Tables 1 to 3. The discharge capacity ratio is a ratio of the discharge capacity relative to that of Comparative example 1, and the capacity maintenance rate is expressed by the discharge capacity at 300 cycles when the maximum discharge capacity is assigned to 100%.

Furthermore, with each of the secondary batteries according to Examples 1 to 27 and Comparative examples 1 to 10, under an environment of 20° C., at 1 C rate, one hour charge of a constant current and constant voltage to 4.2 V is applied, thereafter a discharge capacity is measured when the battery is discharged at 0.1 C rate to 3.0 V, and thereby a discharge capacity at 0.1 C is obtained. Furthermore, after charge is applied under the similar conditions, a discharge capacity is measured when the battery is discharged at 1 C rate to 3.0 V, and thereby a discharge capacity at 1 C is obtained. With the discharge capacity at 0.1 C rate assigned to 100%, the discharge capacity at 1 C rate is expressed. Results are shown in the following Tables 1 to 3 as rate characteristics.

Furthermore, of each of the secondary batteries according to Examples 1 to 27 and Comparative examples 1 to 10, the number of cycles required to attain the maximum discharge capacity when charge/discharge cycle is repeated at 1 C rate is measured, results thereof are shown in the following Tables 1 to 3.

TABLE 1

| | | | Battery characteristics | | | |
|---|---|---|---|---|---|---|
| | | | | | | Number of |
| | | | | Capacity | | repetitions |
| | Negative electrode material | | Discharge | mainte- | Rate | of charge/ |
| | | Metal | capacity | nance | character- | discharge |
| Examples | Alloy composition | texture | ratio | rate (%) | istics (%) | cycle |
| 1 | (Al_{0.75}Si_{0.25})₈₀Ni₁₄Co₄C₂ | Amorphous | 1.5 | 85 | 97 | 7 |
| 2 | (Al_{0.95}Si_{0.05})₈₄Ni₁₃Nb₂Cr₁ | Amorphous | 1.6 | 85 | 97 | 7 |
| 3 | (Al_{0.85}Si_{0.15})₈₄Ni₁₀Co₃Mo₂W₁ | Amorphous | 1.6 | 86 | 94 | 7 |
| 4 | (Al_{0.8}Si_{0.2})₈₀Ni₁₅Fe₃Zr₁La₁ | Amorphous | 1.5 | 90 | 94 | 7 |
| 5 | (Al_{0.7}Si_{0.3})₇₉Ni₁₅CU₂Ta₃Hf₁ | Amorphous | 1.4 | 91 | 95 | 7 |
| 6 | (Al_{0.65}Si_{0.35})₇₆Ni₁₀Mn₁Ti₂V₁Fe₁₀ | Amorphous | 1.4 | 89 | 97 | 7 |
| 7 | [(Al_{0.8}Si_{0.05}Ni_{0.1}Co_{0.04}C_{0.01})]₈₀Li₂₀ | Amorphous | 1.7 | 86 | 98 | 3 |
| 8 | [(Al_{0.9}Si_{0.1})_{0.84}Ni_{0.13}Nb_{0.02}Cr_{0.01}]₈₀Li₂₀ | Amorphous | 1.7 | 87 | 97 | 3 |
| 9 | [(Al_{0.8}Si_{0.2})_{0.84}Ni_{0.1}Co_{0.03}Mo_{0.02}W_{0.01}]₈₅Li₁₅ | Amorphous | 1.7 | 88 | 96 | 3 |
| 10 | [(Al_{0.7}Si_{0.3})_{0.8}Ni_{0.15}Fe_{0.03}Zr_{0.02}]₈₅Li₁₅ | Amorphous | 1.6 | 92 | 96 | 3 |
| 11 | [(Al_{0.6}Si_{0.4})_{0.78}Ni_{0.1}Cu_{0.08}Ta_{0.03}Hf_{0.01}]₉₀Li₁₀ | Amorphous | 1.5 | 92 | 95 | 3 |
| 12 | [(Al_{0.5}Si_{0.5})_{0.76}Ni_{0.15}Fe_{0.05}Mn_{0.01}Ti_{0.02}V_{0.01}]₈₈Li₁₂ | Amorphous | 1.5 | 90 | 95 | 3 |

TABLE 2

| | Negative electrode material | | | | | | |
|---|---|---|---|---|---|---|---|
| | | Microcrys- | | | | | |
| | | talline phase | | Battery characteristics | | | |
| | | | Average | | | | Number of |
| | | | crystal | | Capacity | | repetitions |
| | | | grain | Discharge | mainte- | Rate charac- | of charge/ |
| | | Ratio | size | capacity | nance | teristics | discharge |
| Examples | Alloy composition | (%) | (nm) | ratio | rate (%) | (%) | cycle |
| 13 | (Al_{0.8}Si_{0.2})₈₅Ni₁₀Co₃Nb₂ | 30 | 30 | 1.6 | 86 | 97 | 7 |
| 14 | (Al_{0.7}Si_{0.3})₈₄Ni₁₀Fe₂Nb₂Cr₁P₁ | 60 | 50 | 1.8 | 85 | 97 | 7 |
| 15 | (Al_{0.5}Si_{0.5})₇₈Ni₁₀Fe₇W₂Mo₁Ge₂ | 80 | 70 | 1.4 | 87 | 94 | 7 |
| 16 | (Al_{0.6}Si_{0.4})₈₀Ni₁₀Co₇Ta₁Pb₁Ce₁ | 50 | 50 | 1.5 | 84 | 94 | 7 |
| 17 | (Al_{0.7}Si_{0.3})₇₇Ni₁₄Cu₄Zr₃Hf₁Sn₁ | 100 | 80 | 1.5 | 86 | 95 | 7 |
| 18 | (Al_{0.6}Si_{0.4})₈₀Ni₁₀Mn₁Co₅Ti₃V₁ | 100 | 120 | 1.6 | 85 | 97 | 7 |
| 19 | [(Al_{0.7}Si_{0.3})_{0.8}Ni_{0.12}Co_{0.05}Nb_{0.03}]₈₀Li₂₀ | 20 | 40 | 1.7 | 87 | 98 | 3 |
| 20 | [(Al_{0.8}Si_{0.2})_{0.84}Ni_{0.1}Fe_{0.02}Nb_{0.02}Cr_{0.01} P_{0.01}]₈₀Li₂₀ | 50 | 70 | 1.9 | 86 | 97 | 3 |
| 21 | [(Al_{0.6}Si_{0.4})_{0.77}Ni_{0.1}Fe_{0.08}W_{0.02}Mo_{0.01}Ge_{0.02}]₈₅Li₁₅ | 100 | 90 | 1.5 | 91 | 96 | 3 |
| 22 | [(Al_{0.5}Si_{0.5})_{0.8}Ni_{0.1}Co_{0.07}Ta_{0.02}Pb_{0.01}]₈₅Li₁₅ | 90 | 80 | 1.6 | 85 | 96 | 3 |
| 23 | [(Al_{0.75}Si_{0.25})_{0.77}Ni_{0.14}Cu_{0.04}Zr_{0.03}Hf_{0.01}Sn_{0.01}]₉₀Li₁₀ | 80 | 80 | 1.6 | 87 | 95 | 3 |
| 24 | [(Al_{0.8}Si_{0.2})_{0.8}Ni_{0.1}Mn_{0.01}Co_{0.05}Ti_{0.03}V_{0.01}]₈₈Li₁₂ | 100 | 120 | 1.8 | 86 | 95 | 3 |
| 25 | (Al_{0.7}Si_{0.3})₇₅Fe₁₀Ni₁₀Cr₅ | 20 | 30 | 1.5 | 87 | 96 | 7 |
| 26 | (Al_{0.5}Si_{0.5})₇₅Fe₁₀Ni₁₀Cr₅ | 30 | 60 | 1.7 | 85 | 96 | 7 |
| 27 | (Al_{0.3}Si_{0.7})₇₅Fe₁₀Ni₁₀Cr₅ | 50 | 90 | 1.8 | 82 | 96 | 7 |

TABLE 3

| | Negative electrode material | | | | | | |
|---|---|---|---|---|---|---|---|
| | | Microcrystalline | | | | | |
| | | phase | | Battery characteristics | | | |
| | | | Average | | | | Number of |
| | | | crystal | | Capacity | Rate | repetitions |
| | | | grain | Discharge | mainte- | charac- | of charge/ |
| Comparative | | | size | capacity | nance | teristics | discharge |
| Examples | Alloy composition | Ratio (%) | (nm) | ratio | rate (%) | (%) | cycle |
| 1 | C | — | 5000 | 1 | 70 | 80 | 7 |
| 2 | Al | 100 | 10000 | 3 | 2 | 40 | Immeasurable |
| 3 | Sn₃₀Co₇₀ | Amorphous | — | 1.1 | 80 | 82 | 9 |
| 4 | Si₃₃Ni₆₇ | 100 | 40 | 1.0 | 82 | 85 | 9 |
| 5 | (Al_{0.1}Si_{0.9})₃₃Ni₆₇ | 100 | 300 | 1.0 | 55 | 70 | 7 |
| 6 | Cu₅₀Ni₂₅Sn₂₅ | 100 | 200 | 1.0 | 70 | 75 | 8 |
| 7 | Si₂₅Fe₇₅ | 100 | 300 | 0.7 | 65 | 70 | 7 |
| 8 | Ni(Si_{0.8}Al_{0.2})₂ | 100 | 400 | 1.2 | 60 | 65 | 5 |
| 9 | (Al_{0.1}Si_{0.9})₇₅Fe₁₀Ni₁₀Cr₅ | 80 | 150 | 1.5 | 60 | 80 | 7 |
| 10 | Si₇₅Fe₁₀Ni₁₀Cr₅ | 100 | 300 | 1.2 | 55 | 70 | 6 |

As obvious from Tables 1 to 3, the secondary batteries according to Examples 1 to 27 are excellent in all of the discharge capacity, the capacity maintenance rate at 300 cycles and the rate characteristics.

On the other hand, the secondary battery according to Comparative example 1 in which a carbonaceous material is used as the negative electrode material is inferior to Examples 1 to 27 in all of the discharge capacity, the capacity maintenance rate at 300 cycles and the rate characteristics. Furthermore, it is found that the secondary battery according to Comparative example 2 in which an Al metal is used as the negative electrode material, though higher in the discharge capacity than Examples 1 to 27, is inferior in the capacity maintenance rate at 300 cycles and the rate characteristics to Examples 1 to 27. On the other hand, the secondary batteries according to Comparative examples 3 to 7 are inferior in the rate characteristics to Examples 1 to 27.

When each of the negative electrodes after the repetitions of 300 times of charge/discharge cycle is observed, it is found that there is no change in the alloys of the negative electrodes used in Examples 1 to 24. However, in the negative electrode of Comparative example 2, Al dendrite is found to precipitate. It is supposed that the secondary battery according to Comparative example 2, though higher in an initial battery discharge capacity, as a result of the precipitation of the Al dendrite, deteriorates drastically in the capacity maintenance rate after 300 cycles. Furthermore, since the Al dendrite is easy to react with the electrolyte, the battery may be lowered in safety.

Still furthermore, when Examples 25 to 27 and Comparative examples 9 and 10 are compared, it is found that by setting an atomic ratio x of Si at less than 0.75, the capacity maintenance rate at 300 cycles and the rate characteristics can be improved.

On the other hand, the secondary battery according to Comparative example 8 that uses an alloy that has a composition disclosed in Jpn. Pat. Appln. KOKAI Publication No. 10-302770 has the capacity maintenance rate at 300 cycles such low as 60%, and the rate characteristics are also such low as 65%.

### EXAMPLES 28 TO 37

<Preparation of Negative Electrode>

Elements each of which has a ratio shown in Table 4 are heated and melted followed by solidifying in an inert atmosphere with a single roll, and thereby an alloy is obtained. That is, in an inert atmosphere, an alloy melt is ejected from a nozzle opening having a diameter of 0.6 mm onto a BeCu alloy cooling roll that is rotating at a peripheral speed of 40 m/s and quenched, and thereby a ribbon like alloy is prepared. The quenching can be carried out in an air atmosphere, or an inert gas may be flowed to a tip end of the nozzle. In either case, a similar alloy can be obtained.

The crystallinity of each of the alloys obtained in Examples 28 to 37 is studied by X-ray diffraction. It is confirmed that there is observed no peak due to a crystalline phase.

Each of the ribbon-like alloys according to Examples 28 to 30, 36 and 37 is, after cutting out, pulverized by use of a jet mill, and thereby a powder having an average particle diameter of 10 μm is prepared. Furthermore, each of the ribbon-like alloys according to Examples 31 to 35 is, after cutting out, heat-treated at 300° C. that is equal to or less than a crystallization temperature for 5 hours, thereby the alloy is made brittle while maintaining an amorphous phase, followed by pulverizing by use of a jet mill, and thereby an alloy powder having an average particle diameter of 10 μm is prepared.

Except for the use of each of the alloy powders, similarly to the above-explained Example 1, a cylindrical lithium ion secondary battery is assembled.

### EXAMPLES 38 AND 39

By use of mechanical alloying, alloys having compositions shown in the following Table 4 are prepared. The crystallinity of each of the obtained alloys is studied by X-ray diffraction and it is found that there is not observed any peak due to a crystalline phase. Subsequently, the alloy is pulverized with a jet mill, and an alloy powder having an average particle diameter of 10 μm is prepared.

Except for the use of each of such alloy powders, similarly to the aforementioned explanation given in Example 1, a lithium ion secondary battery is assembled.

### EXAMPLES 40 AND 41

Elements each of which has a ratio shown in Table 5 are heated and melted followed by solidifying in an inert atmosphere with a single roll, and thereby an alloy is obtained. That is, in an inert atmosphere, an alloy melt is ejected from a nozzle opening having a diameter of 0.6 mm onto a BeCu alloy cooling roll that is rotating at a peripheral speed of 45 m/s and quenched, and thereby a ribbon-like or flake-like alloy is prepared. The crystallinity of each of the obtained alloys is studied by X-ray diffraction. As a result, it is confirmed that there is not observed any peak due to a crystalline phase.

Each of the alloys, after the heat-treatment in an inert atmosphere at 350° C. that is equal to or more than the crystallization temperature for 1 hour, is cut, and pulverized with a jet mill, and thereby an alloy powder having an average particle diameter of 10 μm is prepared.

Of each of the obtained alloys, similarly to the aforementioned Example 13, a ratio of a microcrystalline phase and an average crystal grain size of the microcrystalline phase are measured, and results are shown in the following Table 5.

Except for the use of each of such alloy powders, similarly to the aforementioned Example 1, a lithium ion secondary battery is assembled.

### EXAMPLES 42 AND 43

Elements each of which has a ratio shown in Table 5 are heated and melted followed by solidifying with a single roll in an inert atmosphere, and thereby an alloy is obtained. That is, in an inert atmosphere, an alloy melt is ejected from a nozzle opening having a diameter of 0.7 mm onto a BeCu alloy cooling roll that is rotating at a peripheral speed of 40 m/s and quenched, and thereby a flake-like alloy is prepared. Subsequently, the alloy is cut, pulverized with a jet mill, and thereby an alloy powder having an average particle diameter of 10 μm is prepared.

Of each of the obtained alloys, similarly to the aforementioned Example 13, a ratio of a microcrystalline phase and an average crystal grain size of the microcrystalline phase are measured, and results are shown in the following Table 5.

Except for the use of each of such alloy powders, similarly to the explanation given in the aforementioned Example 1, a lithium ion secondary battery is assembled.

### EXAMPLES 44 AND 45

After elements each of which has a ratio shown in Table 5 are heated and melted, an alloy is obtained by solidifying with a single roll in an inert atmosphere. That is, in an inert atmosphere, an alloy melt is ejected from a nozzle opening having a diameter of 0.7 mm onto a BeCu alloy cooling roll that is rotating at a peripheral speed of 40 m/s and quenched, and thereby a flake-like alloy is prepared. The alloy is heat-treated at 300° C. for 1 hour, and thereby a metal texture is controlled. Subsequently, the alloy is cut, and pulverized with a jet mill, and thereby an alloy powder having an average particle diameter of 10 μm is prepared.

Of each of thus obtained alloys, similarly to the aforementioned Example 13, a ratio of a microcrystalline phase and an average crystal grain size of the microcrystalline phase are measured, and results are shown in the following Table 5.

Except for the use of each of such alloys, similarly to the explanation given in the aforementioned Example 1, a lithium ion secondary battery is assembled.

### EXAMPLES 46 AND 47

After elements each of which has a ratio shown in Table 5 are heated and melted, an alloy is obtained by use of a single roll method in an inert atmosphere. That is, in an inert atmosphere, an alloy melt is ejected from a nozzle opening having a diameter of 0.5 mm onto a BeCu alloy cooling roll that is rotating at a peripheral speed of 35 m/s and quenched, and thereby a ribbon-like or a flake-like alloy is prepared. The crystallinity of each of the obtained alloys is studied by X-ray diffraction. As a result, it is confirmed that there is not observed any peak due to a crystalline phase.

Each of the alloys, after the heat-treatment in an inert atmosphere at 300° C. for 1 hour, is cut, and pulverized with a jet mill, and thereby an alloy powder having an average particle diameter of 10 μm is prepared.

Of each of the obtained alloys, similarly to the aforementioned Example 13, a ratio of a microcrystalline phase and an average crystal grain size of the microcrystalline phase are measured, and results are shown in the following Table 5.

Except for the use of each of such alloys, similarly to the aforementioned Example 1, a lithium ion secondary battery is assembled.

### EXAMPLES 48 AND 49

After elements each of which has a ratio shown in Table 5 are heated and melted, an alloy is obtained by use of a single roll method in an inert atmosphere. That is, in an inert atmosphere, an alloy melt is ejected from a nozzle opening having a diameter of 0.45 mm onto a BeCu alloy cooling roll that is rotating at a peripheral speed of 45 m/s and quenched, and thereby a flake-like alloy is prepared.

Each of the alloys, after the heat-treatment in an inert atmosphere at 300° C. for 1 hour to make brittle, is cut, and pulverized with a jet mill, and thereby an alloy powder having an average particle diameter of 10 μm is prepared.

Of each of the obtained alloys, similarly to the aforementioned Example 13, a ratio of a microcrystalline phase and an average crystal grain size of the microcrystalline phase are measured, and results are shown in the following Table 5.

Except for the use of each of such alloys, similarly to the aforementioned Example 1, a lithium ion secondary battery is assembled.

### EXAMPLES 50 AND 51

By use of mechanical alloying, alloys having compositions shown in the following Table 5 are prepared. Subsequently, each of the alloys is pulverized with a jet mill, and thereby an alloy powder having an average particle diameter of 10 μm is prepared.

Of each of the obtained alloys, similarly to the aforementioned Example 13, a ratio of a microcrystalline phase and an average crystal grain size of the microcrystalline phase are measured, and results are shown in the following Table 5.

Except for the use of each of such alloy powders, similarly to the aforementioned explanation given in Example 1, a lithium ion secondary battery is assembled.

### Comparative Examples 11 to 13

As the negative electrode materials, an Al₃Mg₄ alloy, an Al₈Mg₅ alloy and a Cu₃Mg₂Si alloy are prepared according to a single roll method. The roll material is BeCu alloy and a roll peripheral speed is 30 m/s. Each of the obtained alloys is confirmed to be microcrystalline by X-ray diffraction. Average crystal grain sizes are calculated according to Scherrer's equation and results are shown in the following Table 6. Except for the use of each of such alloys, similarly to the aforementioned Example 1, a lithium ion secondary battery is assembled.

Of the secondary batteries obtained according to Examples 28 to 51 and Comparative examples 11 to 13, similarly as explained in the aforementioned Example 1, the discharge capacity ratio, capacity maintenance rate, rate characteristics and the number of repetitions of charge/discharge cycle at which the maximum capacity is attained are evaluated, and results thereof are shown in Tables 4 to 6. In Table 6, the results of the aforementioned Comparative examples 3 and 6 are shown together.

TABLE 4

| | | | Battery characteristics | | | |
|---|---|---|---|---|---|---|
| | | | | | | Number of |
| | | | | Capacity | | repetitions |
| | Negative electrode material | | Discharge | mainte- | Rate | of charge/ |
| | | Metal | capacity | nance | character- | discharge |
| Examples | Alloy composition | texture | ratio | rate (%) | istics (%) | cycle |
| 28 | (Al_{0.9}Mg_{0.1})₈₇Ni₈Co₄C₁ | Amorphous | 1.5 | 85 | 95 | 7 |
| 29 | (Al_{0.95}Mg_{0.05})₈₄Ni₁₃Nb₂Cr₁ | Amorphous | 1.5 | 85 | 97 | 7 |
| 30 | (Al_{0.85}Mg_{0.15})₈₄Ni₁₀Co₃Mo₂W₁ | Amorphous | 1.5 | 86 | 96 | 7 |
| 31 | (Al_{0.8}Mg_{0.2})₈₀Ni₁₅Fe₃Zr₁Pr₁ | Amorphous | 1.4 | 90 | 98 | 7 |
| 32 | (Al_{0.75}Mg_{0.15}Si_{0.1})₇₇Ni₁₆Co₃Cu₁Ta₂Hf₁ | Amorphous | 1.3 | 91 | 95 | 7 |
| 33 | (Al_{0.75}Mg_{0.15}Si_{0.1})₇₆Ni₁₇Fe₂Mn₁Ti₃V₁ | Amorphous | 1.3 | 89 | 97 | 7 |
| 34 | [(Al_{0.9}Mg_{0.1})_{0.87}Ni_{0.08}Co_{0.04}C_{0.01})]₈₀Li₂₀ | Amorphous | 1.6 | 86 | 98 | 3 |
| 35 | [(Al_{0.95}Mg_{0.05})_{0.84}Ni_{0.13}Nb_{0.02}Cr_{0.01})]₈₀Li₂₀ | Amorphous | 1.6 | 87 | 94 | 3 |
| 36 | [(Al_{0.85}Mg_{0.15})_{0.84}Ni_{0.1}Co_{0.03}Mo_{0.02}W_{0.01})]₈₅Li₁₅ | Amorphous | 1.6 | 88 | 94 | 3 |
| 37 | [(Al_{0.8}Mg_{0.2})_{0.8}Ni_{0.1}Fe_{0.08}Zr_{0.02})]₈₅Li₁₅ | Amorphous | 1.5 | 92 | 94 | 3 |
| 38 | [(Al_{0.75}Mg_{0.25})_{0.78}Ni_{0.15}Co_{0.03}Cu_{0.02}Ta_{0.01}Hf_{0.01})]₉₀Li₁₀ | Amorphous | 1.4 | 92 | 96 | 3 |
| 39 | [(Al_{0.75}Mg_{0.25})_{0.76}Ni_{0.14}Fe_{0.05}Mn_{0.01}Ti_{0.03}V_{0.01})]₈₈Li₁₂ | Amorphous | 1.4 | 90 | 98 | 3 |

TABLE 5

| | Negative electrode material | | | | | | |
|---|---|---|---|---|---|---|---|
| | | Microcrys- | | | | | |
| | | talline phase | | Battery characteristics | | | |
| | | | Average | | | | Number of |
| | | | crystal | | Capacity | Rate | repetitions |
| | | | grain | Discharge | mainte- | charac- | of charge/ |
| | | Ratio | size | capacity | nance | teristics | discharge |
| Examples | Alloy composition | (%) | (nm) | ratio | rate (%) | (%) | cycle |
| 40 | (Al_{0.7}Mg_{0.3})₈₀Ni₁₂Co₅Nb₂Nd₁ | 90 | 40 | 1.5 | 86 | 96 | 7 |
| 41 | (Al_{0.8}Mg_{0.2})₇₉Ni₁₅Fe₂Nb₂Cr₁P₁ | 70 | 60 | 1.7 | 85 | 95 | 7 |
| 42 | (Al_{0.5}Mg_{0.5})₇₆Ni₁₁Fe₁₀W₁Mo₁Ge₁ | 90 | 80 | 1.3 | 87 | 95 | 7 |
| 43 | (Al_{0.8}Mg_{0.2})₈₀Ni₁₀Co₇Ta₂Pb₁ | 60 | 60 | 1.4 | 84 | 96 | 7 |
| 44 | (Al_{0.75}Mg_{0.25})₇₇Ni₁₄Cu₄Zr₃Hf₁Sn₁ | 100 | 50 | 1.4 | 86 | 94 | 7 |
| 45 | (Al_{0.6}Mg_{0.4})₈₀Ni₁₀Mn₁Co₅Ti₃V₁ | 100 | 90 | 1.5 | 85 | 92 | 7 |
| 46 | [(Al_{0.8}Mg_{0.2})_{0.8}Ni_{0.12}Co_{0.05}Nb_{0.03}]]₈₀Li₂₀ | 100 | 60 | 1.6 | 87 | 91 | 3 |
| 47 | [(Al_{0.7}Mg_{0.3})_{0.82}Ni_{0.12}Fe_{0.02}Nb_{0.02}Cr_{0.01}P_{0.01}]]₈₀Li₂₀ | 90 | 80 | 1.8 | 86 | 92 | 3 |
| 48 | [(Al_{0.9}Mg_{0.1})_{0.78}Ni_{0.1}Fe_{0.07}W_{0.02}Mo_{0.01}Ge_{0.02}]]₈₅Li₁₅ | 100 | 110 | 1.4 | 91 | 91 | 3 |
| 49 | [(Al_{0.7}Mg_{0.3})_{0.8}Ni_{0.1}Co_{0.07}Ta_{0.02}Pb_{0.01}]]₈₅Li₁₅ | 90 | 100 | 1.5 | 85 | 93 | 3 |
| 50 | [(Al_{0.7}Mg_{0.3})_{0.77}Ni_{0.14}Cu_{0.04}Zr_{0.03}Hf_{0.01}Sn_{0.01}]]₉₀Li₁₀ | 90 | 90 | 1.5 | 87 | 92 | 3 |
| 51 | [(Al_{0.8}Mg_{0.2})_{0.8}Ni_{0.1}Mn_{0.01}Co_{0.05}Ti_{0.03}V_{0.01}]]₈₈Li₁₂ | 100 | 150 | 1.7 | 86 | 92 | 3 |

TABLE 6

| | Negative electrode material | | | Battery characteristics | | | |
|---|---|---|---|---|---|---|---|
| | | Microcrystalline phase | | | | | Number of |
| | | | Average | | | Rate | repetitions |
| | | | crystal | Discharge | Capacity | charac- | of charge/ |
| Comparative | Alloy | | grain size | capacity | maintenance | teristics | discharge |
| Examples | composition | Ratio (%) | (nm) | ratio | rate (%) | (%) | cycle |
| 3 | Sn₃₀Co₇₀ | Amorphous | — | 1.2 | 80 | 82 | 9 |
| 6 | Cu₅₀Ni₂₅Sn₂₅ | 100 | 200 | 1.1 | 70 | 75 | 8 |
| 11 | Al₃Mg₄ | 100 | 500 | 1.0 | 60 | 75 | 8 |
| 12 | Al₈Mg₅ | 100 | 600 | 1.0 | 70 | 75 | 8 |
| 13 | Cu₃Mg₂Si | 100 | 400 | 0.9 | 75 | 77 | 8 |

As obvious from Tables 4 to 6, the secondary batteries according to Examples 28 to 51 are excellent in all of the discharge capacity, the capacity maintenance rate at 300 cycles and rate characteristics.

On the other hand, it is found that the secondary batteries according to Comparative examples 3 and 6 in each of which the alloy has a Sn content exceeding 20 atomic percent are inferior to Examples 28 to 51 in all of the discharge capacity, the capacity maintenance rate at 300 cycles and rate characteristics. Furthermore, in the secondary batteries according to Comparative examples 11 and 12 in each of which a binary alloy between Al and Mg is used and the secondary battery according to Comparative example 13 in which a tertiary alloy between Cu and Mg and Si is used, the capacity maintenance rate at 300 cycles and the rate characteristics are inferior to Examples 28 to 51.

### EXAMPLES 52 AND 53

After each of mother alloys having compositions shown in Table 7 is heated and melted, an alloy is obtained with a single roll method in an inert atmosphere. That is, in an inert atmosphere, an alloy melt is ejected from a nozzle opening (0.5 mm diameter) onto a cooling roll that is rotating at a peripheral speed of 25 m/s so that an alloy thickness is 15 μm, thereby the melt is quenched to solidify into a ribbon-like alloy. Incidentally, the nozzle is arranged so that a gap between the roll and the nozzle is 0.5 mm. And a roll material is BeCu alloy, a roll diameter is 500 mm, and a roll width is 150 mm.

Of each of the alloys obtained according to Examples 52 and 53, evaluation tests explained in the following (1) to (4) are carried out, results are shown in the following Tables 7 and 8.

(1) X-ray Diffractometry

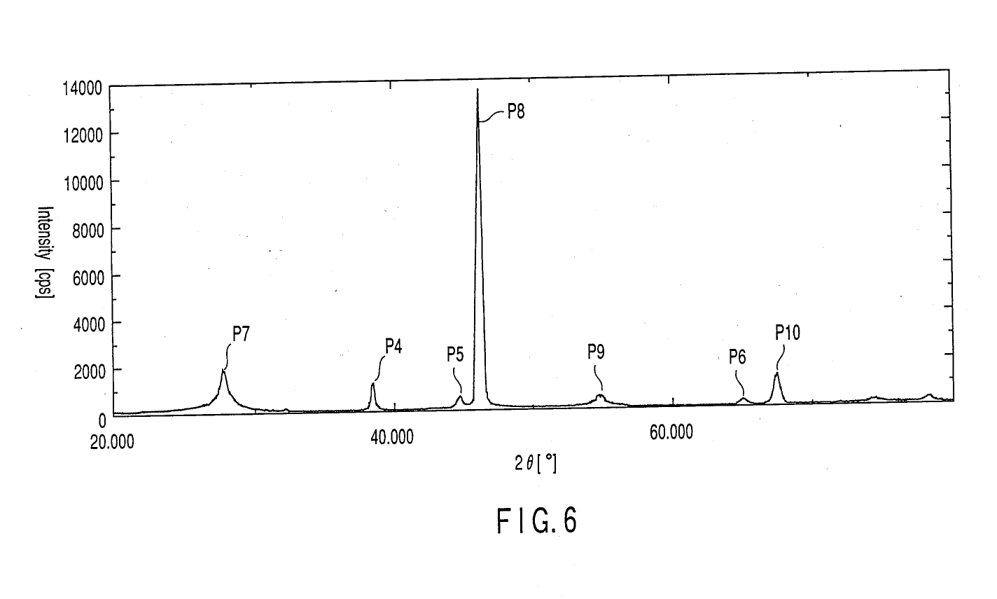

When a powder X-ray diffraction measurement is carried out of each of the obtained alloys, as shown in Table 7, diffraction peaks due to an intermetallic compound and diffraction peaks due to a second phase are obtained. An X-ray diffraction pattern of Example 52 is shown in FIG. 6. Specifically, it is confirmed that the second phase that is principally made of Al and an intermetallic compound phase are present. In the X-ray diffraction pattern of FIG. 6, peaks due to Al metal are detected at 2θ of 38.44°, 44.74°, and 65.04°, and peaks due to a solid solution phase in which an Al dissolved Si₂Ni phase are detected at 2θ of 27.76°, 46.22°, 54.80° and 67.48°. An interplanar spacing d can be obtained from an experimental value of θ with help of 2d sin θ=λ (here, θ: diffraction angle, and λ: wavelength of X-ray). From the X-ray diffraction pattern, it can be speculated that the intermetallic compound of the first phase has a fluorite (CaF₂) structure and its basis is a solid solution phase in which an Al dissolved Si₂Ni lattice, and it is furthermore confirmed that other constituent elements are also contained in this phase. Furthermore, the constituent elements of the second phase due to TEM-EDX are shown in the following Table 8. Still furthermore, from the obtained X-ray diffraction pattern, lattice constants of the fluorite structures are calculated, results thereof are shown in the following Table 7.

On the other hand, mother alloys used to prepare the alloys of Examples 52 and 53 contain an Al₃Ni phase, a Si₂Ni phase (Al is not dissolved) and an Al phase. When diffraction angles of peaks due to Si₂Ni in the X-ray diffraction pattern of the mother alloy and those due to Si₂Ni in the X-ray diffraction pattern of FIG. 6 are compared, it is confirmed that the Si₂Ni phases contained in the alloys of Examples 52 and 53 are dissolved with Al in the form of the solid solution.

The intensity relative to the strongest peak intensity of the fluorite structure of the intermetallic compound varies according to the composition of the alloy and the diffraction angle shifts according to a dissolving ratio of Al into the Si₂Ni phase or Si₂Co phase in the form of a solid solution. Each of the mother alloys used to prepare the alloys of the respective Examples, when AlSiNi is taken as a basis, is consisting essentially of an Al₃Ni phase, a Si₂Ni phase (Al is not dissolved) and an Al phase, and in some cases, an Al₃Ni₂ phase is further contained. On the other hand, when AlSiCo is taken as the basis, each of the mother alloys is consisting essentially of an Al₉Co₂ phase, a Si₂Co phase, and an Al phase. The maximum diameter of the crystal grains in the mother alloy exceeds 500 nm in all cases, and in almost all cases, it is an order of micrometer.

(2) Transmission Electron Microscope (TEM) Observation

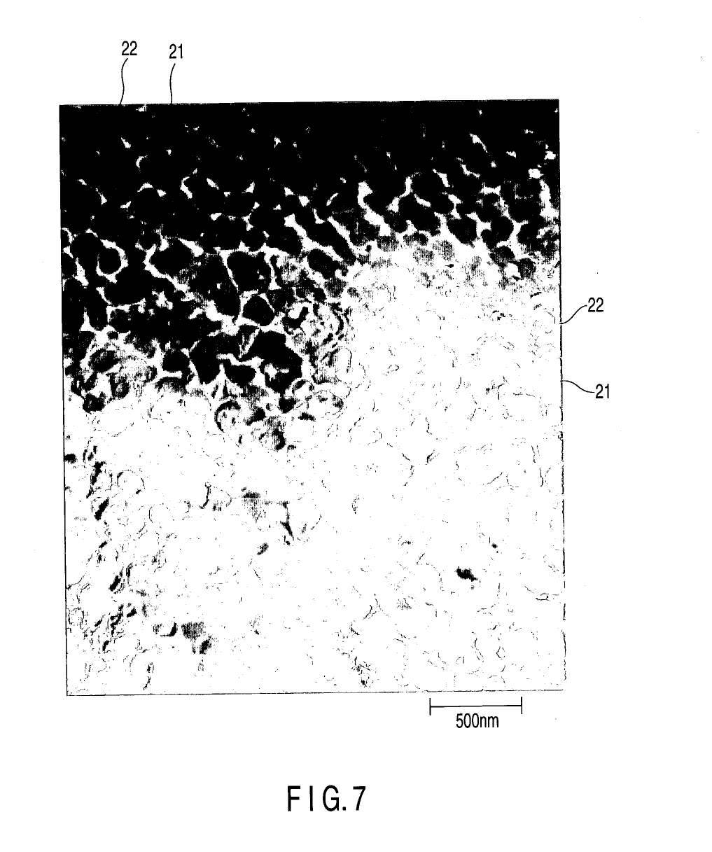

When a metal texture is confirmed by taking a TEM microgram (10⁵ magnification), it is found that in all cases, crystal grains of the intermetallic compound are precipitated at least partially isolated, and the second phase consisting essentially of an element that can form an alloy with lithium precipitates so as to fill in between islands formed by this precipitation. A TEM microgram of the alloy according to Example 52 is shown in FIG. 7. In FIG. 7, isolated crystal grains (black) are crystal grains 21 of the intermetallic compound and a phase (gray) that fills in between the isolated crystal grains 21 is the second phase 22. Furthermore, from FIG. 7, it can be seen that a network structure of the second phase is broken and the second phase is partially isolated.

Furthermore, of each of mutually adjacent 50 crystal grains of the intermetallic compound in the TEM microgram, the maximum diameter is measured and an average thereof is taken as an average crystal grain size. These are 100 nm and 60 nm, respectively, for Examples 52 and 53. When two or more crystal grains of the intermetallic compound are in contact, the maximum length of each of the crystal grains of the intermetallic compound that can be separated by a grain boundary is measured as the crystal grain size.

Furthermore, of mutually adjacent 50 crystal grains of the intermetallic compound in the TEM microgram, a distance between the mutually adjacent crystal grains of the intermetallic compound is measured at arbitral 50 positions and an average thereof is taken as an average of distances between crystal grains of the intermetallic compound. These are 60 nm and 30 nm, respectively, for Examples 52 and 53.

Still furthermore, in one visual field of the TEM microgram, an entire area that includes at least 50 crystal grains of the intermetallic compound is assigned as 100%. An area ratio (%) of the first phase of the entire area is obtained by means of image processing. The area ratio (%) of the first phase is subtracted from the entire area, and thereby an area ratio of the second phase, that is, an occupation rate of the second phase in the negative electrode material is obtained. These are 17% and 30%, respectively, for Examples 52 and 53. When two or more crystal grains of the intermetallic compound are in contact each other, these are not counted as one but as the number of crystal grains of the intermetallic compound that can be separated by the grain boundary.

Subsequently, the number of crystal grains of the intermetallic compound for an alloy area of 1 μm² is measured according to a method that will be explained in the following. As a result, these are 80 crystal grains and 205 crystal grains, respectively, for the alloys according to Examples 52 and 53.

That is, the number of islands of the intermetallic compound within a range of 1 μm² in one visual field in the TEM microgram is counted. At this time, the island on a borderline that divides into 1 μm×1 μm is counted as one. The results are shown in Table 10. When two or more crystal grains of the intermetallic compound are in contact with each other, these are not counted as one but as the number of crystal grains of the intermetallic compound that can be separated by the grain boundary.

(3) Differential Scanning Calorimetry (DSC)

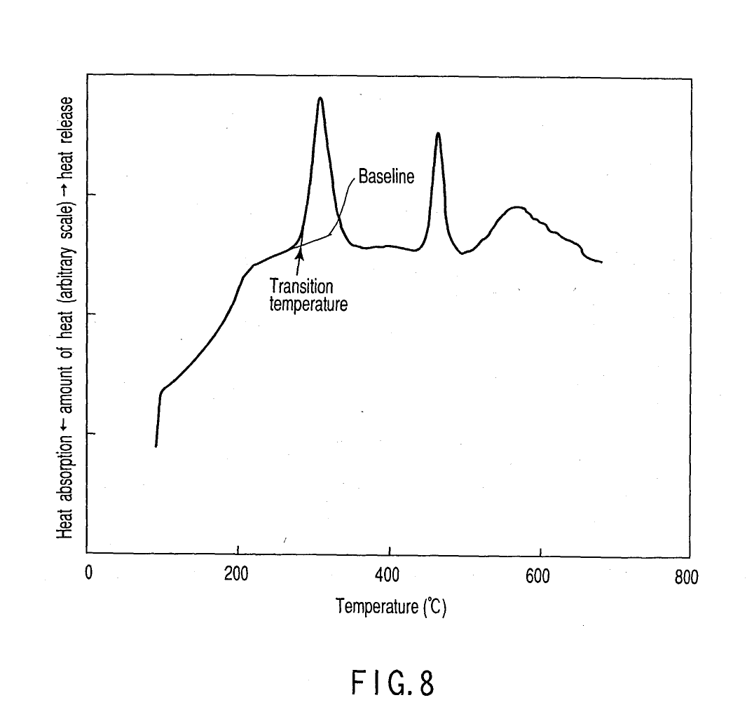

The differential scanning calorimetry is carried out with help of a differential scanning calorimeter (DSC) at a temperature raise speed of 10° C./min. in an inert atmosphere. A temperature at which a nonequilibrium phase transforms to an equilibrium phase is measured with a peak of heat generation. A DSC curve of the alloy according to Example 52 is shown in FIG. 8. A point where a curve that shows less variation (base line) among a peak of heat generation and the largest gradient of the peak of heat generation intersect is defined as a transition temperature T. These temperatures are shown in Table 8. First peaks of heat generation of Examples 52 and 53 are found at 293° C. and 267° C., respectively. The transition temperature obtained according to such a method is a temperature relatively close to a rising edge of the peak of heat generation.

(4) TEM-EDX (Transmission Electron Microscopy-Energy Dispersive X-ray Spectrometry)

It is confirmed with TEM-EDX that other elements are dissolved in the form of the solid solution at a ratio equal to or less than 10 atomic % in the second phase of each of the alloys. In the second phase of the alloy according to Example 52, 3 atomic percent of Si and 2.5 atomic percent of Ni are contained, and in the second phase of the alloy according to Example 53, 2.2 atomic percent of Si and 1.9 atomic percent of Ni are contained.

After the evaluations of (1) to (4), each of the alloys according to Examples 52 and 53 is cut, pulverized with a jet mill, and an alloy powder having an average particle diameter of 10 μm is prepared.

Except for the use of each of the obtained alloy powders, in the manner similar to that explained in the aforementioned Example 1, a lithium ion secondary battery is assembled.

### EXAMPLES 54 TO 72

After each of mother alloys having compositions shown in Tables 8 and 9 is heated and melted, in an inert atmosphere, an alloy melt is ejected from a nozzle opening (0.5 mm diameter) onto a cooling roll that is rotating at a peripheral speed of 25 m/s according to a single roll method so that an alloy thickness is 15 μm, thereby the melt is quenched to solidify into a ribbon-like alloy. Incidentally, the nozzle is arranged so that a gap between the roll and the nozzle is 0.5 mm. And a roll material is BeCu alloy, a roll diameter is 500 mm, and a roll width is 150 mm.

Of each of the alloys obtained according to Examples 54 to 72, similarly to Examples 52 and 53, evaluation tests according to the following (1) X-ray diffraction, (2) TEM observation, (3) differential scanning calorimetry, and (4) composition analysis due to TEM-EDX are carried out, results are shown in the following Tables 8 to 11.

After the evaluations according to (1) to (4), each of the alloys of Examples 54 to 72 is cut, pulverized with a jet mill, and thereby an alloy powder having an average particle diameter of 10 μm is prepared.

Except for the use of each of the obtained alloy powders, in the similar way as explained in the aforementioned Example 1, a lithium ion secondary battery is assembled.

### Comparative Example 14

Except for the use of Si_{66.7}Ni_{33.3} having an inverse fluorite structure of a lattice constant of 5.4 Å, in the similar way as explained in the aforementioned Example 1, a lithium ion secondary battery is assembled.

### Comparative Example 15

Except for the use of Mg_{66.7}Si_{33.3} having a fluorite structure of a lattice constant of 6.35 Å, in the similar way as explained in the aforementioned Example 1, a lithium ion secondary battery is assembled.

### Comparative Example 16

Raw material is melted in an Ar atmosphere by use of high frequency melting, and the melt is poured into a tundish. After that, a narrow stream of the melt is formed by allowing the melt to pass through a fine pore arranged at a bottom portion of the tundish, a high pressure Ar gas is sprayed to the narrow stream of the melt, and thereby the melt is solidified into an alloy particles.

From a SEM (scanning electron microscope) observation of a section of powder of the obtained negative electrode material and an analysis of each of the phases with an EPMA, it is confirmed that a composition is Co₄₂Si₅₈, a CoSi phase precipitates as a primary crystal, and a Si phase forms an eutectic layer with part of the CoSi phase. Furthermore, an average of thicknesses of layers of Si (minor axis diameter) is in the range of 0.1 to 2 μm.

Except for the use of such a negative electrode material, in the similar way as explained in the aforementioned Example 1, a lithium ion secondary battery is assembled.

Of each of secondary batteries according to Examples 54 to 72 and Comparative examples 14 to 16, in the similar way as explained in Example 1, the discharge capacity ratio, the capacity maintenance rate, the rate characteristics and the number of repetitions of charge/discharge cycle when the maximum capacity is attained are evaluated, and results thereof are shown in Tables 8 to 11.

TABLE 7

| | | | | | | | | | | | Lattice |
|---|---|---|---|---|---|---|---|---|---|---|---|
| | | | | | | | | | | | constant of |
| | | X-ray diffraction angle d due to | | | | | X-ray diffraction angle d | | | | intermetallic |
| Examples | Composition | first phase (A) | | | | | due to second phase (A) | | | | compound (A) |
| 52 | (Al_{0.65}Si_{0.35})₇₅Ni₂₅ | 3.2101 | 1.9658 | 1.6764 | 1.3902 | 1.2756 | 2.3399 | 2.0239 | 1.4328 | 1.2211 | 5.560 |
| 53 | (Al_{0.8}Si_{0.2})₈₀Ni₂₀ | 3.3311 | 2.0389 | 1.7380 | 1.4420 | 1.3210 | 2.3434 | 2.0308 | 1.4332 | 1.2244 | 5.770 |

TABLE 8

| | | | | | | Occupation |
|---|---|---|---|---|---|---|
| | | | | | Transition | rate of |
| | | Composition of | Intermetallic | Lattice | temperature | second phase |
| Examples | Alloy composition | second phase | compound | constant (Å) | (° C.) | (%) |
| 52 | (Al_{0.65}Si_{0.35})₇₅Ni₂₅ | Al + Si + Ni | CaF₂ structure | 5.56 | 293 | 17 |
| 53 | (Al_{0.8}Si_{0.2})₈₀Ni₂₀ | Al + Si + Ni | CaF₂ structure | 5.77 | 267 | 30 |
| 54 | (Al_{0.55}Si_{0.45})_{77.5}Co_{17.5}Ni₅ | Al + Si + | CaF₂ structure | 5.51 | 350 | 15 |
| | | Co + Ni | | | | |
| 55 | (Al_{0.6}Si_{0.4})₇₇Ni₂₀Co₃ | Al + Si + | CaF₂ structure | 5.54 | 290 | 18 |
| | | Ni + Co | | | | |
| 56 | (Al_{0.6}Si_{0.4})₇₇Ni₂₀Fe₃ | Al + Si + | CaF₂ structure | 5.54 | 320 | 22 |
| | | Ni + Fe | | | | |
| 57 | (Al_{0.7}Si_{0.3})₇₆Ni₂₂Nb₂ | Al + Si + Ni | CaF₂ structure | 5.72 | 365 | 8 |
| 58 | (Al_{0.7}Si_{0.3})₇₆Ni₁₈Co₅Ta₁ | Al + Si + | CaF₂ structure | 5.67 | 310 | 10 |
| | | Ni + Co | | | | |
| 59 | (Al_{0.7}Si_{0.3})₇₆Ni₁₈Co₅La₁ | Al + Si + | CaF₂ structure | 5.64 | 340 | 13 |
| | | Ni + Co | | | | |
| 60 | (Al_{0.5}In_{0.1}Si_{0.4})₇₆Ni₁₈Co₅Ce₁ | Al + Si + | CaF₂ structure | 5.82 | 262 | 12 |
| | | In + Ni | | | | |
| 61 | (Al_{0.5}Bi_{0.1}Si_{0.4})₇₆Ni₁₈Co₆ | Al + Si + | CaF₂ structure | 5.79 | 270 | 11 |
| | | Bi + Ni | | | | |
| 62 | (Al_{0.5}Pb_{0.1}Si_{0.4})₇₆Ni₁₈Mn₆ | Al + Si + | CaF₂ structure | 5.88 | 285 | 9 |
| | | Pb + Ni | | | | |
| 63 | (Al_{0.5}Zn_{0.1}Si_{0.4})₇₆Ni₁₈Cu₆ | Al + Si + | CaF₂ structure | 5.56 | 295 | 16 |
| | | Zn + Ni | | | | |
| 64 | (Al_{0.5}Ga_{0.1}Si_{0.4})₇₆Ni₁₈Co₄Ti₂ | Al + Si + | CaF₂ structure | 5.50 | 248 | 23 |
| | | Ga + Ni | | | | |
| 65 | (Al_{0.5}Sb_{0.1}Si_{0.4})₇₆Ni₁₈Co₅Zr₁ | Al + Si + | CaF₂ structure | 5.55 | 288 | 15 |
| | | Sb + Ni | | | | |
| 66 | (Al_{0.5}Mg_{0.1}Si_{0.4})₇₆Ni₁₈Co₅Hf₁ | Al + Si + | CaF₂ structure | 5.80 | 285 | 15 |
| | | Mg + Ni | | | | |
| 67 | (Al_{0.5}Sn_{0.1}Si_{0.4})₇₆Ni₁₈Co₄Cr₂ | Al + Si + | CaF₂ structure | 5.63 | 270 | 20 |
| | | Sn + Ni | | | | |

Note:
Each second phase of the examples 52 to 67 contains Al as a principal element.

TABLE 9

| | | Composition | | Lattice | Transition | Occupation |
|---|---|---|---|---|---|---|
| | | of second | Intermetallic | constant | temperature | rate of second |
| | Alloy composition | phase | compound | (Å) | (° C.) | phase |
| Example 68 | [(Al_{0.65}Si_{0.35})₇₅Ni₂₅]₉₀Li₁₀ | Al + Si + | CaF₂ structure | 5.52 | 263 | 19 |
| | | Ni + Li | | | | |
| Example 69 | [(Al_{0.8}Si_{0.2})₈₀Ni₂₀]₉₀Li₁₀ | Al + Si + | CaF₂ structure | 5.73 | 257 | 33 |
| | | Ni + Li | | | | |
| Example 70 | [(Al_{0.55}Si_{0.45})_{77.5}Co_{17.5}Ni₅]₈₈Li₁₂ | Al + Si + | CaF₂ structure | 5.47 | 330 | 18 |
| | | Co + Ni + | | | | |
| | | Li | | | | |
| Example 71 | [(Al_{0.65}Si_{0.35})₇₇Ni₂₀Co₃]₉₂Li₈ | Al + Si + | CaF₂ structure | 5.50 | 270 | 21 |
| | | Ni + Co + | | | | |
| | | Li | | | | |
| Example 72 | [(Al_{0.6}Si_{0.4})₇₆Ni₂₀Fe₄]₉₀Li₁₀ | Al + Si + | CaF₂ structure | 5.50 | 300 | 25 |
| | | Ni + Fe + | | | | |
| | | Li | | | | |
| Comparative | Si_{66.7}Ni_{33.3} | — | Inverse | 5.4 | — | — |
| Example 14 | | | fluorite | | | |
| | | | structure | | | |
| Comparative | Mg_{66.7}Si_{33.3} | — | CaF₂ structure | 6.35 | — | — |
| Example 15 | | | | | | |
| Comparative | Co₄₂Si₅₈ | — | CoSi₂ phase + | 5.35 | — | 15 |
| Example 16 | | | CoSi phase | | | (Si phase) |

Note:
Each second phase of the examples 68 to 72 contains Al as a principal element.

TABLE 10

| | First phase | | | Battery characteristics | | | |
|---|---|---|---|---|---|---|---|
| | | | Average | | | | Number of |
| | Average | Number | distance | | | | repetitions of |
| | crystal | of | between | | | | charge/discharge |
| | grain | crystal | crystal | Discharge | Capacity | Rate | cycle until the |
| | size | grains | grains | capacity | maintenance | characteristics | maximum capacity |
| Examples | (nm) | (pieces) | (nm) | ratio | rate (%) | (%) | is attained |
| 52 | 100 | 80 | 60 | 1.6 | 89 | 97 | 7 |
| 53 | 60 | 205 | 30 | 1.6 | 89 | 96 | 7 |
| 54 | 80 | 120 | 60 | 1.5 | 91 | 95 | 7 |
| 55 | 50 | 280 | 35 | 1.7 | 90 | 92 | 7 |
| 56 | 120 | 65 | 70 | 1.6 | 89 | 94 | 7 |
| 57 | 60 | 350 | 30 | 1.5 | 93 | 94 | 7 |
| 58 | 40 | 800 | 20 | 1.4 | 94 | 93 | 7 |
| 59 | 50 | 320 | 30 | 1.5 | 93 | 95 | 7 |
| 60 | 50 | 300 | 35 | 1.7 | 90 | 93 | 7 |
| 61 | 50 | 320 | 30 | 1.7 | 89 | 93 | 7 |
| 62 | 50 | 340 | 30 | 1.6 | 89 | 92 | 7 |
| 63 | 50 | 280 | 40 | 1.6 | 89 | 92 | 7 |
| 64 | 80 | 100 | 70 | 1.6 | 90 | 91 | 7 |
| 65 | 60 | 250 | 40 | 1.5 | 91 | 92 | 7 |
| 66 | 60 | 270 | 35 | 1.5 | 90 | 91 | 7 |
| 67 | 50 | 290 | 30 | 1.6 | 90 | 92 | 7 |

TABLE 11

| | First phase | | | Battery characteristics | | | |
|---|---|---|---|---|---|---|---|
| | | | Average | | | | Number of |
| | Average | Number | distance | | | | repetitions of |
| | crystal | of | between | | | Rate | charge/discharge |
| | grain | crystal | crystal | Discharge | Capacity | charac- | cycle until the |
| | size | grains | grains | capacity | maintenance | teristics | maximum capacity |
| | (nm) | (pieces) | (nm) | ratio | rate (%) | (%) | is attained |
| Example 68 | 90 | 100 | 50 | 1.6 | 87 | 94 | 2 |
| Example 69 | 60 | 205 | 30 | 1.6 | 87 | 93 | 2 |
| Example 70 | 80 | 120 | 60 | 1.5 | 90 | 92 | 2 |
| Example 71 | 50 | 280 | 35 | 1.7 | 87 | 90 | 2 |
| Example 72 | 120 | 65 | 70 | 1.6 | 89 | 91 | 2 |
| Comparative | 2000 | 1 | — | 0.8 | 40 | 20 | — |
| Example 14 | | | | | | | |
| Comparative | 3000 | 1 | — | 1 | 65 | 80 | 8 |
| Example 15 | | | | | | | |
| Comparative | 800 | 2 | 200 | 1 | 70 | 80 | 8 |
| Example 16 | | | | | | | |

As obvious from Tables 8 to 11, the secondary batteries according to Examples 52 to 72 are superior in the discharge capacity ratio, the capacity maintenance rate and the rate characteristics to those according to Comparative examples 14 to 16, and the numbers of repetitions of charge/discharge cycle when the maximum discharge capacity is attained are smaller than those according to Comparative examples 14 to 16.

<Comparison of Characteristics Between Alloy Containing Amorphous Phase and Alloy Containing Microcrystalline Phase>

From the aforementioned Examples 1 to 51, secondary batteries according to Examples 2, 3, 10 and 11 in each of which an alloy consisting essentially of an amorphous phase is used and secondary batteries according to Examples 17 and 18 in each of which an alloy consisting essentially of a microcrystalline phase is used are selected, and furthermore secondary batteries according to Examples 52, 54, 55, 68 and 71 are also prepared.

Furthermore, an alloy (Example 73) having a composition shown in the following Table 12 is prepared in a method similar to that explained in Example 1, from the alloy, in the similar way as explained in Example 1, a lithium ion secondary battery is assembled, and thereby a secondary battery of Example 73 is obtained.

With each of these secondary batteries, the charge/discharge cycle test is carried out at room temperature and 60° C. under the conditions similar to those explained in Example 1. With a discharge capacity after 100 cycles at room temperature assigned to 100%, the discharge capacity after 100 cycles at 60° C. is expressed. Results are shown in the following Table 12 as high temperature cycle characteristics. Furthermore, in the charge/discharge cycle test at 60° C., with the maximum discharge capacity assigned to 100%, a discharge capacity at 300 cycles is obtained. Results thereof are shown in the following Table 12 as capacity maintenance rate at 60° C.

TABLE 12

| | | | Battery characteristics | | |
|---|---|---|---|---|---|
| | | | | Capacity | High |
| | | | | mainte- | temperature |
| | | | Discharge | nance | cycle |
| | Negative electrode | | capacity | rate at | character- |
| Examples | Alloy composition | Metal texture | ratio | 60° C. (%) | istics (%) |
| 2 | (Al_{0.95}Si_{0.05})₈₄Ni₁₃Nb₂Cr₁ | Amorphous | 1.6 | 68 | 90.8 |
| 3 | (Al_{0.85}Si_{0.15})₈₄Ni₁₀Co₃Mo₂W₁ | Amorphous | 1.6 | 65 | 88.4 |
| 10 | [(Al_{0.7}Si_{0.3})_{0.8}Ni_{0.15}Fe_{0.03}Zr_{0.02}]₈₅Li₁₅ | Amorphous | 1.6 | 63 | 86.5 |
| 11 | [(Al_{0.6}Si_{0.4})_{0.78}Ni_{0.1}Cu_{0.08}Ta_{0.03}Hf_{0.01}]₉₀Li₁₀ | Amorphous | 1.5 | 66 | 85.5 |
| 73 | (Al_{0.8}Si_{0.2})₈₂Ni₁₆Nb₂ | Amorphous | 1.6 | 70 | 89.1 |
| 17 | (Al_{0.7}Si_{0.3})₇₇Ni₁₄Cu₄Zr₃Hf₁Sn₁ | Microcrystalline | 1.5 | 80 | 95.8 |
| 18 | (Al_{0.6}Si_{0.4})₈₀Ni₁₀Mn₁Co₅Ti₃V₁ | Microcrystalline | 1.6 | 77 | 95.5 |
| 52 | (Al_{0.65}Si_{0.35})₇₅Ni₂₅ | Microcrystalline | 1.6 | 77 | 96.5 |
| 54 | (Al_{0.55}Si_{0.45})_{77.5}Co_{17.5}Ni₅ | Microcrystalline | 1.5 | 82 | 97.2 |
| 55 | (Al_{0.6}Si_{0.4})₇₇Ni₂₀Co₃ | Microcrystalline | 1.7 | 81 | 97.4 |
| 68 | [(Al_{0.65}Si_{0.35})₇₅Ni₂₅]₉₀Li₁₀ | Microcrystalline | 1.6 | 79 | 95.2 |
| 71 | [(Al_{0.65}Si_{0.35})₇₇Ni₂₀Co₃]₉₂Li₈ | Microcrystalline | 1.7 | 79 | 94.9 |

As obvious from Table 12, each of the secondary batteries according to Examples 17, 18, 52, 54, 55, 68 and 71 each of which comprises an alloy containing a microcrystalline phase is superior in the charge/discharge cycle characteristics at 60° C. to each of those according to Examples 2, 3, 10, 11 and 73 each of which comprises an alloy consisting essentially of the amorphous phase.

### EXAMPLES 73 TO 88

<Preparation of Negative Electrode>

After each of mother alloys prepared to ratios by atomic percent shown in Table 13 is heated and melted, an alloy is obtained according to a single roll method in an inert atmosphere. That is, in an inert atmosphere, an alloy melt is ejected from a nozzle opening having a diameter of 1.0 mm onto a BeCu alloy cooling roll that is rotating at a peripheral speed of 40 m/s and quenched, and thereby a ribbon-like alloy is prepared. An atmosphere when the melt is quenched may be an air atmosphere, or an inert gas may be flowed to a tip end of the nozzle, in either case, a similar alloy can be obtained. These alloys are heat-treated at a temperature of 450° C. for 1.5 hours in a nitrogen atmosphere.

The crystallinity of each of the alloys obtained according to Examples 73 to 88 is checked by X-ray diffraction, and it can be confirmed that there are an Al phase or Mg phase that is a simple substance phase of an element that can form an alloy with lithium and two kinds or more of intermetallic compound phases X that have stoichiometric compositions shown in the following Table 13. When the compositions of the intermetallic compounds X are compared, it is found that the kind of the element that can form an alloy with lithium is different from each other.

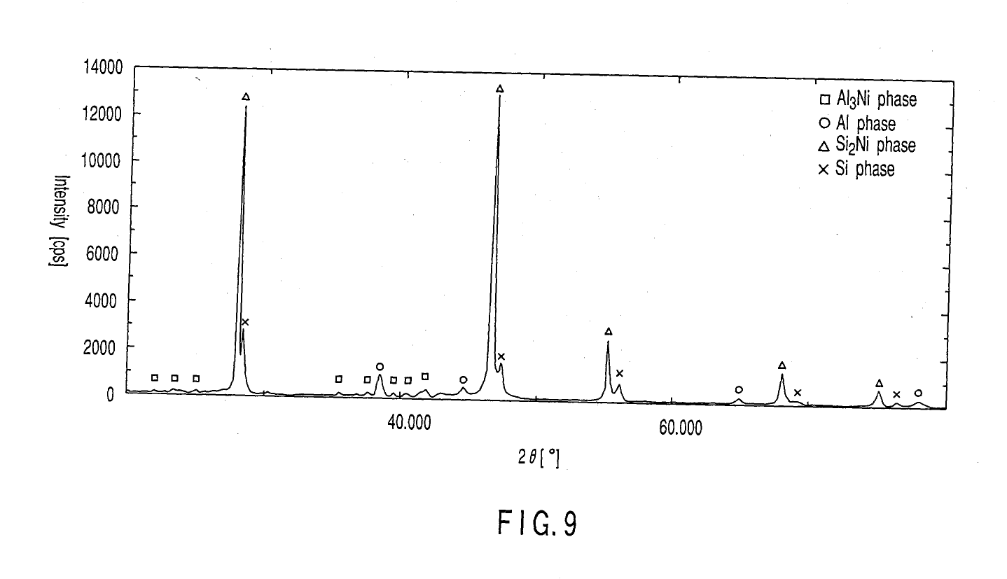

In FIG. 9, an X-ray diffraction pattern (X-ray; CuKα) of the alloy according to Example 73 is shown. In FIG. 9, there are diffraction peaks due to an Al phase (denoted with ◯ mark), an Al₃Ni phase (denoted with □ mark), a Si phase (denoted with X mark) and a Si₂Ni phase (denoted with Δ mark).

Subsequently, each of the ribbon-like alloys according to Examples 73 to 88 is cut, and pulverized with a jet mill, and thereby an alloy powder having an average diameter of 10 μm is prepared.

The alloy powder 94% by weight, graphite powder that is a conductive material 3% by weight, styrene-butadiene rubber that is a binder 2% by weight, and carboxylmethyl cellulose as an organic solvent 1% by weight are mixed followed by dispersing in water, and thereby a suspension is prepared. The suspension is coated on a copper foil that is a collector and has a thickness of 18 μm followed by drying and pressing, and thereby a negative electrode is prepared.

<Preparation of Positive Electrode>

Powder of lithium cobalt oxide 91% by weight, graphite powder 6% by weight and polyvinylidene fluoride 3% by weight are mixed and dispersed in N-methyl-2-pyrrolidone, and thereby a slurry is prepared. The slurry is coated on an aluminum foil that is a collector followed by drying and pressing, and thereby a positive electrode is prepared.

<Preparation of Lithium Ion Secondary Battery>

A separator made of a porous polyethylene film is prepared. A positive electrode and a negative electrode are wound with the separator interposed therebetween, and thereby an electrode group is prepared. Furthermore, lithium hexafluorophosphate as an electrolyte is dissolved in a solvent mixture of ethylene carbonate and methyl ethyl carbonate (volume ratio is 1:2) at a concentration of 1 mol/liter, and thereby a nonaqueous electrolyte is prepared.

After the electrode group is accommodated in a cylindrical stainless case, the nonaqueous electrolyte is poured therein followed by applying sealing, and thereby a cylindrical lithium ion secondary battery is assembled.

### EXAMPLES 89 TO 104

After each of mother alloys prepared to composition ratios by atomic percent shown in Table 14 is heated and melted, an alloy is obtained in an inert atmosphere according to a single roll method. That is, in an inert atmosphere, an alloy melt is ejected from a nozzle opening having a diameter of 1 mm onto a BeCu alloy cooling roll that is rotating at a peripheral speed of 30 m/s and quenched, and thereby a ribbon-like alloy is prepared. The obtained alloy is heat-treated in a nitrogen atmosphere at a temperature of 350° C. for 1 hour.

When each of the alloys obtained according to Examples 89 to 104 is subjected to a thermal analysis under the conditions explained in the following, a peak of heat generation is observed in the range of 200 to 350° C. Accordingly, it can be confirmed that a nonequilibrium phase is contained.

<Measurement Conditions of Thermal Analysis>

The thermal analysis is carried out with the differential scanning calorimeter at a temperature rise speed of 10° C./min. and in an inert gas atmosphere, and a peak of heat generation when a nonequilibrium phase transfers to an equilibrium phase is obtained.

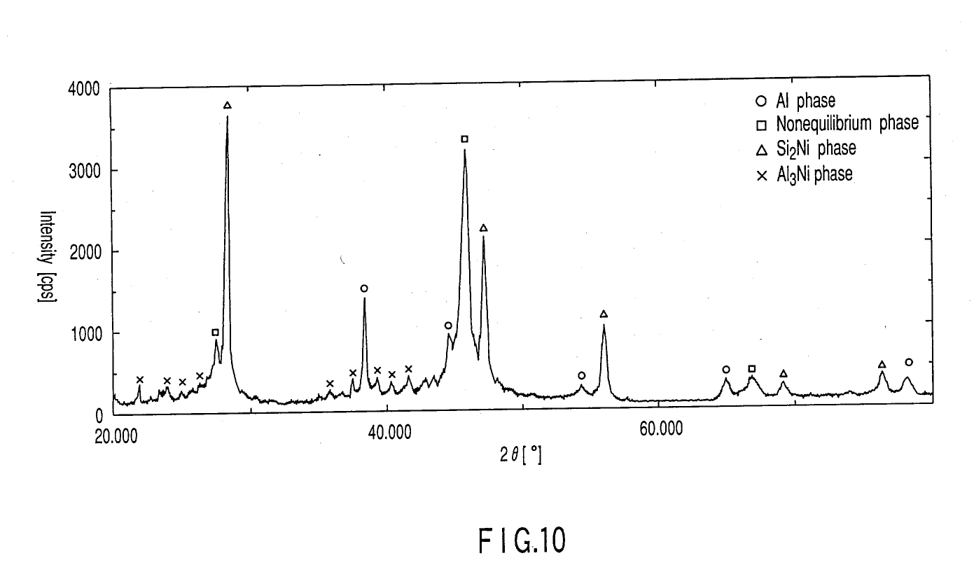

When a metal texture of each of alloys according to Examples 89 to 104 is studied by an X-ray diffraction method, it is confirmed that there are an Al phase that is a simple substance phase of an element that can form an alloy with lithium, and two kinds of intermetallic compound phases each of which has a stoichiometric composition shown in the following Table 14. When the compositions of the intermetallic compounds are compared, it is found that the kind of the element that can form an alloy with lithium is different from each other. An X-ray diffraction pattern of the alloy according to Example 89 is shown in FIG. 10. In FIG. 10, there appear peaks due to a nonequilibrium phase whose base structure is fluorite structure (denoted with □ mark) as well as peaks due to the Al phase (denoted with ◯ mark), peaks due to a Si₂Ni phase (denoted with Δ mark), and peaks due to an Al₃Ni phase (denoted with X mark).

Except for the use of each of such alloy powders, in the way similar to that explained in the aforementioned Example 73, a lithium ion secondary battery is assembled.

### Comparative Example 17

Except for the use of carbonaceous material powder of mesophase pitch-based carbon fiber that is heat-treated at 3250° C. (average fiber diameter; 10 μm, average fiber length; 25 μm, interplanar spacing d₀₀₂; 0.3355 nm, and specific surface area due to BET; 3 m²/g) in place of the alloy powder, similarly to the aforementioned Example 73, a lithium ion secondary battery is assembled.

### Comparative Example 18

Except for the use in place of the alloy powder of Al powder having an average particle diameter of 10 μm, similarly to the aforementioned Example 73, a lithium ion secondary battery is assembled.

### Comparative Example 19

A Sn₃₀Co₇₀ alloy is prepared by spending 100 hours by use of the mechanical alloying. The obtained alloy is confirmed to be amorphous by the X-ray diffraction. Except for the use of alloy like this, similarly to the aforementioned Example 73, a lithium ion secondary battery is assembled.

### Comparative Examples 20 to 22

As negative electrode materials, a Si₃₃Ni₆₇ alloy, a (Al_{0.1}Si_{0.9})₃₃Ni₆₇ alloy, and a Cu₅₀Ni₂₅Sn₂₅ alloy are prepared according to a single-roll process. Roll material is a BeCu alloy and a roll peripheral speed is 25 m/s. The obtained alloys are confirmed to be microcrystallized by the X-ray diffraction. Average crystal grain sizes are calculated according to Scherrer's equation and results are shown in the following Table 15. Except for the use of each of such alloys, similarly to the aforementioned Example 73, a lithium ion secondary battery is assembled.

### Comparative Example 23

As a negative electrode material, an Fe₂₅Si₇₅ alloy is obtained by atomization. When an average crystal grain size is calculated according to Scherrer's equation, it is found to be 300 nm. Except for the use of such an alloy, similarly to the aforementioned Example 73, a lithium ion secondary battery is assembled.

### Comparative Example 24

An alloy expressed by AlNi₂Ti is melted and quenched according to a single roll method, and thereby a sample of Comparative example 24 is obtained. The preparation is performed with a copper roll having a diameter of 200 mm and in an Ar atmosphere. When the X-ray diffraction is performed, it can be confirmed that the alloy is made of an amorphous phase. The obtained sample is pulverized and an alloy powder having an average particle diameter of 9 μm is prepared. Except for the use of such an alloy powder, in the way similar to that explained in Example 73, a lithium ion secondary battery is assembled.

### Comparative Examples 25 to 27

Of alloys expressed by Ni(Si_{1-X}Al_{X})₂, three kinds of X=0.1, 0.2, and 0.25 are prepared according to a gas atomization. Each of obtained samples, without subjecting to the heat treatment, is sieved so as to enable to employ powder of 15 to 45 μm. Except for the use of each of such negative electrode materials, in the way similar to that explained in Example 73, a lithium ion secondary battery is assembled.

### Comparative Example 28

Al and Mo are prepared at a ratio of 12:1 and an alloy is formed therefrom by means of arc melting. A cooling speed after the melting is controlled so that an Al phase, an Al₁₂Mo phase and an Al₅Mo phase may be obtained. The alloy is pulverized and a negative electrode material having an average particle diameter of 20 μm is prepared. Except for the use of this alloy, in the way similar to that explained in Example 73, a lithium ion secondary battery is assembled.

Of each of the secondary batteries obtained according to Examples 73 to 104 and Comparative examples 17 to 28, the evaluation tests explained below are carried out, and results are shown together in the following Tables 13 to 15.

1) Measurement of Average Crystal Grain Size of Microcrystalline Phase

As shown in Tables 13 to 14, each of the alloys of Examples 73 to 104 contains a mixed microcrystalline phase consisting essentially of an element simple substance phase and intermetallic compound phases. Of each of the alloys according to Examples 73 to 104, with the longest portion of each of the crystal grains obtained by a TEM (transmission electron microscope) microgram as a crystal grain size, in a TEM microgram (for instance, 10⁵ magnification) obtained by the TEM observation, the crystal grain size is measured of each of 50 adjacent crystal grains, an averaged value thereof is taken as an average crystal grain size of the intermetallic compound phase. When islands of the intermetallic compound phase are floating in a sea of the simple substance phase, the evaluation of the size is made only of the islands (crystal grains). A magnification of the TEM microgram may be varied according to the magnitude of the crystal grain.

2) Service Capacity Ratio and Capacity Maintenance Rate at 300 Cycles

Of each of the secondary batteries, a charge/discharge cycle test is carried out in which the secondary battery is charged under a charge current of 1.5 A up to a voltage of 4.2 V for 2 hours at 20° C. followed by discharging at 1.5 A to 2.7 V. Thereby, the discharge capacity ratio and the capacity maintenance rate at 300 cycles are measured. The discharge capacity ratio is expressed by a ratio relative to the discharge capacity of Comparative example 1 that is assigned to 1, and the capacity maintenance rate is expressed by the discharge capacity at 300 cycles relative to the maximum discharge capacity that is assigned to 100%.

3) Rate Characteristics

Of each of the secondary batteries, under an environment of 20° C., at 1 C rate, one-hour charge of a constant current and constant voltage to 4.2 V is applied, thereafter a discharge capacity is measured when discharge has been carried out at 0.1 C rate to 3.0 V, and thereby a discharge capacity at 0.1 C is obtained. Furthermore, after charge is applied under the similar conditions, a discharge capacity is measured when discharge has been carried out at 1 C rate to 3.0 V, and thereby a discharge capacity at 1 C is obtained. With the discharge capacity at 0.1 C assigned to 100%, the discharge capacity at 1 C is expressed. Results are taken as rate characteristics.

4) Number of Repetition of Charge/Discharge Cycle When the Maximum Capacity is Attained

Of each of the secondary batteries, the number of cycles required to attain the maximum discharge capacity when the charge/discharge cycles are repeated at 1 C is measured.

TABLE 13

| | | | | Battery characteristics | | | |
|---|---|---|---|---|---|---|---|
| | | | | | | | Number of |
| | | | | | | | repetitions |
| | | | | | | | of charge/ |
| | Negative electrode | | | | | | discharge |
| | | | Average | | | | cycle until |
| | | | crystal | | Capacity | | the maximum |
| | | | grain | Discharge | mainte- | Rate | discharge |
| | | | size | capacity | nance | character- | capacity is |
| Examples | Alloy composition | Precipitated phase | (nm) | ratio | rate (%) | istics (%) | obtained |
| 73 | (Al_{0.4}Si_{0.6})₇₇Ni₂₂Nb₁ | Al + Al₃Ni + Si₂Ni + Si | 280 | 1.6 | 85 | 91 | 6 |
| 74 | (Al_{0.3}Si_{0.7})₇₈Ni₁₉Ti₂Mo₁ | Al + Al₃Ni + Si₂Ni | 250 | 1.5 | 87 | 92 | 6 |
| 75 | (Al_{0.5}Si_{0.5})₇₆Ni₂₁V₂Ta₁ | Al + Al₃Ni + Si₂Ni | 300 | 1.7 | 83 | 93 | 6 |
| 76 | (Al_{0.4}Si_{0.6})₈₀Ni₁₇Cr₂W₁ | Al + Al₃Ni + Si₂Ni | 320 | 1.4 | 85 | 92 | 6 |
| 77 | (Al_{0.5}Si_{0.5})₈₀Fe₁₅Co₂Ta₁Pb₁ | Al + Al₃Fe + Si₂Fe | 300 | 1.4 | 86 | 91 | 6 |
| 78 | (Al_{0.5}Ge_{0.5})₇₉Ni₁₆Fe₄Nb₁ | Al + Al₃Ni + GeNi | 320 | 1.6 | 85 | 91 | 6 |
| 79 | (Al_{0.6}Ga_{0.4})₈₁Cu₁₄Ni₄Mo₁ | Al + Al₂Cu + Ga₂Cu | 350 | 1.4 | 87 | 88 | 6 |
| 80 | (Al_{0.5}In_{0.5})₇₆Ni₂₃Zr₁ | Al + Al₃Ni + In₃Ni₂ | 360 | 1.5 | 83 | 88 | 6 |
| 81 | (Al_{0.5}Si_{0.4}Ge_{0.1})₈₀Ni₁₅Co₄Nb₁ | Al + Al₃Ni + Si₂Ni + GeNi | 270 | 1.6 | 85 | 86 | 6 |
| 82 | (Al_{0.6}Bi_{0.4})₈₀Ni₁₈Nb₂ | Al + Al₃Ni + Bi₃Ni | 250 | 1.4 | 84 | 88 | 6 |
| 83 | (Al_{0.4}Si_{0.6})₇₆Fe₂₀B₄ | Al + Al₃Fe + Si₂Fe | 180 | 1.5 | 80 | 84 | 6 |
| 84 | (Al_{0.6}Si_{0.4})₇₂Ni₂₀Cr₂B₆ | Al + Al₃Ni + Si₂Ni + Al₃Ni₂ | 150 | 1.4 | 79 | 85 | 6 |
| 85 | (Al_{0.5}Si_{0.5})₇₄Ni₂₀Co₂B₄ | Al + Al₃Ni + Si₂Ni | 140 | 1.5 | 80 | 85 | 6 |
| 86 | (Mg_{0.9}Si_{0.1})₇₅La₆Ni₁₈Nb₁ | Mg + Si₂Ni + Mg₂Ni | 200 | 1.4 | 83 | 84 | 6 |
| 87 | (Mg_{0.7}Al_{0.3})₇₄Ce₁₀Cu₁₄Zr₂ | Mg + AlCu + Mg₂Cu | 180 | 1.4 | 82 | 86 | 6 |
| 88 | (Mg_{0.8}Si_{0.2})₇₃Pr₈Ni₁₈Mo₁ | Mg + Si₂Ni + Mg₂Ni | 230 | 1.4 | 83 | 85 | 6 |

TABLE 14

| | | | | Battery characteristics | | | |
|---|---|---|---|---|---|---|---|
| | | | | | | | Number of |
| | Negative electrode | | | | | | repetitions of |
| | | | Average | | | | charge/discharge |
| | | | crystal | | Capacity | | cycle until the |
| | | | grain | Discharge | mainte- | Rate | maximum discharge |
| | | Precipitated | size | capacity | nance | character- | capacity is |
| Examples | Alloy composition | phase | (nm) | ratio | rate (%) | istics (%) | obtained |
| 89 | (Al_{0.5}Si_{0.5})₇₅Ni₂₀Cr₂Fe₂Cu₁ | Al + Al₃Ni + Si₂Ni + | 230 | 1.7 | 86 | 93 | 6 |
| | | nonequilibrium phase | | | | | |
| 90 | (Al_{0.55}Si_{0.45})₇₅Ni₂₀Nb₁Mn₃Cr₁ | Al + Al₃Ni + Si₂Ni + | 220 | 1.7 | 88 | 91 | 6 |
| | | nonequilibrium phase | | | | | |
| 91 | (Al_{0.5}Si_{0.5})₇₄Ni₁₄Co₃Nb₁Cu₂ | Al + Al₃Ni + Si₂Ni + | 200 | 1.6 | 89 | 90 | 6 |
| | | nonequilibrium phase | | | | | |
| 92 | (Al_{0.55}Si_{0.45})₇₆Ni₁₄Fe₃W₁Co₃Cu₃ | Al + Al₃Ni + Si₂Ni + | 190 | 1.6 | 87 | 90 | 6 |
| | | nonequilibrium phase | | | | | |
| 93 | (Al_{0.5}Si_{0.5})₈₀Ni₁₂Mn₅Ta₁Fe₂ | Al + Al₃Ni + Si₂Ni + | 190 | 1.4 | 90 | 90 | 6 |
| | | nonequilibrium phase | | | | | |
| 94 | (Al_{0.5}Si_{0.4}Sn_{0.1})₇₆Ni₁₉Mo₁Cu₂Cr₂ | Al + Al₃Ni + Si₂Ni + | 180 | 1.5 | 90 | 90 | 6 |
| | | nonequilibrium phase | | | | | |
| 95 | (Al_{0.55}Si_{0.25}Ge_{0.2})₇₆Ni₁₇Cu₅Nb₁Mo₁ | Al + Al₃Ni + Si₂Ni + | 160 | 1.6 | 89 | 91 | 6 |
| | | nonequilibrium phase | | | | | |
| 96 | (Al_{0.4}Si_{0.5}Ga_{0.1})₇₅Ni₁₉Co₃Nb₁Mn₂ | Al + Al₃Ni + Si₂Ni + | 210 | 1.4 | 89 | 91 | 6 |
| | | nonequilibrium phase | | | | | |
| 97 | (Al_{0.5}Si_{0.45}Zn_{0.05})₇₈Ni₁₄Fe₅Zr₁Cu₂ | Al + Al₃Ni + Si₂Ni + | 180 | 1.5 | 89 | 92 | 6 |
| | | nonequilibrium phase | | | | | |
| 98 | (Al_{0.55}Si_{0.45})₇₆Ni₁₈Cu₂Nb₁Co₃ | Al + Al₃Ni + Si₂Ni + | 200 | 1.5 | 90 | 93 | 6 |
| | | nonequilibrium phase | | | | | |
| 99 | (Al_{0.5}Si_{0.5})₈₀Ni₁₁Cr₄B₅ | Al + Al₃Ni + Si₂Ni + | 150 | 1.5 | 83 | 86 | 6 |
| | | nonequilibrium phase | | | | | |
| 100 | (Al_{0.6}Si_{0.4})₇₇Ni₁₅Cu₃B₅ | Al + Al₃Ni + Si₂Ni + | 130 | 1.5 | 83 | 86 | 6 |
| | | nonequilibrium phase | | | | | |
| 101 | (Al_{0.55}Si_{0.45})₈₂Ni₁₁Co₃B₄ | Al + Al₃Ni + Si₂Ni + | 160 | 1.5 | 84 | 87 | 6 |
| | | nonequilibrium phase | | | | | |
| 102 | (Mg_{0.6}Si_{0.1}Al_{0.3})₇₆La₉Ni₁₃Cr₂ | Mg + Al₃Ni + Si₂Ni + | 160 | 1.6 | 84 | 84 | 6 |
| | | nonequilibrium phase | | | | | |
| 103 | (Mg_{0.5}Si_{0.2}Al_{0.3})₇₇Ce₈Ni₁₃Fe₂ | Mg + Al₃Ni + Si₂Ni + | 160 | 1.4 | 84 | 86 | 6 |
| | | nonequilibrium phase | | | | | |
| 104 | (Mg_{0.6}Si_{0.2}Al_{0.2})₇₆Nd₇Ni₃Cu₂Nb₁ | Mg + Al₃Ni + Si₂Ni + | 120 | 1.4 | 84 | 85 | 6 |
| | | nonequilibrium phase | | | | | |

TABLE 15

| | | | | Battery characteristics | | | |
|---|---|---|---|---|---|---|---|
| | | | | | | | Number of |
| | | | | | | | repetitions |
| | | | | | | | of charge/ |
| | Negative electrode | | | | | | discharge |
| | | | Average | | | | cycle until |
| | | | crystal | | Capacity | | the maximum |
| | | | grain | Discharge | mainte- | Rate | discharge |
| | | Precipitated | size | capacity | nance | charact- | capacity is |
| Comparative | Alloy composition | phase | (nm) | ratio | rate (%) | eristics (%) | obtained |
| 17 | C | — | 5000 | 1 | 70 | 80 | 7 |
| 18 | Al | — | 10000 | 3 | 2 | 40 | Immeasurable |
| 19 | Sn₃₀Co₇₀ | — | Amorphous | 1.1 | 80 | 82 | 9 |
| 20 | Si₃₃Ni₆₇ | — | 40 | 1.0 | 82 | 85 | 9 |
| 21 | (Al_{0.1}Si_{0.9})₃₃Ni₆₇ | — | 300 | 1.0 | 55 | 70 | 7 |
| 22 | Cu₅₀Ni₂₅Sn₂₅ | — | 200 | 1.0 | 70 | 75 | 8 |
| 23 | Si₇₅Fe₂₅ | — | 300 | 1.2 | 30 | 50 | 7 |
| 24 | AlNi₂Ti | AlNi₂Ti | 300 | 0.7 | 85 | 80 | 8 |
| | (Roll quenching) | | | | | | |
| 25 | Ni(Si_{0.9}Al_{0.1})₂ | Si₂Ni + AlNi | 600 | 1.3 | 75 | 75 | 7 |
| | (Gas atomization method) | | | | | | |
| 26 | Ni(Si_{0.8}Al_{0.2})₂ | Si₂Ni + AlNi | 700 | 1.2 | 77 | 75 | 7 |
| | (Gas atomization method) | | | | | | |
| 27 | Ni(Si_{0.75}Al_{0.25})₂ | Si₂Ni + AlNi | 600 | 1.1 | 79 | 75 | 7 |
| | (Gas atomization method) | | | | | | |
| 28 | AlMo base alloy | Al + Al₁₂Mo + Al₅Mo | 800 | 1.0 | 70 | 75 | 8 |
| | (slow cooling) | | | | | | |

As obvious from Table 13, each of the alloy compositions according to Examples 73 to 78, 80 and 81 belongs to one of the aforementioned general equations (9), (10) and (13), all of the alloy compositions according to Examples 83 to 85 belong to the aforementioned general formula (11), and all of the secondary batteries of the alloy compositions according to Examples 86 to 88 belong to the aforementioned general formula (12). Each of the alloys according to Examples 73 to 88, in either composition, contains a simple substance phase of an element that can form an alloy with lithium and two kinds or more of intermetallic compound phases X. Accordingly, the discharge capacity ratio is 1.4 or more, the capacity maintenance rate at 300 cycles is 79% or more, the rate characteristics are 84% or more, and at the same time the number of repetition of charge/discharge cycle when the maximum capacity is attained is such small as 6 times. Among these, the secondary batteries of Examples 73 to 78 are superior in the rate characteristics to those of Examples 79 to 88.

As obvious from Table 14, each of the alloy compositions according to Examples 89 to 95 and 98 belongs to one of the aforementioned general equations (9), (10) and (13), each of those according to Examples 99 to 101 belongs to the aforementioned general formula (11), and the secondary batteries having the alloy compositions according to Examples 102 to 104 belongs to the aforementioned general formula (12). All of the alloys according to Examples 89 to 104, in either composition, includes a simple substance phase of an element that can form an alloy with lithium, intermetallic compound phases and a nonequilibrium phase. Accordingly, the discharge capacity ratio is 1.4 or more, the capacity maintenance rate at 300 cycles is 83% or more and the rate characteristics are 84% or more, and at the same time the number of repetition of charge/discharge cycle where the maximum capacity is attained is such small as 6 times.

On the contrary to these, as obvious from Table 15, it is found that the secondary battery according to Comparative example 17 that uses the carbonaceous material as the negative electrode material is inferior in all of the discharge capacity, the capacity maintenance rate at 300 cycles and the rate characteristics to those according to Examples 73 to 104. Furthermore, the secondary battery according to Comparative example 18 that uses Al metal as the negative electrode material, though higher in the discharge capacity in comparison with those according to Examples 73 to 104, is inferior in the capacity maintenance rate at 300 cycles and the rate characteristics to those according to Examples 73 to 104.

The secondary batteries according to Comparative examples 19 and 20 are smaller in the discharge capacity ratio than those according to Examples 73 to 104. On the other hand, the secondary batteries according to Comparative examples 21 to 23 and 25 to 28 are lower in the rate characteristics in comparison with those according to Examples 73 to 104. Furthermore, the secondary battery according to Comparative example 24 is inferior in the discharge capacity ratio to those according to Examples 73 to 104. Still furthermore, all of the secondary batteries according to Comparative examples 17 to 28 (comparative Example 18 is omitted because of incapability of measurement) are larger in the number of repetition of charge/discharge cycle until the maximum discharge capacity is attained in comparison with those according to Examples 73 to 104.

Furthermore, when the negative electrode is observed after the charge/discharge cycles are repeated 300 times, in the negative electrodes used in Examples 73 to 104, there is found no change in the alloys. However, in the negative electrode according to Comparative example 18, it is found that Al dendrite precipitates. It is supposed that as a result of the precipitation of the Al dendrite, the secondary battery according to Comparative example 18, though higher in an initial battery discharge capacity, exhibits a drastic decrease in the capacity maintenance rate after 300 cycles. Still furthermore, since the Al dendrite reacts easily with the electrolyte, a decrease in battery safety may be caused.

In the aforementioned embodiments, there are explained of examples in which the negative electrode materials are applied to the cylindrical nonaqueous electrolyte secondary batteries. However, the present invention can be similarly applied to a rectangular nonaqueous electrolyte secondary battery and a thin nonaqueous electrolyte secondary battery.

Furthermore, in the aforementioned embodiments, there are explained of examples in which the negative electrode materials are applied in the nonaqueous electrolyte secondary batteries. However, when the present invention is applied to a nonaqueous electrolyte primary battery, the discharge capacity and the rate characteristics can be improved.

As explained above, according to the present invention, a negative electrode material that is excellent in the discharge capacity, the charge/discharge cycle life and the discharge rate characteristics in nonaqueous electrolyte batteries, a method of manufacturing a negative electrode material, a negative electrode and a nonaqueous electrolyte battery can be provided.

Furthermore, according to the present invention, a negative electrode material excellent in both the discharge capacity and the rate characteristics in nonaqueous electrolyte batteries, a method of manufacturing a negative electrode material, a negative electrode and a nonaqueous electrolyte battery can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A negative electrode material that has a composition expressed by a general formula (1) below and comprises an amorphous phase:
(Al₁₋ₓSiₓ)ₐM_{b}M′_{c}T_{d} (1)
provided that, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x <0.75.

2. A negative electrode material that has a composition expressed by a general formula (2) below and comprises an amorphous phase:
(Al_{1-X}A_{X})ₐM_{b}M′_{c}T_{d} (2)
provided that, the A is Mg, or Si and Mg, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x≦0.9.

3. A negative electrode material that has a composition expressed by the following general formula (3) and includes a microcrystalline phase having an average crystal grain size of 500 nm or less:
(Al_{1-X}Si_{X})ₐM_{b}M′_{c}T_{d} (3)
provided that, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x<0.75.

4. A negative electrode material according to claim 3, wherein the average crystal grain size is 5 nm or more and 500 nm or less.

5. A negative electrode material according to claim 3, wherein, in powder X-ray diffraction, peaks derived from an intermetallic compound including Al and Si appear at least in the range of from 3.13 Å to 3.64 Å and from 1.92 Å to 2.23 Å by d value, and a peak derived from Al appears at least in the range of from 2.31 Å to 2.40 Å by d value.

6. A negative electrode material according to claim 3, wherein the microcrystalline phase has a cubic fluorite structure whose lattice constant is 5.42 Å or more and 6.3 Å or less or an inverse fluorite structure whose lattice constant is 5.42 Å or more and 6.3 Å or less.

7. A negative electrode material according to claim 3, wherein, in differential scanning calorimetry (DSC) at a temperature rise speed of 10° C./min., at least one peak of heat generation is exhibited in the range of 200° C. to 450° C.

8. A negative electrode material according to claim 3,
wherein the microcrystalline phase is an intermetallic compound phase including Al, Si and the element M, and the intermetallic compound phase includes isolated crystal grains and
the negative electrode material further comprises a second phase that contains Al and is arranged between the isolated crystal grains.

9. A negative electrode material that has a composition expressed by the following general formula (4) and contains a microcrystalline phase whose average crystal grain size is 500 nm or less:
(Al_{1-X}A_{X})ₐM_{b}M′_{c}T_{d} (4)
provided that, the A is Mg, or Si and Mg, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x≦0.9.

10. A negative electrode material that has a composition expressed by the following general formula (5) and comprises an amorphous phase:
[(Al_{1-X}Si_{X})ₐM_{b}M′_{c}T_{d}]_{y}Li_{z} (5)
provided that, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x<0.75, y+z=100 atomic percent, and 0<z≦50 atomic percent.

11. A negative electrode material that has a composition expressed by the following general formula (6) and comprises an amorphous phase:
[(Al_{1-X}A_{X})ₐM_{b}M′_{c}T_{d}]_{y}Li_{z} (6)
provided that, the A is Mg, or Si and Mg, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x≦0.9, y+z=100 atomic percent, and 0<z≦50 atomic percent.

12. A negative electrode material that contains a microcrystalline phase whose average crystal grain size is 500 nm or less and has a composition expressed by the following general formula (7):
[(Al_{1-X}Si_{X})ₐM_{b}M′_{c}T_{d}]_{y}Li_{z} (7)
provided that, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x<0.75, y+z=100 atomic percent, and 0<z≦50 atomic percent.

13. A negative electrode material that contains a microcrystalline phase whose average crystal grain size is 500 nm or less and has a composition expressed by the following general formula (8):
[(Al_{1-X}A_{X})ₐM_{b}M′_{c}T_{d}]_{y}Li_{z} (8)
provided that, the A is Mg, or Si and Mg, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x≦0.9, y+z=100 atomic percent, and 0<z<50 atomic percent.

14. A negative electrode material that is capable of storing and releasing lithium, wherein the negative electrode material exhibits at least one peak of heat generation in the range of 200° C. to 450° C. in differential scanning calorimetry (DSC) at a temperature rise speed of 10° C./min., and exhibits a peak derived from a crystalline phase in X-ray diffraction.

15. A negative electrode material, comprising:
a first phase including isolated intermetallic compound crystal grains that include at least two kinds of elements capable of forming an alloy with lithium, an average size of crystal grains of the first phase is in the range of 5 nm to 500 nm, and the number of crystal grains of the first phase is within the range of 10 pieces to 2000 pieces per an area of 1 μm^{2;} and
a second phase that contains a simple substance of an element capable of forming an alloy with lithium and is arranged between the isolated crystal grains.

16. A negative electrode material, comprising:
a first phase including isolated intermetallic compound crystal grains that include at least two kinds of elements capable of forming an alloy with lithium, an average size of crystal grains of the first phase is in the range of 5 nm to 500 nm, and an average distance between the isolated crystal grains is 500 nm or less; and
a second phase that contains a simple substance of an element capable of forming an alloy with lithium and is arranged between the isolated crystal grains.

17. A negative electrode material, comprising:
a first phase including isolated crystal grains of an intermetallic compound that includes at least two kinds of elements capable of forming an alloy with lithium, and an average size of crystal grains of the first phase is in the range of 5 nm to 500 nm; and
a second phase that contains a simple substance of an element capable of forming an alloy with lithium and is arranged between the isolated crystal grains,
wherein the intermetallic compound have a cubic fluorite structure whose lattice constant is in the range of from 5.42 Å to 6.3 Å or an inverse fluorite structure whose lattice constant is in the range of from 5.42 Å to 6.3 Å.

18. A negative electrode material, comprising:
an intermetallic compound phase that includes at least two kinds of elements capable of forming an alloy with lithium; and
a second phase containing a simple substance of an element capable of forming an alloy with lithium, wherein, in the powder X-ray diffraction, peaks derived from the intermetallic compound phase appear at least in the range of from 3.13 Å to 3.64 Å and from 1.92 Å to 2.23 Å by d value, and a peak derived from the second phase appears at least in the range of from 2.31 Å to 2.4 Å by d value.

19. A negative electrode material, including:
a phase containing an element that is capable of forming an alloy with lithium; and
a plurality of intermetallic compound phases,
wherein each of at least two kinds of the plurality of intermetallic compound phases includes a first element that is capable of forming an intermetallic compound with lithium and a second element that does not form an intermetallic compound with lithium, a combination of the first element and the second element being different from each other.

20. A negative electrode material, including:
a phase containing an element capable of forming an alloy with lithium;
an intermetallic compound phase; and
a nonequilibrium phase.

21. A negative electrode material according to claim 20,
wherein an average crystal grain size of the plurality of intermetallic compound phases is in the range of 5 nm to 500 nm.

22. A negative electrode material according to claim 20, wherein the negative electrode material has a composition expressed by a general formula (9) below:
XₓT1_{y}J_{z} (9)
provided that, the X is at least two kinds of elements selected from the group consisting of Al, Si, Mg, Sn, Ge, In, Pb, P and C, the T1 is at least one kind of element selected from the group consisting of Fe, Co, Ni, Cr and Mn, the J is at least one kind of element selected from the group consisting of Cu, Ti, Zr, Hf, V, Nb, Ta, Mo, W and rare earth elements, and x, y and z satisfy the following corresponding equations, x+y+z=100 atomic percent, 50≦x≦90, 10≦y≦33, and 0≦z≦10.

23. A negative electrode material according to claim 20,
wherein the negative electrode material has a composition expressed by a general formula (10) below:
A1ₐT1_{b}J_{c}Z_{d} (10)
provided that, the A1 is at least one kind of element selected from the group consisting of Si, Mg and Al, the T1 is at least one kind of element selected from the group consisting of Fe, Co, Ni, Cr and Mn, the J is at least one kind of element selected from the group consisting of Cu, Ti, Zr, Hf, V, Nb, Ta, Mo, W and rare earth elements, the Z is at least one kind of element selected from the group consisting of C, Ge, Pb, P and Sn, and the a, b, c, and d satisfy the following corresponding equations, a+b+c+d=100 atomic percent, 50 atomic percent≦a≦95 atomic percent, 5 atomic percent≦b≦40 atomic percent, 0≦c≦10 atomic percent, and 0≦d<20 atomic percent.

24. A negative electrode material according to claim 20,
wherein the negative electrode material has a composition expressed by a general formula (11) below:
T1_{100-a-b-c}(A2₁₋ₓJ′ₓ)ₐB_{b}J_{c} (11)
provided that, the T1 is at least one kind of element selected from the group consisting of Fe, Co, Ni, Cu, Cr and Mn, the A2 is at least one element selected from the group consisting of Al and Si, the J is at least one kind of element selected from the group consisting of Ti, Zr, Hf, V, Nb, Ta, Mo, W and rare earth elements, the J′ is at least one kind of element selected from the group consisting of C, Ge, Pb, P, Sn and Mg, and a, b, c, and x satisfy the following corresponding equations, 10 atomic percent≦a≦85 atomic percent, 0<b≦35 atomic percent, 0≦c≦10 atomic percent, and 0≦x≦0.3, and a content of Sn is less than 20 atomic percent (including 0 atomic percent).

25. A negative electrode material according to claim 20,
wherein the negative electrode material has a composition expressed by a general formula (12) below:
(Mg₁₋ₓA3ₓ)_{100-a-b-c-d}(RE)ₐT1_{b}M1_{c}A4_{d} (12)
provided that, the element A3 is at least one kind of element selected from the group consisting of Al, Si and Ge, the RE is at least one kind of element selected from the group consisting of Y and rare earth elements, the T1 is at least one kind of element selected from the group consisting of Fe, Co, Ni, Cu, Cr and Mn, the M1 is at least one kind of element selected from the group consisting of Ti, Zr, Hf, V, Nb, Ta, Mo and W, the A4 is at least one kind of element selected from the group consisting of Sn, Pb, Zn, P and C, and a, b, c, d and x satisfy the following corresponding equations, 0<a≦40 atomic percent, 0<b≦40 atomic percent, 0≦c≦10 atomic percent, 0≦d<20 atomic percent, and 0≦x≦0.5.

26. A negative electrode material according to claim 20,
wherein the negative electrode material has a composition expressed by a general formula (13) below:
(A1₁₋ₓA5ₓ)ₐT1_{b}J_{c}Z_{d} (13)
provided that, the element A5 is at least one kind of element selected from the group consisting of Si and Mg, the T1 is at least one kind of element selected from the group consisting of Fe, Co, Ni, Cr and Mn, the J is at least one kind of element selected from the group consisting of Cu, Ti, Zr, Hf, V, Nb, Ta, Mo, W and rare earth elements, the Z is at least one kind of element selected from the group consisting of C, Ge, Pb, P and Sn, and a, b, c, d and x satisfy the following corresponding equations, a+b+c+d=100 atomic percent, 50 atomic percent≦a≦95 atomic percent, 5 atomic percent≦b≦40 atomic percent, 0≦c≦10 atomic percent, 0≦d<20 atomic percent, and 0<x≦0.9.

27. A negative electrode containing an alloy that has a composition expressed by a general formula (1) below and comprises an amorphous phase:
(Al₁₋ₓSiₓ)ₐM_{b}M′_{c}T_{d} (1)
provided that, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x<0.75.

28. A negative electrode containing an alloy that has a composition expressed by a general formula (2) below and comprises an amorphous phase:
(Al_{1-X}A_{X})ₐM_{b}M′_{c}T_{d} (2)
provided that, the A is Mg, or Si and Mg, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x≦0.9.

29. A negative electrode containing an alloy that contains a microcrystalline phase whose average crystal grain size is 500 nm or less and has a composition expressed by a general formula (3) below:
(Al_{1-X}Si_{X})ₐM_{b}M′_{c}T_{d} (3)
provided that, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x<0.75.

30. A negative electrode containing an alloy that contains a microcrystalline phase whose average crystal grain size is 500 nm or less and has a composition expressed by a general formula (4) below:
(Al_{1-X}A_{X})ₐM_{b}M′_{c}T_{d} (4)
provided that, the A is Mg, or Si and Mg, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x≦0.9.

31. A negative electrode containing an alloy that has a composition expressed by a general formula (5) below and comprises an amorphous phase:
[(Al_{1-X}Si_{X})ₐM_{b}M′_{c}T_{d}]_{y}Li_{z} (5)
provided that, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x<0.75, y+z=100 atomic percent, and 0<z≦50 atomic percent.

32. A negative electrode containing an alloy that has a composition expressed by a general formula (6) below and comprises an amorphous phase:
[(Al_{1-X}A_{X})ₐM_{b}M′_{c}T_{d}]_{y}Li_{z} (6)
provided that, the A is Mg, or Si and Mg, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x≦0.9, y+z=100 atomic percent, and 0<z≦50 atomic percent.

33. A negative electrode containing an alloy that includes a microcrystalline phase whose average crystal grain size is 500 nm or less and has a composition expressed by a general formula (7) below:
[(Al_{1-X}Si_{X})ₐM_{b}M′_{c}T_{d}]_{y}Li_{z} (7)
provided that, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x<0.75, y+z=100 atomic percent, and 0<z≦50 atomic percent.

34. A negative electrode containing an alloy that includes a microcrystalline phase whose average crystal grain size is 500 nm or less and has a composition expressed by a general formula (8) below:
[(Al_{1-X}A_{X})ₐM_{b}M′_{c}T_{d}]_{y}Li_{z} (8)
provided that, the A is Mg, or Si and Mg, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x≦0.9, y+z=100 atomic percent, and 0<z≦50 atomic percent.

35. A negative electrode including a negative electrode material that is capable of storing and releasing lithium, wherein the negative electrode material exhibits at least one peak of heat generation in the range of 200° C. to 450° C. in differential scanning calorimetry (DSC) at a temperature raise speed of 10° C./min., and exhibits a peak derived from a crystalline phase in X-ray diffraction.

36. A negative electrode including a negative electrode material,
wherein the negative electrode material comprises:
a first phase including isolated intermetallic compound crystal grains that include at least two kinds of elements capable of forming an alloy with lithium, an average size of crystal grains of the first phase is in the range of 5 nm to 500 nm, and the number of crystal grains of the first phase is within the range of 10 pieces to 2000 pieces per an area of 1 μm^{2;} and
a second phase that contains a simple substance of an element capable of forming an alloy with lithium and is arranged between the isolated crystal grains.

37. A negative electrode including a negative electrode material,
wherein the negative electrode material comprises:
a first phase including isolated intermetallic compound crystal grains that include at least two kinds of elements capable of forming an alloy with lithium, an average size of crystal grains of the first phase is in the range of 5 nm to 500 nm, and an average distance between the isolated crystal grains is 500 nm or less; and
a second phase that contains a simple substance of an element capable of forming an alloy with lithium and is arranged between the isolated crystal grains.

38. A negative electrode including a negative electrode material,
wherein the negative electrode material comprises:
a first phase including isolated crystal grains of an intermetallic compound that includes at least two kinds of elements capable of forming an alloy with lithium, and an average size of crystal grains of the first phase is in the range of 5 nm to 500 nm; and
a second phase that contains a simple substance of an element capable of forming an alloy with lithium and is arranged between the isolated crystal grains, and the intermetallic compound have a cubic fluorite structure whose lattice constant is in the range of from 5.42 Å to 6.3 Å or an inverse fluorite structure whose lattice constant is in the range of from 5.42 Å to 6.3 Å.

39. A negative electrode including a negative electrode material,
wherein the negative electrode material comprises:
an intermetallic compound phase including at least two kinds of elements capable of forming an alloy with lithium; and
a second phase containing a simple substance of an element capable of forming an alloy with lithium, and
the negative electrode material, in powder X-ray diffraction, exhibits peaks derived from the intermetallic compound at least in the range of from 3.13 Å to 3.64 Å and from 1.92 Å to 2.23 Å by d value and a peak derived from the second phase at least in the range of from 2.31 Å to 2.4 Å by d value.

40. A negative electrode containing a negative electrode material including:
a plurality of intermetallic compound phases; and
a phase containing an element that is capable of forming an alloy with lithium,
wherein each of at least two kinds of the plurality of intermetallic compound phases contains a first element that is capable of forming an alloy with lithium and a second element that does not form an alloy with lithium, a combination of the first element and the second element being different from each other.

41. A negative electrode containing a negative electrode material including:
an intermetallic compound phase;
a nonequilibrium phase; and
a phase that contains an element capable of forming an alloy with lithium.

42. A nonaqueous electrolyte battery comprising:
a negative electrode containing an alloy that has a composition expressed by the following general formula (1) and comprises an amorphous phase;
a positive electrode; and
a nonaqueous electrolyte:
(Al₁₋ₓSiₓ)ₐM_{b}M′_{c}T_{d} (1)
provided that, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x<0.75.

43. A nonaqueous electrolyte battery comprising:
a negative electrode containing an alloy that has a composition expressed by the following general formula (2) and comprises an amorphous phase;
a positive electrode; and
a nonaqueous electrolyte:
(Al_{1-X}A_{X})ₐM_{b}M′_{c}T_{d} (2)
provided that, the A is Mg, or Si and Mg, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent ≦a≦95 atomic percent, 5 atomic percent≦b≦40 atomic percent, 0≦c≦10 atomic percent, 0≦d<20 atomic percent and 0<x≦0.9.

44. A nonaqueous electrolyte battery comprising:
a negative electrode containing an alloy that includes a microcrystalline phase whose average crystal grain size is 500 nm or less and has a composition expressed by the following general formula (3);
a positive electrode; and
a nonaqueous electrolyte:
(Al_{1-X}Si_{X})ₐM_{b}M′_{c}T_{d} (3)
provided that, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x<0.75.

45. A nonaqueous electrolyte battery comprising:
a negative electrode containing an alloy that includes a microcrystalline phase whose average crystal grain size is 500 nm or less and has a composition expressed by the following general formula (4);
a positive electrode; and
a nonaqueous electrolyte:
(Al_{1-X}A_{X})ₐM_{b}M′_{c}T_{d} (4)
provided that, the A is Mg, or Si and Mg, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d and x satisfy corresponding equations of a+b+c+d=100 atomic percent, 50 atomic percent≦a≦95 atomic percent, 5 atomic percent≦b≦40 atomic percent, 0≦c≦10 atomic percent, 0≦d<20 atomic percent and 0<x≦0.9.

46. A nonaqueous electrolyte battery comprising:
a negative electrode containing an alloy that has a composition expressed by the following general formula (5) and comprises an amorphous phase;
a positive electrode; and
a nonaqueous electrolyte:
[(Al_{1-X}Si_{X})ₐM_{b}M′_{c}T_{d}]_{y}Li_{z} (5)
provided that, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x<0.75, y+z=100 atomic percent, and 0<z≦50 atomic percent.

47. A nonaqueous electrolyte battery comprising:
a negative electrode containing an alloy that has a composition expressed by the following general formula (6) and comprises an amorphous phase;
a positive electrode; and
a nonaqueous electrolyte:
[(Al_{1-X}A_{X})ₐM_{b}M′_{c}T_{d}]_{y}Li_{z} (6)
provided that, the A is Mg, or Si and Mg, the M is at least one kind of element selected from the group consisting of Fe, Co, Ni, Cu and Mn, the M′ is at least one kind of element selected from the group consisting of Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x≦0.9, y+z=100 atomic percent, and 0<z≦50 atomic percent.

48. A nonaqueous electrolyte battery comprising:
a negative electrode containing an alloy that includes a microcrystalline phase whose average crystal grain size is 500 nm or less and has a composition expressed by the following general formula (7);
a positive electrode; and
a nonaqueous electrolyte:
[(Al_{1-X}Si_{X})ₐM_{b}M′_{c}T_{d}]_{y}Li_{z} (7)
provided that, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x<0.75, y+z=100 atomic percent, and 0<z≦50 atomic percent.

49. A nonaqueous electrolyte battery comprising:
a negative electrode containing an alloy that includes a microcrystalline phase whose average crystal grain size is 500 nm or less and has a composition expressed by the following general formula (8);
a positive electrode; and
a nonaqueous electrolyte:
[(Al_{1-X}A_{X})ₐM_{b}M′_{c}T_{d}]_{y}Li_{z} (8)
provided that, the A is Mg, or Si and Mg, the M is at least one kind of element selected from the group consisting of Fe, Co, Ni and Mn, the M′ is at least one kind of element selected from the group consisting of Cu, Ti, Zr, Hf, V, Nb, Ta, Cr, Mo, W and rare earth elements, the T is at least one kind of element selected from the group consisting of C, Ge, Pb, P and Sn, and the a, b, c, d, x, y and z satisfy corresponding equations of a+b+c+d=1, 0.5≦a≦0.95, 0.05≦b≦0.4, 0≦c≦0.1, 0≦d<0.2, 0<x≦0.9, y+z=100 atomic percent, and 0<z≦50 atomic percent.

50. A nonaqueous electrolyte battery comprising a positive electrode, a nonaqueous electrolyte and a negative electrode that includes a negative electrode material capable of storing and releasing lithium,
wherein the negative electrode material exhibits at least one peak of heat generation in the range of 200° C. to 450° C. in differential scanning calorimetry (DSC) at a temperature raise speed of 10° C./min., and exhibits a peak derived from a crystalline phase in X-ray diffraction.

51. A nonaqueous electrolyte battery comprising a positive electrode, a nonaqueous electrolyte and a negative electrode that includes a negative electrode material,
wherein the negative electrode material comprises:
a first phase including isolated intermetallic compound crystal grains that include at least two kinds of elements capable of forming an alloy with lithium, an average size of crystal grains of the first phase is in the range of 5 nm to 500 nm, and the number of crystal grains of the first phase is within the range of 10 pieces to 2000 pieces per an area of 1 μm²; and
a second phase that contains a simple substance of an element capable of forming an alloy with lithium and is arranged between the isolated crystal grains.

52. A nonaqueous electrolyte battery comprising a positive electrode, a nonaqueous electrolyte and a negative electrode including a negative electrode material,
wherein the negative electrode material comprises:
a first phase including isolated intermetallic compound crystal grains that include at least two kinds of elements capable of forming an alloy with lithium, an average size of crystal grains of the first phase is in the range of 5 nm to 500 nm, and an average distance between the isolated crystal grains is 500 nm or less; and
a second phase that contains a simple substance of an element capable of forming an alloy with lithium and is arranged between the isolated crystal grains.

53. A nonaqueous electrolyte battery comprising a positive electrode, a nonaqueous electrolyte and a negative electrode including a negative electrode material,
wherein the negative electrode material comprises:
a first phase including isolated crystal grains of an intermetallic compound that includes at least two kinds of elements capable of forming an alloy with lithium, and an average size of crystal grains of the first phase is in the range of 5 nm to 500 nm; and
a second phase that contains a simple substance of an element capable of forming an alloy with lithium and is arranged between the isolated crystal grains, and
the intermetallic compound have a cubic fluorite structure whose lattice constant is in the range of from 5.42 Å to 6.3 Å or an inverse fluorite structure whose lattice constant is in the range of from 5.42 Å to 6.3 Å.

54. A nonaqueous electrolyte battery comprising a positive electrode, a nonaqueous electrolyte and a negative electrode that includes a negative electrode material,
wherein the negative electrode material comprises:
an intermetallic compound phase including at least two kinds of elements capable of forming an alloy with lithium; and
a second phase containing a simple substance of an element capable of forming an alloy with lithium,
and the negative electrode material exhibits, in powder X-ray diffraction, peaks derived from the intermetallic compound phase at least in the range of from 3.13 Å to 3.64 Å and from 1.92 Å to 2.23 Å by d value and a peak derived from the second phase at least in the range of from 2.31 Å to 2.4 Å by d value.

55. A nonaqueous electrolyte battery comprising:
a negative electrode containing a negative electrode material including a plurality of intermetallic compound phases and a phase containing an element that is capable of forming an alloy with lithium;
a positive electrode; and
a nonaqueous electrolyte:
wherein each of at least two kinds of the plurality of intermetallic compound phases contains a first element that is capable of forming an alloy with lithium and a second element that does not form an alloy with lithium, a combination of the first element and the second element being different from each other.

56. A nonaqueous electrolyte battery comprising:
a negative electrode containing a negative electrode material including an intermetallic compound phase, a nonequilibrium phase and a phase containing an element that is capable of forming an alloy with lithium;
a positive electrode; and
a nonaqueous electrolyte.

57. A method of manufacturing a negative electrode material, comprising:
ejecting a melt containing first to third elements onto a single roll such that an alloy thickness is 10 μm to 500 μm; and
quenching the melt to obtain an alloy that contains a high melting point intermetallic compound phase including the first to third elements and a second phase containing the first element and lower in the melting point than the intermetallic compound phase,
wherein the first element is at least one kind of element selected from the group consisting of Al, In, Pb, Ga, Sb, Bi, Sn and Zn,
the second element is at least one kind of element selected from elements, other than Al, In, Pb, Ga, Sb, Bi, Sn and Zn, capable of forming an intermetallic compound with lithium, and
the third element is an element capable of forming an intermetallic compound with the first element and second element.

58. A method of manufacturing a negative electrode material, comprising:
ejecting a melt containing Al and element N1 and element N2 and element N3 onto a single roll such that an alloy thickness is 10 μm to 500 μm; and
quenching the melt to obtain an alloy that contains a high melting point intermetallic compound phase including Al and the element N1 and the element N2 and a second phase containing Al and lower in the melting point than the intermetallic compound phase,
wherein the element N1 is Si, or Si and Mg,
the element N2 is at least one element of Ni and Co,
the element N3 is at least one kind of element selected from the group consisting of In, Bi, Pb, Sn, Ga, Sb, Zn, Fe, Cu, Mn, Cr, Ti, Zr, Nb, Ta and rare earth elements, and
an Al content in the melt is h atomic percent, a content of the element N1 in the melt is i atomic percent, a content of the element N2 in the melt is j atomic percent and a content of the element N3 in the melt is k atomic percent, the h, i, j and k, respectively, satisfy 12.5≦h<95, 0<i≦71, 5≦j≦40, and 0≦k<20.

59. A method of manufacturing a negative electrode material, comprising:
quenching a melt according to a single roll method to obtain an alloy consisting essentially of an amorphous phase, and the melt having a composition expressed by a general formula (9) below; and
applying heat-treatment to the alloy at a temperature equal to or more than a crystallization temperature of the alloy:
XₓT1_{y}J_{z} (9)
provided that, the X is at least two kinds of elements selected from the group consisting of Al, Si, Mg, Sn, Ge, In, Pb, P and C, the T1 is at least one kind of element selected from the group consisting of Fe, Co, Ni, Cr and Mn, the J is at least one kind of element selected from the group consisting of Cu, Ti, Zr, Hf, V, Nb, Ta, Mo, W and rare earth elements, and x, y and z satisfy the following corresponding equations, x+y+z=100 atomic percent, 50≦x≦90, 10≦y≦33, and 0≦z≦10.

60. A method of manufacturing a negative electrode material, comprising:
quenching a melt according to a single roll method to obtain an alloy consisting essentially of an amorphous phase, the melt having a composition expressed by a general formula (10) below; and
applying heat-treatment to the alloy at a temperature equal to or more than a crystallization temperature of the alloy:
A1ₐT1_{b}J_{c}Z_{d} (10)
provided that, the A1 is at least one kind of element selected from the group consisting of Si, Mg and Al, the T1 is at least one kind of element selected from the group consisting of Fe, Co, Ni, Cr and Mn, the J is at least one kind of element selected from the group consisting of Cu, Ti, Zr, Hf, V, Nb, Ta, Mo, W and rare earth elements, the Z is at least one kind of element selected from the group consisting of C, Ge, Pb, P and Sn, and the a, b, c and d satisfy the following corresponding equations, a+b+c+d=100 atomic percent, 50≦a≦95, 5≦b≦40, 0≦c≦10, and 0≦d<20.

61. A method of manufacturing a negative electrode material, comprising:
quenching a melt according to a single roll method to obtain an alloy consisting essentially of an amorphous phase, and the melt having a composition expressed by a general formula (11) below; and
applying heat-treatment to the alloy at a temperature equal to or more than a crystallization temperature of the alloy:
T1_{100-a-b-c}(A2₁₋ₓJ′ₓ)ₐB_{b}J_{c} (11)
provided that, the T1 is at least one kind of element selected from the group consisting of Fe, Co, Ni, Cu, Cr and Mn, the element A2 is at least one element selected from the group consisting of Al and Si, the J is at least one kind of element selected from the group consisting of Ti, Zr, Hf, V, Nb, Ta, Mo, W and rare earth elements, the J′ is at least one kind of element selected from the group consisting of C, Ge, Pb, P, Sn and Mg, and a, b, c, and x satisfy the following corresponding equations, 10 atomic percent≦a≦85 atomic percent, 0<b ≦35 atomic percent, 0≦c≦10 atomic percent, and 0≦x≦0.3, and a content of Sn is less than 20 atomic percent (including 0 atomic percent).

62. A method of manufacturing a negative electrode material, comprising:
quenching a melt according to a single roll method to obtain an alloy consisting essentially of an amorphous phase, the melt having a composition expressed by a general formula (12) below; and
applying heat-treatment to the alloy at a temperature equal to or more than a crystallization temperature of the alloy:
(Mg₁₋ₓA3ₓ)_{100-a-b-c-d}(RE)ₐT1_{b}M1_{c}A4_{d} (12)
provided that, the element A3 is at least one kind of element selected from the group consisting of Al, Si and Ge, the RE is at least one kind of element selected from the group consisting of Y and rare earth elements, the T1 is at least one kind of element selected from the group consisting of Fe, Co, Ni, Cu, Cr and Mn, the M1is at least one kind of element selected from the group consisting of Ti, Zr, Hf, V, Nb, Ta, Mo and W, the A4 is at least one kind of element selected from the group consisting of Sn, Pb, Zn, P and C, and a, b, c, d and x satisfy the following corresponding equations, 0<a≦40 atomic percent, 0<b≦40 atomic percent, 0≦c≦10 atomic percent, 0≦d<20 atomic percent, and 0≦x≦0.5.

63. A method of manufacturing a negative electrode material, comprising:
quenching a melt according to a single roll method to obtain an alloy consisting essentially of an amorphous phase, and the melt having a composition expressed by a general formula (13) below; and
applying heat-treatment to the alloy at a temperature equal to or more than a crystallization temperature of the alloy:
(A1₁₋ₓA5ₓ)ₐT1_{b}J_{c}Z_{d} (13)
provided that, the element A5 is at least one kind of element selected from the group consisting of Si and Mg, the T1is at least one kind of element selected from the group consisting of Fe, Co, Ni, Cr and Mn, the J is at least one kind of element selected from the group consisting of Cu, Ti, Zr, Hf, V, Nb, Ta, Mo, W and rare earth elements, the Z is at least one kind of element selected from the group consisting of C, Ge, Pb, P and Sn, and a, b, c, d and x satisfy the following corresponding equations, a+b+c+d=100 atomic percent, 50≦a≦95, 5≦b≦40, 0≦c≦10, 0≦d<20, and 0<x≦0.9.
